(19) United States
(12) Patent Application Publication
(10) Pub. No.: US 2024/0145687 A1
(43) Pub. Date: May 2, 2024

(54) METHOD FOR FORMING COMPOSITE OXIDE, POSITIVE ELECTRODE, LITHIUM-ION SECONDARY BATTERY, ELECTRONIC DEVICE, POWER STORAGE SYSTEM, AND MOVING VEHICLE

(71) Applicant: SEMICONDUCTOR ENERGY LABORATORY CO., LTD., Atsugi-shi, Kanagawa-ken (JP)

(72) Inventors: Jo SAITO, Atsugi, Kanagawa, (JP); Yohei MOMMA, Isehara, Kanagawa (JP); Tatsuyoshi TAKAHASHI, Atsugi, Kanagawa (JP); Nao KUROSAWA, Atsugi, Kanagawa (JP); Kunihiko SUZUKI, Isehara, Kanagawa (JP)

(21) Appl. No.: 18/549,274

(22) PCT Filed: Mar. 1, 2022
(86) PCT No.: PCT/IB2022/051763

§ 371 Date: Sep. 6, 2023

(30) Foreign Application Priority Data
Mar. 9, 2021 (JP) 2021-037492
Mar. 22, 2021 (JP) 2021-047441
Dec. 24, 2021 (JP) 2021-210799

(51) Int. Cl. H01M 4/36; H01M 4/525; H01M 4/583; H01M 4/88; H01M 10/0525; H01M 10/0562

(52) U.S. Cl. CPC H01M 4/366; H01M 4/525; H01M 4/583; H01M 4/8882; H01M 10/0525; H01M 10/0562; H01M 2004/028

(57) ABSTRACT

A novel positive electrode active material, a novel positive electrode, and a novel lithium-ion secondary battery are to be provided. The lithium-ion secondary battery includes a positive electrode, a negative electrode, and an electrolyte. The positive electrode includes a positive electrode active material that includes a composite oxide containing lithium and cobalt. The positive electrode active material includes barium, magnesium, and aluminum in a surface portion. When being analyzed, the surface portion preferably includes a region where a first point of the highest barium concentration and a second point of the highest magnesium concentration exist closer to the surface than a third point of the highest aluminum concentration does.

### TECHNICAL FIELD

One embodiment of the present invention relates to a method for forming a positive electrode active material. Another embodiment of the present invention relates a method for forming a positive electrode. Another embodiment of the present invention relates a method for forming a secondary battery. Another embodiment of the present invention relates to a portable information terminal, a power storage system, a vehicle, and the like each including a secondary battery.

One embodiment of the present invention relates to an object, a method, or a manufacturing method. Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof. Note that one embodiment of the present invention particularly relates to a method for forming a positive electrode active material or the positive electrode active material. Alternatively, one embodiment of the present invention particularly relates to a method for forming a positive electrode or the positive electrode. Alternatively, one embodiment of the present invention particularly relates to a method for forming a secondary battery or the secondary battery.

Note that in this specification, a semiconductor device refers to any device that can function by utilizing semiconductor characteristics, and an electro-optical device, a semiconductor circuit, and an electronic device are all semiconductor devices.

Note that electronic devices in this specification mean all devices including positive electrode active materials, secondary batteries, or power storage devices, and electro-optical devices including positive electrode active materials, positive electrodes, secondary batteries, or power storage devices, information terminal devices including power storage devices, and the like are all electronic devices.

Note that in this specification and the like, a power storage device refers to all elements and devices each having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demands for lithium-ion secondary batteries with high output and high energy density have rapidly grown with the development of the semiconductor industry; such lithium-ion secondary batteries are used for portable information terminals such as mobile phones, smartphones, and laptop computers, portable music players, digital cameras, medical equipment, home power storage systems, industrial power storage systems, next-generation clean energy vehicles such as hybrid electric vehicles (HVs), electric vehicles (EVs), and plug-in hybrid electric vehicles (PHVs), and the like. The lithium-ion secondary batteries are essential as rechargeable energy supply sources for today's information society.

Above all, composite oxides having a layered rock salt structure, such as lithium cobalt oxide and lithium nickel-cobalt-manganese oxide, are widely used. These materials have characteristics of high capacity and high discharge voltage, which are useful for active materials for power storage devices; to exhibit high capacity, a positive electrode is exposed to a high potential versus a lithium potential at the time of charge. In such a high potential state, release of a large amount of lithium might cause a reduction in stability of the crystal structure to cause significant deterioration in charge and discharge cycles. In the aforementioned background, improvements of positive electrode active materials included in positive electrodes of secondary batteries are actively conducted so as to achieve highly stable secondary batteries with high capacity (e.g., Patent Document 1 to Patent Document 3).

### REFERENCE

### Patent Document

[Patent Document 1] Japanese Published Patent Application No. 2018-088400
[Patent Document 2] International Publication No. WO2018/203168 Pamphlet
[Patent Document 3] Japanese Published Patent Application No. 2020-140954

### SUMMARY OF THE INVENTION

### Problems to be Solved by the Invention

In spite of the active improvements of positive active materials conducted in Patent Documents 1 to 3, development of lithium-ion secondary batteries and positive electrode active materials used therein has room for improvement in terms of charge and discharge capacity, cycle performance, reliability, safety, cost, and the like.

In view of the above, an object of one embodiment of the present invention is to provide a method for forming a positive electrode active material that is stable in a high potential state (also referred to as a high-voltage charged state) and/or a high temperature state. Another object is to provide a method for forming a positive electrode active material whose crystal structure is not easily broken even when charge and discharge are repeated. Another object is to provide a method for forming a positive electrode active material with excellent charge and discharge cycle performance. Another object is to provide a method for forming a positive electrode active material with high charge and discharge capacity. Another object is to provide a method for forming a highly reliable or safe secondary battery.

An object of one embodiment of the present invention is to provide a method for forming a positive electrode that is stable in a high potential state and/or a high temperature state. Another object is to provide a method for forming a positive electrode with excellent charge and discharge cycle performance. Another object is to provide a method for forming a positive electrode with high charge and discharge capacity.

Another object of one embodiment of the present invention is to provide a novel material, novel active material particles, a novel electrode, a novel secondary battery, a novel power storage device, or a formation method thereof. Another object of one embodiment of the present invention is to provide a method for forming a secondary battery having one or more of characteristics selected from increased purity, improved performance, and increased reliability or to provide the secondary battery.

Note that the description of these objects does not preclude the existence of other objects. Note that one embodiment of the present invention does not have to achieve all the objects. Other objects can be derived from the description of the specification, the drawings, and the claims.

### Means for Solving the Problems

One embodiment of the present invention is a positive electrode including a positive electrode active material that includes a composite oxide containing lithium and cobalt; the positive electrode active material includes barium, magnesium, and aluminum in a surface portion.

Another embodiment of the present invention is a positive electrode including a positive electrode active material that includes a composite oxide containing lithium and cobalt; the positive electrode active material includes barium, magnesium, and aluminum in a surface portion; and the surface portion includes a region where the barium and the magnesium exist closer to the surface of the positive electrode active material than aluminum does.

Another embodiment of the present invention is a positive electrode including a positive electrode active material that includes a composite oxide containing lithium and cobalt; the positive electrode active material includes barium, magnesium, and aluminum in a surface portion; and when the surface portion is analyzed by cross-sectional STEM-EDX linear analysis, the surface portion includes a region where a first point of the maximum characteristic X-ray detected value of the barium and a second point of the maximum characteristic X-ray detected value of the magnesium exist closer to the surface of the positive electrode active material than a third point of the maximum characteristic X-ray detected value of the aluminum does.

Another embodiment of the present invention is a positive electrode including a positive electrode active material that includes a composite oxide containing lithium and cobalt; the positive electrode active material includes barium, magnesium, and aluminum in a surface portion; and in a charged state with a charge depth greater than or equal to 0.8, the lithium is distributed uniformly.

Another embodiment of the present invention is a lithium-ion secondary battery including a positive electrode, a negative electrode, and an electrolyte; the positive electrode includes a positive electrode active material that includes a composite oxide containing lithium and cobalt; and the positive electrode active material includes barium, magnesium, and aluminum in a surface portion.

Another embodiment of the present invention is a lithium-ion secondary battery including a positive electrode, a negative electrode, and an electrolyte; the positive electrode includes a positive electrode active material that includes a composite oxide containing lithium and cobalt; the positive electrode active material includes barium, magnesium, and aluminum in a surface portion; and the surface portion includes a region where the barium and the magnesium exist closer to the surface of the positive electrode active material than the aluminum does.

Another embodiment of the present invention is a lithium-ion secondary battery including a positive electrode, a negative electrode, and an electrolyte; the positive electrode includes a positive electrode active material that includes a composite oxide containing lithium and cobalt; the positive electrode active material includes barium, magnesium, and aluminum in a surface portion; and when the surface portion is analyzed by cross-sectional STEM-EDX linear analysis, the surface portion includes a region where a first point of the maximum characteristic X-ray detected value of the barium and a second point of the maximum characteristic X-ray detected value of the magnesium exist closer to the surface of the positive electrode active material than a third point of the maximum characteristic X-ray detected value of the aluminum does.

Another embodiment of the present invention is a lithium-ion secondary battery including a positive electrode, a negative electrode, and an electrolyte; the positive electrode includes a positive electrode active material that includes a composite oxide containing lithium and cobalt; the positive electrode active material includes barium, magnesium, and aluminum; and in a charged state with a charge depth greater than or equal to 0.8, the lithium is distributed uniformly in the positive electrode active material.

In the lithium-ion secondary battery described in any one of the above, the negative electrode preferably includes a carbon-based material.

In the lithium-ion secondary battery described in any one of the above, the electrolyte preferably includes a solid electrolyte.

One embodiment of the present invention is a moving vehicle including the lithium-ion secondary battery described in any of the above.

One embodiment of the present invention is a power storage system including the lithium-ion secondary battery described in any of the above.

One embodiment of the present invention is an electronic device including the lithium-ion secondary battery described in any of the above.

Another embodiment of the present invention is a method for forming a composite oxide including a step of heating a composite oxide containing lithium and cobalt at a temperature higher than or equal to 700° C. and lower than or equal to 1000° C. for a time longer than or equal to two hours, a step of adding a first mixture including a barium source and a second mixture including a magnesium source to the composite oxide to form a third mixture, a step of heating the third mixture at a temperature higher than or equal to 800° C. and lower than or equal to 1100° C. for a time longer than or equal to two hours, a step of adding a nickel source and an aluminum source to the third mixture to form a fourth mixture, and a step of heating the fourth mixture at a temperature higher than or equal to 800° C. and lower than or equal to 1100° C. for a time longer than or equal to two hours.

In the above-described method for forming the lithium-ion secondary battery, when the number of barium atoms included in the barium source is denoted by atBa and the number of magnesium atoms included in the magnesium source is denoted by atMg, atBa/(atBa+atMg) is preferably greater than or equal to 0.1 and less than or equal to 0.5.

In method for forming the lithium-ion secondary battery described in any one of the above, the barium source is barium fluoride, the magnesium source is magnesium fluoride, and when the number of moles of the barium fluoride is denoted by mBaF₂ and the number of moles of the magnesium fluoride is denoted by mMgF₂, mBaF₂/(mBaF₂+mMgF₂) is preferably greater than or equal to 0.1 and less than or equal to 0.5.

### Effect of the Invention

According to one embodiment of the present invention, a method for forming a positive electrode active material with high discharge capacity can be provided. According to one embodiment of the present invention, a method for forming a positive electrode active material that can withstand high charge and discharge voltages can be provided. According to one embodiment of the present invention, a method for forming a positive electrode active material that is less likely to deteriorate can be provided. According to one embodiment of the present invention, a novel positive electrode active material can be provided.

Note that the description of these effects does not preclude the existence of other effects. Note that one embodiment of the present invention does not need to have all of these effects. Note that other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1 is a flow chart showing a process for forming a positive electrode active material of one embodiment of the present invention.

FIG. 2A to FIG. 2C are each a flow chart showing a process for forming a positive electrode active material of one embodiment of the present invention.

FIG. 3A is a cross-sectional view of a positive electrode active material, and FIG. 3B1 to FIG. 3C2 are cross-sectional views of part of the positive electrode active material.

FIG. 4A to FIG. 4C are diagrams each showing a calculation model of a positive electrode active material.

FIG. 5A and FIG. 5B are graphs showing calculation results of a positive electrode active material.

FIG. 6 is a diagram illustrating a crystal structure of a positive electrode active material of one embodiment of the present invention.

FIG. 7 shows XRD patterns calculated from crystal structures.

FIG. 8 is a diagram illustrating crystal structures of a positive electrode active material of a comparative example.

FIG. 9 shows XRD patterns calculated from crystal structures.

FIG. 10A to FIG. 10 C are images of a positive electrode active material observed after a cycle test.

FIG. 11A to FIG. 11C are images of a positive electrode active material observed after a cycle test.

FIG. 12A to FIG. 12C are images of a positive electrode active material observed after a cycle test.

FIG. 13A to FIG. 13E are diagrams showing observation results of a positive electrode active material after a cycle test.

FIG. 14A is a diagram showing a calculation model of a positive electrode active material, and FIG. 14B and FIG. 14C are diagrams each showing a calculation result of the positive electrode active material.

FIG. 15A1 and FIG. 15B1 are diagrams each illustrating a calculation model of a positive electrode active material, and FIG. 15A2 and FIG. 15B2 are diagrams each illustrating a calculation result of the positive electrode active material.

FIG. 16A is an exploded perspective view of a coin-type secondary battery, FIG. 16B is a perspective view of the coin-type secondary battery, and FIG. 16C is a cross-sectional perspective view thereof.

FIG. 17A illustrates an example of a cylindrical secondary battery. FIG. 17B illustrates the example of the cylindrical secondary battery. FIG. 17C illustrates an example of a plurality of cylindrical secondary batteries. FIG. 17D illustrates an example of a power storage system including a plurality of cylindrical secondary batteries.

FIG. 18A and FIG. 18B are diagrams illustrating examples of a secondary battery, and FIG. 18C is a diagram illustrating an internal state of the secondary battery.

FIG. 19A to FIG. 19C are diagrams illustrating an example of a secondary battery.

FIG. 20A and FIG. 20B are diagrams illustrating external views of a secondary battery.

FIG. 21A to FIG. 21C are diagrams illustrating a method for manufacturing a secondary battery.

FIG. 22A to FIG. 22C are diagrams illustrating structure examples of a battery pack.

FIG. 23A and FIG. 23B are cross-sectional views of an active material layer in the case where a graphene compound is used as a conductive material.

FIG. 24A and FIG. 24B are diagrams illustrating examples of a secondary battery.

FIG. 25A to FIG. 25C are diagrams illustrating an example of a secondary battery.

FIG. 26A and FIG. 26B are diagrams illustrating an example of a secondary battery.

FIG. 27A is a perspective view of a battery pack of one embodiment of the present invention, FIG. 27B is a block diagram of a battery pack, and FIG. 27C is a block diagram of a vehicle having a motor.

FIG. 28A to FIG. 28D are diagrams illustrating examples of transport vehicles.

FIG. 29A and FIG. 29B are diagrams illustrating a power storage device of one embodiment of the present invention.

FIG. 30A is a diagram illustrating an electric bicycle, FIG. 30B is a diagram illustrating a secondary battery of an electric bicycle, and FIG. 30C is a diagram illustrating an electric motorcycle.

FIG. 31A to FIG. 31D are diagrams illustrating examples of electronic devices.

FIG. 32A illustrates examples of wearable devices, FIG. 32B is a perspective view of a watch-type device, and FIG. 32C is a diagram illustrating a side surface of the watch-type device. FIG. 32D is a diagram illustrating an example of wireless earphones.

FIG. 33A to FIG. 33C are each a surface SEM image of a positive electrode active material.

FIG. 34A is a cross-sectional STEM image of a positive electrode active material, FIG. 34B1 to FIG. 34B4 are EDX mapping images thereof, and FIG. 34C is a graph showing a result of EDX linear analysis.

FIG. 35A to FIG. 35C are graphs showing results of EDX linear analysis of a positive electrode active material.

FIG. 36A and FIG. 36B are graphs showing cycle performance of half cells.

FIG. 37A and FIG. 37B are graphs showing cycle performance of a half cell.

FIG. 38A and FIG. 38B are graphs showing cycle performance of a half cell.

FIG. 39A and FIG. 39B are each a graph showing charge-discharge characteristics of a half cell in a cycle test.

FIG. 40A and FIG. 40B are each a graph showing charge-discharge characteristics of a half cell in a cycle test.

FIG. 41A and FIG. 41B are each a graph showing charge-discharge characteristics of a half cell in a cycle test.

FIG. 42A to FIG. 42C are cross-sectional STEM images of a positive electrode active material after the cycle test.

### MODE FOR CARRYING OUT THE INVENTION

Hereinafter, embodiments of the present invention will be described in detail with reference to the drawings. Note that the present invention is not limited to the following description, and it is readily understood by those skilled in the art that modes and details of the present invention can be modified in various ways. In addition, the present invention should not be construed as being limited to the description of the embodiments below.

A “composite oxide” in this specification and the like refers to an oxide containing a plurality of kinds of metal elements in its structure.

In this specification and the like, crystal planes and orientations are indicated by the Miller index. In the crystallography, a bar is placed over a number in the expression of crystal planes and orientations; however, in this specification and the like, because of application format limitations, crystal planes and orientations are sometimes expressed by placing − (a minus sign) before the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. As the Miller indices of trigonal system and hexagonal system such as R-3m, not only (hkl) but also (hkil) are used in some cases. Here, i is −(h+k).

In this specification and the like, a layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can diffuse two-dimensionally. Note that a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist in part of the crystal structure.

In this specification and the like, the theoretical capacity of a positive electrode active material refers to the amount of electricity for the case where all the lithium that can be inserted into and extracted from the positive electrode active material is extracted. For example, the theoretical capacity of LiFePO₄ is 170 mAh/g, the theoretical capacity of LiCoO₂ is 274 mAh/g, the theoretical capacity of LiNiO₂ is 275 mAh/g, and the theoretical capacity of LiMn₂O₄ is 148 mAh/g.

The remaining amount of lithium that can be inserted into and extracted from a positive electrode active material is represented by x in a compositional formula, e.g., LiₓCoO₂ or LiMO₂ (M is a transition metal element). In this specification, LiₓCoO₂ can be replaced with LiₓM1O₂ (M1 is a transition metal element) as appropriate. It can be said that x is an occupancy rate, and in the case of a positive electrode active material in a secondary battery, x may be represented by (theoretical capacity−charge capacity)/theoretical capacity. For example, in the case where a secondary battery using LiCoO₂ as a positive electrode active material is charged to 219.2 mAh/g, it can be said that the positive electrode active material is represented by Li_{0.2}CoO₂ or x=0.2. Small x in LiₓCoO₂ means, for example, 0.1<x≤0.24.

In the case where lithium cobalt oxide almost satisfies the stoichiometric composition proportion, lithium cobalt oxide is LiCoO₂ and the occupancy rate of Li in the lithium sites is x=1. For a secondary battery after its discharging ends, it can be said that lithium cobalt oxide is LiCoO₂ and x=1. Here, “discharging ends” means that a voltage becomes lower than or equal to 2.5 V (lithium counter electrode) at a current of 100 mA/g, for example. In a lithium-ion secondary battery, the voltage of the lithium-ion secondary battery rapidly decreases when the occupancy rate of lithium in the lithium sites becomes x=1 and more lithium cannot enter the lithium-ion secondary battery. At this time, it can be said that the discharging is terminated. In general, in a lithium-ion secondary battery using LiCoO₂, the discharge voltage rapidly decreases until discharge voltage reaches 2.5 V; thus, discharging is terminated under the above-described conditions.

In this specification and the like, the charge depth obtained when all the lithium that can be inserted into and extracted from a positive electrode material is inserted is 0, and the charge depth obtained when all the lithium that can be inserted into and extracted from the positive electrode active material is extracted is 1, in some cases. As for x in LiₓMO₂ as an example, the charge depth is 0 when x=1, the charge depth is 1 when x=0, and the charge depth is 0.8 when x=0.2.

In this specification and the like, an active material is expressed as an active material particle in some cases; note that the active material can have a variety of shapes and the shape is not limited to a particle form. For example, the shape of the active material (active material particle) in one cross section may be an ellipse, a rectangle, a trapezoid, a triangle, a quadrilateral with rounded corners, or an asymmetrical shape, as well as a circle.

It can be said that when surface unevenness information in one cross section of an active material is converted into numbers with measurement data, a smooth surface of the active material has a surface roughness of at least less than or equal to 10 nm, in this specification and the like.

The one cross section in this specification and the like is, for example, a cross section obtained in observation using a scanning transmission electron microscope (STEM).

### Embodiment 1

In this embodiment, a method for forming a positive electrode active material of one embodiment of the present invention will be described.

### <<Formation Method 1 of Positive Electrode Active Material>>

### <Step S11>

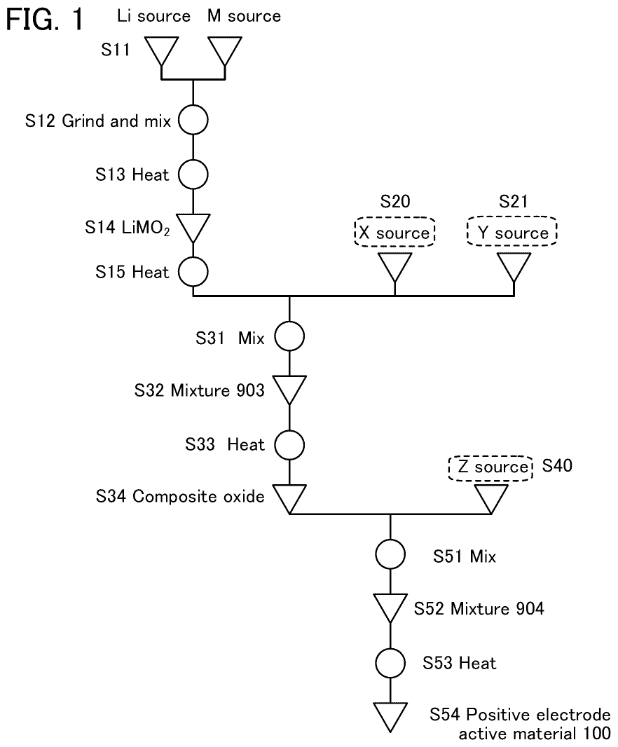

In Step S11 shown in FIG. 1, a lithium source (Li source) and a transition metal source (M source) are prepared as materials for lithium and a transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

The transition metal can be selected from the elements belonging to Groups 3 to 11 of the periodic table and for example, at least one of manganese, cobalt, and nickel is used. As the transition metal, for example, cobalt alone; nickel alone; two metals of cobalt and manganese; two metals of cobalt and nickel; or three metals of cobalt, manganese, and nickel may be used. When cobalt alone is used, the positive electrode active material to be obtained contains lithium cobalt oxide (LCO); when three metals of cobalt, manganese, and nickel are used, the positive electrode active material to be obtained contains lithium nickel cobalt manganese oxide (NCM).

As the transition metal source, a compound containing the above transition metal is preferably used and for example, an oxide, a hydroxide, or the like of any of the metals given as examples of the transition metal can be used. As a cobalt source, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used.

The transition metal source preferably has a high purity and is preferably a material having a purity of higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using the high-purity material. As a result, a secondary battery with an increased capacity and/or increased reliability can be obtained.

Furthermore, the transition metal source preferably has high crystallinity, and preferably includes single crystal particles, for example. To evaluate the crystallinity of the transition metal source, the crystallinity can be judged by a TEM (transmission electron microscope) image, a STEM (scanning transmission electron microscope) image, a HAADF-STEM (high-angle annular dark field scanning transmission electron microscope) image, an ABF-STEM (annular bright-field scanning transmission electron microscope) image, or the like, or can be judged by X-ray diffraction (XRD), electron diffraction, neutron diffraction, or the like. Note that the above methods for evaluating crystallinity can also be employed to evaluate the crystallinity of other materials in addition to the transition metal source.

In the case of using two or more transition metal sources, the two or more transition metal sources are preferably prepared to have proportions (mixing ratio) such that a composite oxide to be obtained would have a layered rock-salt crystal structure.

### <Step S12>

Next, in Step S12 shown in FIG. 1, the lithium source and the transition metal source are ground and mixed to form a mixed material (mixture). The grinding and mixing can be performed by a dry method or a wet method. A wet process is preferred because it can crush a material into a smaller size. When a wet method is employed, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, dehydrated acetone with a purity higher than or equal to 99.5% is used. It is preferable that the lithium source and the transition metal source be mixed into dehydrated acetone whose moisture content is less than or equal to 10 ppm and which has a purity higher than or equal to 99.5% in the crushing and mixing. With use of dehydrated acetone with the above-described purity, impurities that might be mixed can be reduced.

A ball mill, a bead mill, or the like can be used as a means of the mixing and the like. When a ball mill is used, aluminum balls or zirconium balls are preferably used as a grinding medium. Zirconia balls are preferable because they release fewer impurities. When a ball mill, a bead mill, or the like is used, the peripheral speed is preferably higher than or equal to 100 mm/s and lower than or equal to 2000 mm/s in order to inhibit contamination from the media. In this embodiment, the peripheral speed is set to 838 mm/s (the rotational frequency is 400 rpm, and the diameter of the ball mill is 40 mm).

### <Step S13>

Next, the mixed material is heated in Step S13 shown in FIG. 1. The heating temperature is preferably higher than or equal to 800° C. and lower than or equal to 1100° C., further preferably higher than or equal to 900° C. and lower than or equal to 1000° C., and still further preferably approximately 950° C. An excessively low temperature might lead to insufficient decomposition and melting of the lithium source and the transition metal source. An excessively high temperature might lead to a defect due to evaporation or sublimation of lithium from the lithium source and/or excessive reduction of the metal used as the transition metal source, for example. The defect is, for example, an oxygen defect which could be induced by a change of trivalent cobalt into divalent cobalt due to excessive reduction, in the case where cobalt is used as the transition metal.

The heating time is longer than or equal to 1 hour and shorter than or equal to 100 hours, preferably longer than or equal to 2 hours and shorter than or equal to 20 hours.

The temperature raising rate is preferably higher than or equal to 80° C./h and lower than or equal to 250° C./h, although depending on the end-point temperature of the heating. For example, in the case of heating at 1000° C. for 10 hours, the temperature rise is preferably at 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, the following method may be employed: the pressure in the reaction chamber is reduced, then the reaction chamber is filled with oxygen, and the oxygen is prevented from entering or exiting from the reaction chamber. Such a method is referred to as purging. For example, the pressure in the reaction chamber may be reduced to −970 hPa and then, the reaction chamber may be filled with oxygen until the pressure becomes 50 hPa.

Cooling after the heating can be performed by natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. The heating with a rotary kiln can be performed while stirring is performed in either case of a sequential rotary kiln or a batch-type rotary kiln.

As a container used in heating, a crucible can be used, and a material of the container is preferably aluminum. An aluminum crucible is made of a material that is less likely to release impurities. In this embodiment, a crucible made of alumina with a purity of 99.9% is used. The heating is preferably performed with the crucible covered with a lid. This can prevent evaporation or sublimation of a material. Instead of a crucible, a container with a flat bottom, called a saggar or setter, may be used. As a material of the container, mullite (Al₂O₃—SiO₂ based ceramics) may be used.

The heated material is ground as needed and may be made to pass through a sieve. Before collection of the heated material, the material may be moved from the crucible to a mortar. As the mortar, an alumina mortar is suitably used. An alumina mortar is made of a material that is less likely to release impurities. Specifically, a mortar made of alumina with a purity of 90% or higher, preferably 99% or higher, is used. Note that heating conditions equivalent to those in Step S13 can be employed in a later-described heating step other than Step S13.

### <Step S14>

Through the above steps, a composite oxide containing the transition metal (LiMO₂) can be obtained in Step S14 shown in FIG. 1. The composite oxide needs to have a crystal structure of a lithium composite oxide represented by LiMO₂, but the composition is not strictly limited to Li:M:O=1:1:2. In the case of using cobalt as the transition metal, lithium cobalt oxide (represented as LiCoO₂) can be obtained, for example. The composition is not strictly limited to Li:Co:O=1:1:2.

Although the example is described where the composite oxide is fabricated by a solid phase method as in Step S11 to Step S14, the composite oxide may be fabricated by a coprecipitation method. Alternatively, the composite oxide may be fabricated by a hydrothermal method.

### <Step S15>

Next, in Step S15 shown in FIG. 1, the above composite oxide is heated. The heating in Step S15 is the first heating performed on the composite oxide, and thus is sometimes referred to as initial heating. Through the initial heating, the surface of the composite oxide is made smooth. Having a smooth surface refers to a state where the composite oxide has little unevenness and is rounded as a whole and its corner portion is rounded. Being smooth refers to a state where few foreign matters are attached to the surface. Foreign matters are deemed to cause unevenness and are preferably not attached to a surface.

The initial heating is heating performed after a composite oxide is obtained, and in order to make the surface smooth, the initial heating is performed by the present inventors, whereby degradation after charging and discharging can be reduced. The initial heating for making the surface smooth does not need a lithium compound source.

Alternatively, the initial heating for making the surface smooth does not need an additive element source.

Alternatively, the initial heating for making the surface smooth does not need a flux agent.

The initial heating is performed before Step S20 described below and is sometimes referred to as preheating or pretreatment.

The lithium source and the transition metal source prepared in Step S11 and the like might contain impurities. The initial heating can reduce impurities in the composite oxide completed in Step 14.

The heating conditions in this step can be freely set as long as the heating makes the surface of the above composite oxide smooth. For example, any of the heating conditions described for Step S13 can be selected. Additionally, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature higher than or equal to 700° C. and lower than or equal to 1000° C. for longer than or equal to 2 hours.

In the composite oxide, a temperature difference between the surface and the inner portion of the composite oxide might be caused by the heating in Step S13. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the composite oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the composite oxide is relieved. This is probably why the surface of the composite oxide becomes smooth through Step S15. This is also rephrased as modification of the surface. In other words, it is deemed that Step S15 reduces the differential shrinkage caused in the composite oxide to make the surface of the composite oxide smooth.

Such differential shrinkage might cause a micro shift in the composite oxide such as a shift in a crystal. To reduce the shift, this step is preferably performed. Performing this step can distribute a shift uniformly in the composite oxide. When the shift is distributed uniformly, the surface of the composite oxide might become smooth. This is also referred to as alignment of crystal grains. In other words, it is deemed that Step S15 reduces the shift due to a crystal or the like which is caused in the composite oxide to make the surface of the composite oxide smooth.

In a secondary battery including a composite oxide with a smooth surface as a positive electrode active material, degradation by charging and discharging is suppressed and a crack in the positive electrode active material can be prevented.

It can be said that when surface unevenness information in one cross section of a composite oxide is converted into numbers with measurement data, a smooth surface of the composite oxide has a surface roughness of at least less than or equal to 10 nm. The one cross section is, for example, a cross section obtained in observation using a scanning transmission electron microscope (STEM).

Note that a pre-synthesized composite oxide containing lithium, a transition metal, and oxygen may be used in Step S14. In this case, Step S11 to Step S13 can be skipped. When Step S15 is performed on the pre-synthesized composite oxide, a composite oxide with a smooth surface can be obtained.

The initial heating might decrease lithium in the composite oxide. An additive element X and an additive element Y described for Step S20 or the like might easily enter the composite oxide owing to the decrease in lithium. Note that the method for forming a positive electrode active material of one embodiment of the present invention is not necessarily limited to the method including the initial heating.

### <Steps S20 and S21>

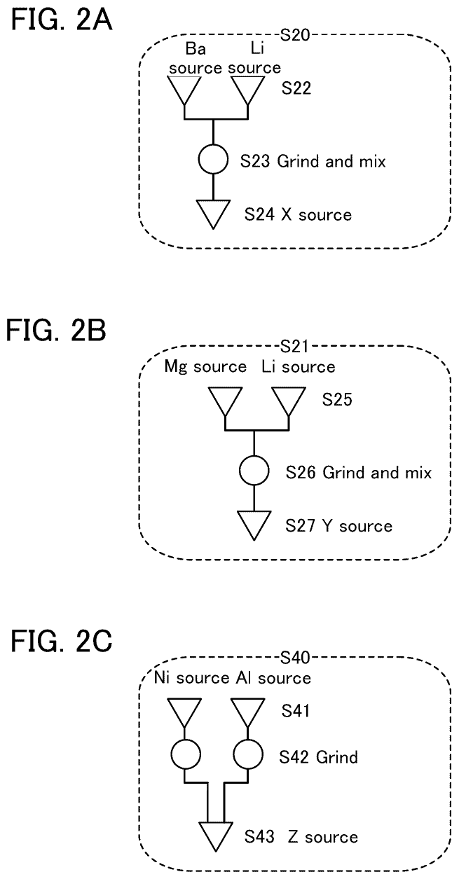

The additive element X and the additive element Y may be added to the composite oxide having a smooth surface as long as a layered rock-salt crystal structure can be obtained. When the composite oxide to which the additive element is added has a smooth surface, the additive element X and the additive element Y can be uniformly added. It is thus preferable that the initial heating precede the addition of the additive element X and the additive element Y. The steps for adding the element X and the addition element Y are described with reference to FIG. 2A and FIG. 2B.

### <Step S22>

In Step S22 shown in FIG. 2A, an additive element X source to be added to the composite oxide is prepared. The element X is barium (Ba). It is preferable that the additive element X source further include a lithium source (Li source). FIG. 2A shows an example in which a barium source (Ba source) and a lithium source (Li source) are prepared in Step S22.

For the barium source, barium fluoride (BaF₂), barium oxide (BaO), barium hydroxide (Ba(OH)₂), barium nitrate (Ba(NO₃)₂), barium sulfate (BaSO₄), or the like can be used.

As the Li source, for example, lithium carbonate, lithium hydroxide, lithium nitrate, lithium fluoride, or the like can be used.

When the barium source and the Li source are used as the additive element X source, it is preferable to use barium fluoride and lithium fluoride for the barium source and the lithium source, respectively, in which case the eutectic point is obtained.

### <Step S23>

Next, in Step S23, the Ba source and the Li source prepared in Step S22 are ground and mixed. Any of the conditions for the grinding and mixing that are described for Step S12 in FIG. 1 can be selected to perform this step.

### <Step S24>

Next, in Step S24 shown in FIG. 2A, the materials ground and mixed in the above step are collected to obtain the additive element X source (X source). Note that the additive element X source in Step S24 contains a plurality of starting materials and can be referred to as a mixture.

### <Step S25>

In Step S25 shown in FIG. 2B, an additive element Y source to be added to the composite oxide is prepared. It is preferable that the additive element Y source further include a lithium source (Li source). FIG. 2B shows an example in which a magnesium source (Mg source) and a lithium source (Li source) are prepared in Step S25.

As the additive element Y, one or more elements selected from magnesium, calcium, fluorine, aluminum, nickel, cobalt, manganese, titanium, zirconium, yttrium, vanadium, chromium, niobium, lanthanum, hafnium, zinc, silicon, sulfur, phosphorus, and boron can be used.

When magnesium is selected as the additive element Y, the additive element Y source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element Y, the additive element Y source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), cerium fluoride (CeF₂), lanthanum fluoride (LaF₃), sodium aluminum hexafluoride (Na₃AlF₆), or the like can be used. Among them, lithium fluoride, which has a relatively low melting point of 848° C., is preferable because it is easily melted in a heating step described later.

Magnesium fluoride can be used as both the fluorine source and the magnesium source. Lithium fluoride can be used as the lithium source. Another example of the lithium source used in Step S25 is lithium carbonate.

The fluorine source may be a gas; for example, fluorine (F₂), carbon fluoride, sulfur fluoride, oxygen fluoride (e.g., OF₂, O₂F₂, O₃F₂, O₄F₂, and O₂F), or the like may be used and mixed in the atmosphere in a heating step described later. Two or more of these fluorine sources may be used.

As an example of the additive element Y source in this embodiment, lithium fluoride (LiF) is prepared as the lithium source (also as the fluorine source) is prepared, and magnesium fluoride (MgF₂) is prepared as the magnesium source (also as the fluorine source) is prepared. When lithium fluoride and magnesium fluoride are mixed at approximately LiF:MgF₂=65:35 (molar ratio), the effect of lowering the melting point becomes the highest. Meanwhile, when the proportion of lithium fluoride increases, the cycle performance might deteriorate because of an excessive amount of lithium. Therefore, the molar ratio of lithium fluoride to magnesium fluoride (LiF:MgF₂) is preferably x:1 (0≤x≤1.9), further preferably x:1 (0.1≤x≤0.5), still further preferably x:1 (x=0.33 and the vicinity thereof). Note that in this specification and the like, the expression “a value in the vicinity thereof” means greater than 0.9 times and smaller than 1.1 times the given value.

### <Step S26>

Next, in Step S26 shown in FIG. 2B, the magnesium source and the fluorine source are ground and mixed. Any of the conditions for the grinding and mixing that are described for Step S12 can be selected to perform this step.

A heating step may be performed after Step S26 as needed. Any of the heating conditions described for Step S13 can be selected to perform the heating step. The heating time is preferably longer than or equal to 2 hours and the heating temperature is preferably higher than or equal to 800° C. and lower than or equal to 1100° C.

### <Step S27>

Next, in Step S27 shown in FIG. 2B, the materials ground and mixed in the above step are collected to obtain the additive element Y source (Y source). Note that the additive element Y source in Step S27 contains a plurality of starting materials and can be referred to as a mixture.

As for the particle diameter of each of the mixtures obtained in Step S24 and Step S27, the D50 (median diameter) is preferably greater than or equal to 50 nm and less than or equal to 10 μm, further preferably greater than or equal to 100 nm and less than or equal to 3 m. Also when one kind of material is used as the additive element source, the D50 (median diameter) is preferably greater than or equal to 50 nm and less than or equal to 10 μm, further preferably greater than or equal to 100 nm and less than or equal to 3 μm.

Such a pulverized mixture (which may contain only one kind of the additive element) is easily attached to the surface of a composite oxide particle uniformly in a later step of mixing with the composite oxide. The mixture is preferably attached uniformly to the surface of the composite oxide particle, in which case barium and magnesium are easily distributed or dispersed uniformly in a surface portion of the composite oxide after heating. The region where barium and magnesium are distributed can also be referred to as a surface portion. When there is a region not containing barium and magnesium in the surface portion, the positive electrode active material might be less likely to have the O3′ type crystal structure, which is described later, in a charged state.

### <Step S31>

Next, in Step S31 shown in FIG. 1, the composite oxide, the additive element X source (X source), and the additive element Y source (Y source) are mixed. The ratio of the number of atoms of the transition metals (atM) in the composite oxide containing the transition metal and oxygen to the number of barium atoms (atBa) in the additive element X and the number of magnesium atoms (atMg) in the additive element Y, that is, atM:(atBa+atMg) is preferably 100:y (0.1≤y≤6), further preferably 100:y (0.3≤y≤3). When the number of barium atoms atBa in the additive element X is 1, the number of magnesium atoms atMg in the additive element Y is preferably greater than or equal to 1 and less than or equal to 9, further preferably greater than or equal to 1 and less than or equal to 4, still further preferably 1. The quantitative relationship between the additive element X and the additive element Y described above is satisfied, in which case a positive electrode active material stable in a high-potential state and/or a high-temperature state can be formed.

The conditions of the mixing in Step S31 are preferably milder than those of the mixing in Step S12 in order not to damage the composite oxide particles. For example, conditions with a lower rotation frequency or shorter time than those for the mixing in Step S12 are preferable. In addition, it can be said that the dry process has a milder condition than the wet process. For example, a ball mill or a bead mill can be used for the mixing. When a ball mill is used, zirconia balls are preferably used as media, for example.

In this embodiment, the mixing is performed with a ball mill using zirconia balls with a diameter of 1 mm by a dry process at 150 rpm for 1 hour. The mixing is performed in a dry room the dew point of which is higher than or equal to −100° C. and lower than or equal to −10° C.

### <Step S32>

Next, in Step S32 in FIG. 1, the materials mixed in the above manner are collected, whereby a mixture 903 is obtained. At the time of collection, the materials may be made to pass through a sieve as needed after being crushed.

### <Step S33>

Then, in Step S33 shown in FIG. 1, the mixture 903 is heated. For the heating, any of the heating conditions described for Step S13 can be selected. The heating time is preferably longer than or equal to two hours.

Here, a supplementary explanation of the heating temperature is provided. The lower limit of the heating temperature in Step S33 needs to be higher than or equal to the temperature at which a reaction between the composite oxide (LiMO₂) and the additive element X source and the additive element Y source proceeds. The temperature at which the reaction proceeds is the temperature at which interdiffusion of the elements included in LiMO₂ and the additive element X source and the additive element Y occurs, and may be lower than the melting temperatures of these materials. It is known that in the case of an oxide as an example, solid phase diffusion occurs at the Tamman temperature T_{d} (0.757 times the melting temperature Tₘ). Accordingly, it is only required that the heating temperature in Step S33 be higher than or equal to 500° C.

Needless to say, the reaction more easily proceeds at a temperature higher than or equal to the temperature at which at least part of the mixture 903 is melted. For example, in the case where LiF and BaF₂ are included in the additive element X source, the lower limit of the heating temperature in Step S33 is preferably higher than or equal to 765° C. because the eutectic point of LiF and BaF₂ is around 765° C. For example, in the case where LiF and MgF₂ are included in the additive element Y source, the lower limit of the heating temperature in Step S33 is preferably higher than or equal to 742° C. because the eutectic point of LiF and MgF₂ is around 742° C. For example, in the case where LiF, BaF₂, and MgF₂ are included in the additive element X source and the additive element Y source, the lower limit of the heating temperature in Step S33 is preferably higher than or equal to 654° C. because the eutectic point of LiF, BaF₂, and MgF₂ is around 654° C. Thus, the heating temperature in Step S33 is preferably higher than or equal to 654° C., further preferably higher than or equal to 742° C., still further preferably higher than or equal to 775° C.

A higher heating temperature is preferable because it facilitates the reaction, shortens the heating time, and enables high productivity.

The upper limit of the heating temperature is lower than the decomposition temperature of LiMO₂ (the decomposition temperature of LiCoO₂ is 1130° C.). At around the decomposition temperature, a slight amount of LiMO₂ might be decomposed. Thus, the heating temperature is preferably lower than or equal to 1000° C., further preferably lower than or equal to 950° C., still further preferably lower than or equal to 900° C.

In view of the above, the heating temperature in Step S33 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., and yet still further preferably higher than or equal to 500° C. and lower than or equal to 900° C. Furthermore, the heating temperature is preferably higher than or equal to 654° C. and lower than or equal to 1130° C., further preferably higher than or equal to 654° C. and lower than or equal to 1000° C., still further preferably higher than or equal to 654° C. and lower than or equal to 950° C., yet still further preferably higher than or equal to 654° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is preferably higher than or equal to 765° C. and lower than or equal to 1130° C., further preferably higher than or equal to 765° C. and lower than or equal to 1000° C., still further preferably higher than or equal to 765° C. and lower than or equal to 950° C., yet still further preferably higher than or equal to 765° C. and lower than or equal to 900° C. Note that the heating temperature in Step S33 is preferably higher than that in Step S13.

In addition, at the time of heating the mixture 903, the partial pressure of fluorine or a fluoride in a heating furnace or a heat-resistant container such as a crucible, which originates the fluorine source or the like, is preferably controlled to be within an appropriate range.

In the fabrication method described in this embodiment, some of the materials, e.g., LiF as the lithium source, function as a flux in some cases. Owing to this function, the heating temperature can be lower than the decomposition temperature of the composite oxide (LiMO₂), e.g., a temperature higher than or equal to 654° C. and lower than or equal to 950° C., which allows distribution of the additive element such as barium and magnesium in the surface portion and formation of the positive electrode active material having favorable characteristics.

However, since LiF in a gas phase has a specific gravity less than that of oxygen, heating might evaporate or sublimate LiF and in that case, LiF in the mixture 903 decreases. As a result, the function of flux deteriorates. Thus, heating needs to be performed while the evaporation or sublimation of LiF is inhibited. Note that even when LiF is not used as the lithium source or the like, Li at the surface of LiMO₂ and F of the fluorine source might react to produce LiF, which might evaporate or sublimate. Therefore, the evaporation or sublimation needs to be inhibited also when a fluoride having a higher melting point than LiF is used.

In view of this, the mixture 903 is preferably heated in an atmosphere containing LiF, i.e., the mixture 903 is preferably heated in a state where the partial pressure of LiF in a heating furnace is high. Such heating can inhibit evaporation or sublimation of LiF in the mixture 903.

The heating in this step is preferably performed such that the particles of the mixture 903 are not adhered to each other. Adhesion of the particles of the mixture 903 during the heating might decrease the area of contact with oxygen in the atmosphere and inhibit a path of diffusion of the additive element X and the additive element Y (e.g., barium, magnesium, and fluorine), thereby hindering distribution of the additive element X and the additive element Y (e.g., barium, magnesium, and fluorine) in the surface portion.

It is considered that uniform distribution of the additive element X and the additive element Y (e.g., barium, magnesium, and fluorine) in the surface portion leads to a smooth positive electrode active material with little unevenness. Thus, it is preferable that the particles not be adhered to each other in order to allow the smooth surface obtained through the heating in Step S15 to be maintained or to be smoother in this step.

In the case of using a rotary kiln for the heating, the flow rate of an oxygen-containing atmosphere in the kiln is preferably controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation or sublimation of the fluorine source, which prevents maintaining the smoothness of the surface.

In the case of using a roller hearth kiln for the heating, the mixture 903 can be heated in an atmosphere containing LiF with the container containing the mixture 903 covered with a lid, for example.

A supplementary explanation of the heating time is provided. The heating time depends on conditions such as the heating temperature and the particle size and composition of LiMO₂ in Step S14. In the case where the particle size is small, the heating is preferably performed at a lower temperature or for a shorter time than the case where the particle size is large, in some cases.

When the median diameter (D50) of the composite oxide (LiMO₂) in Step S14 in FIG. 1 is approximately 12 μm, the heating temperature is preferably higher than or equal to 600° C. and lower than or equal to 950° C., for example. The heating time is preferably longer than or equal to 3 hours, further preferably longer than or equal to 10 hours, still further preferably longer than or equal to 60 hours, for example. Note that the temperature decreasing time after the heating is, for example, preferably longer than tor equal to 10 hours and shorter than or equal to 50 hours.

When the median diameter (D50) of the composite oxide (LiMO₂) in Step S14 is approximately 5 μm, the heating temperature is preferably higher than or equal to 600° C. and lower than or equal to 950° C., for example. The heating time is preferably longer than or equal to 1 hour and shorter than or equal to 10 hours, further preferably approximately 2 hours, for example. Note that the temperature decreasing time after the heating is, for example, preferably longer than tor equal to 10 hours and shorter than or equal to 50 hours.

### <Step S34>

Next, the material heated in Step S33 is collected to form a composite oxide containing the additive element X and the additive element Y. This composite oxide is called a second composite oxide to be distinguished from the composite oxide in Step S14.

### <Step S40>

In Step S40 shown in FIG. 1, an additive element Z source is added. An example in which nickel and aluminum are used as an additive element Z is described with reference to FIG. 2C.

### <Step S41>

A nickel source (Ni source) and an aluminum source (Al source) are prepared in Step S41 shown in FIG. 2C and are separately ground in Step S42. Accordingly, the additive element Z source (Z source) is prepared in Step S43.

As the additive element, one or more elements selected from magnesium, calcium, fluorine, aluminum, nickel, cobalt, manganese, titanium, zirconium, yttrium, vanadium, chromium, niobium, lanthanum, hafnium, zinc, silicon, sulfur, phosphorus, and boron can be used.

When nickel and aluminum are selected for the additive element Z, nickel oxide, nickel hydroxide, or the like can be used as a nickel source. As an aluminum source, aluminum oxide, aluminum hydroxide, or the like can be used.

### <Step S51 to Step S53>

Next, Step S51 to Step S53 shown in FIG. 1 can be performed under the same conditions as those in Step S31 to Step S34. A mixture 904 of Step S52 is heated in Step S53. At this time, the conditions of heating in Step S53 are a lower temperature and a shorter time than those in Step S33. Through the above steps, the positive electrode active material 100 of one embodiment of the present invention can be obtained in Step S54. The positive electrode active material of one embodiment of the present invention has a smooth surface.

The initial heating described in this embodiment makes it possible to obtain a positive electrode active material having a smooth surface.

The initial heating described in this embodiment is performed on a composite oxide. Thus, the initial heating is preferably performed at a temperature lower than the heating temperature for forming the composite oxide and for a time shorter than the heating time for forming the composite oxide. In the case of adding the additive element to the composite oxide, the adding step is preferably performed after the initial heating. The adding step may be separated into two or more steps. Such an order of steps is preferred in order to maintain the smoothness of the surface achieved by the initial heating. When a composite oxide contains cobalt as a transition metal, the composite oxide can be read as a composite oxide containing cobalt.

This embodiment can be used in combination with the other embodiments.

### Embodiment 2

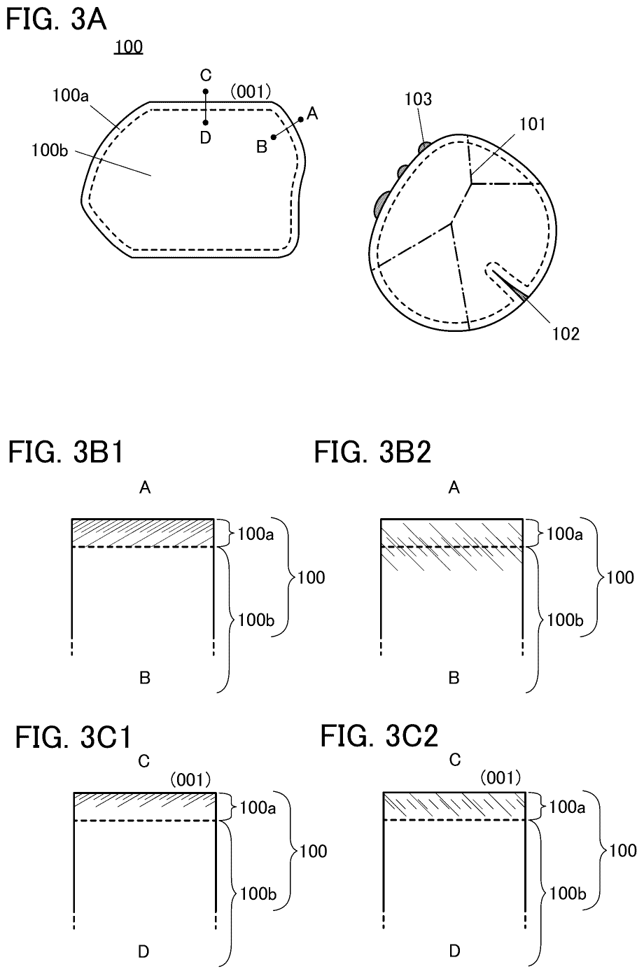

In this embodiment, a positive electrode active material of one embodiment of the present invention will be described with reference to FIG. 3 to FIG. 17.

FIG. 3A is a cross-sectional view of a positive electrode active material 100 of one embodiment of the present invention. FIG. 3B1 and FIG. 3B2 show enlarged views of a portion near the line A-B in FIG. 3A. FIG. 3C1 and FIG. 3C2 show enlarged views of a portion near the line C-D in FIG. 3A.

As illustrated in FIG. 3A to FIG. 3C2, the positive electrode active material 100 includes a surface portion 100a and an inner portion 100b. In each drawing, the dashed line denotes a boundary between the surface portion 100a and the inner portion 100b. FIG. 3A also illustrates a case where the positive electrode active material 100 includes a crystal grain boundary (denoted by a dashed-dotted line).

In this specification and the like, a region that is approximately 50 nm in depth from the surface toward the inner portion of a positive electrode active material is referred to as the surface portion 100a. A plane generated by a crack may also be referred to as a surface. The surface portion 100a may also be referred to as the vicinity of a surface, a region in the vicinity of a surface, a shell, or the like. A region in a deeper position than the surface portion 100a of the positive electrode active material is referred to as the inner portion 100b. The inner portion 100b may also be referred to as an inner region or a core.

The surface portion 100a preferably has a higher concentration of an additive element (the additive element X, the additive element Y, and the additive element Z) described later than the inner portion 100b. In addition, the additive element (the additive element X, the additive element Y, and the additive element Z) preferably has a concentration gradient. In the case where a plurality of kinds of additive elements (the additive element X, the additive element Y, and the additive element Z) are included, the additive elements preferably exhibit concentration peaks at different depths from a surface.

For example, the additive element X and the additive element Y preferably have a concentration gradient as illustrated by gradation in FIG. 3B1, in which the concentration increases from the inner portion 100b toward the surface. Examples of the additive element X and the additive element Y that preferably have such a concentration gradient include barium, magnesium, fluorine, titanium, silicon, phosphorus, boron, and calcium.

Another element, the additive element Z, preferably has a concentration gradient as illustrated by gradation in FIG. 3B2 and exhibits a concentration peak at a deeper region than the concentration peak in FIG. 3B1. The concentration peak may be located in the surface portion 100a or located deeper than the surface portion 100a. For example, the additive element Z preferably has the peak in a region that is 5 nm to 50 nm inclusive in depth from the surface. Examples of the additive element Z that preferably has such a concentration gradient include aluminum and manganese.

It is preferable that the crystal structure change continuously from the inner portion 100b toward the surface owing to the concentration gradients of the additive elements (the additive element X, the additive element Y, and the additive element Z) contained in the positive electrode active material 100 as described above.

### <Contained Element>

The positive electrode active material 100 contains lithium, the transition metal M, oxygen, and the additive element X, the additive element Y, and the additive element Z. The positive electrode active material 100 can be regarded as a composite oxide represented by LiMO₂ to which an additive element is added. Note that the positive electrode active material of one embodiment of the present invention only needs to have a crystal structure of a lithium composite oxide represented by LiMO₂, and the composition is not strictly limited to Li:M:O=1:1:2. In some cases, a positive electrode active material to which an additive element is added is referred to as a composite oxide.

As the transition metal M contained in the positive electrode active material 100, a metal that can form, together with lithium, a layered rock-salt composite oxide belonging to the space group R-3m is preferably used. For example, at least one of manganese, cobalt, and nickel can be used. That is, as the transition metal contained in the positive electrode active material 100, only cobalt may be used, only nickel may be used, two types of metals of cobalt and manganese may be used or two types of metals of cobalt and nickel may be used, or three types of metals of cobalt, manganese, and nickel may be used. In other words, the positive electrode active material 100 can contain a composite oxide containing lithium and the transition metal M, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide.

Specifically, using cobalt at greater than or equal to 75 at %, preferably greater than or equal to 90 at %, further preferably greater than or equal to 95 at % as the transition metal M contained in the positive electrode active material 100 brings many advantages such as relatively easy synthesis, easy handling, and excellent cycle performance. Moreover, when nickel is contained as the transition metal M in addition to cobalt in the above range, a shift in a layered structure formed of octahedrons of cobalt and oxygen is sometimes inhibited. This is preferable because the crystal structure becomes more stable particularly in a charged state at a high temperature in some cases.

Note that manganese is not necessarily contained as the transition metal M. When the positive electrode active material 100 is substantially free from manganese, the above advantages such as relatively easy synthesis, easy handling, and excellent cycle performance are sometimes enhanced. The weight of manganese contained in the positive electrode active material 100 is preferably less than or equal to 600 ppm, further preferably less than or equal to 100 ppm, for example.

Using nickel at greater than or equal to 33 at %, preferably greater than or equal to 60 at %, further preferably greater than or equal to 80 at % as the transition metal M contained in the positive electrode active material 100 is preferable because in that case, the cost of the raw materials might be lower than that in the case of using a large amount of cobalt and charge and discharge capacity per weight might be increased.

Note that nickel is not necessarily contained as the transition metal M. When the positive electrode active material 100 is substantially free from nickel, the above advantages such as relatively easy synthesis, easy handling, and excellent cycle performance are sometimes enhanced. The weight of nickel contained in the positive electrode active material 100 is preferably less than or equal to 600 ppm, further preferably less than or equal to 100 ppm, for example.

As the additive elements (the additive element X, the additive element Y, and the additive element Z) contained in the positive electrode active material 100, at least one of barium, magnesium, fluorine, aluminum, titanium, zirconium, vanadium, chromium, niobium, cobalt, zinc, silicon, sulfur, phosphorus, and boron is preferably used. These additive elements further stabilize the crystal structure of the positive electrode active material 100 in some cases as described later. The positive electrode active material 100 can include lithium cobalt oxide to which barium and magnesium are added, lithium cobalt oxide to which magnesium and aluminum are added, lithium nickel-cobalt oxide to which barium and magnesium are added, lithium cobalt-aluminum oxide to which barium, magnesium, and nickel are added, lithium nickel-cobalt-aluminum oxide, lithium nickel-cobalt-aluminum oxide to which barium and magnesium are added, lithium nickel-manganese-cobalt oxide to which barium and magnesium are added, or the like. Note that in this specification and the like, the additive element may be rephrased as a mixture, a constituent of a material, an impurity element, or the like.

Note that as the additive element, magnesium, fluorine, aluminum, titanium, zirconium, vanadium, iron, chromium, niobium, cobalt, arsenic, zinc, silicon, sulfur, phosphorus, or boron is not necessarily contained.

In order to prevent the breakage of a layered structure formed of octahedrons of cobalt and oxygen even when lithium is extracted from the positive electrode active material 100 of one embodiment of the present invention by charging, the surface portion 100a, i.e., the outer portion of a particle, is reinforced by the additive elements. Therefore, the surface portion 100a preferably has higher concentrations of the additive elements.

It is preferable that the whole of the surface portion 100a of the positive electrode active material 100 have uniform concentration gradients of the additive elements (the additive element X, the additive element Y, and the additive element Z) contained in the positive electrode active material 100. In other words, it is preferable that the reinforcement derived from the level of additive element concentration affect the surface portion 100a uniformly. When only part of the surface portion 100a is reinforced, stress might be concentrated on parts that do not have reinforcement. The concentration of stress on part of a particle might cause defects such as cracks from that part, leading to breakage of the positive electrode active material and a decrease in charge and discharge capacity.

Note that in this specification and the like, uniformity refers to a phenomenon in which, in a solid made of a plurality of elements (e.g., A, B, and C), a certain element (e.g., A) is distributed with similar features in specific regions. Note that it is acceptable for the specific regions to have substantially the same concentration of the element. For example, a difference in the concentration of the element between the specific regions can be 10% or less. Examples of the specific regions include a surface portion, a surface, a projection, a depression, and an inner portion.

Note that it is not always necessary that the whole of the surface portion 100a of the positive electrode active material 100 have uniform concentration gradients of the additive elements (the additive element X, the additive element Y, and the additive element Z) contained in the positive electrode active material 100. FIG. 3C1 shows an example of distribution of the additive element X and the additive element Y in a portion near the line C-D in FIG. 3A. FIG. 3C2 shows an example of distribution of the additive element Z in a portion near the line C-D.

Here, the portion near the line C-D has a layered rock-salt crystal structure belonging to R-3m and the surface of the portion has a (001) orientation. The surface with a (001) orientation may have different distribution of the additive elements (the additive element X, the additive element Y, and the additive element Z) from the other surface. For example, the surface with a (001) orientation and the surface portion 100a thereof may confine the distribution of at least one of the additive element X, the additive element Y, and the additive element Z in a shallower portion positioned from the surface than a surface with other orientations. Alternatively, the surface with a (001) orientation and the surface portion 100a thereof may have a lower concentration of at least one of the additive element X, the additive element Y, and the additive element Z than a surface with other orientations. Further alternatively, at the surface with a (001) orientation and the surface portion 100a thereof, the concentration of at least one of the additive element X and the additive element Y may be below the lower detection limit.

In a layered rock-salt crystal structure belonging to R-3m, cations are arranged parallel to a (001) plane. In other words, a CoO₂ layer formed of octahedrons of cobalt and oxygen and a lithium layer are alternately stacked parallel to a (001) plane. Accordingly, a diffusion path of lithium ions also exists parallel to a (001) plane.

Since the CoO₂ layer formed of octahedrons of cobalt and oxygen is a relatively stable structure, a (001) plane existing on a surface of the CoO₂ layer is relatively stable. A diffusion path of lithium ions is not exposed at the (001) plane.

By contrast, a diffusion path of lithium ions is exposed at a surface having an orientation other than a (001) orientation. Thus, the surface with an orientation other than a (001) orientation and the surface portion 100a thereof easily lose stability because they are regions where extraction of lithium ions starts as well as important regions for maintaining a diffusion path of lithium ions. It is thus preferable to reinforce the surface with an orientation other than a (001) orientation and the surface portion 100a thereof so that the crystal structure of the whole positive electrode active material 100 is maintained.

Therefore, in the positive electrode active material 100 of another embodiment of the present invention, it is preferable that the surface with an orientation other than a (001) orientation and the surface portion 100a thereof have distribution of the additive elements (the additive element X, the additive element Y, and the additive element Z) as illustrated in FIG. 3B1 and FIG. 3B2. By contrast, in the surface with a (001) orientation and the surface portion 100a thereof, the additive element may have a distribution peak at a shallow position or a low concentration as described above or the additive element may be absent.

In the formation method as described in the above embodiment, in which high-purity LiMO₂ is formed, the additive elements are mixed afterwards, and heating is performed, the additive elements (the additive element X, the additive element Y, and the additive element Z) spread mainly via a diffusion path of lithium ions and thus, distribution of the additive elements (the additive element X, the additive element Y, and the additive element Z) at the surface with an orientation other than a (001) orientation and the surface portion 100a thereof can easily fall within a preferred range.

When the positive electrode active material 100 of one embodiment of the present invention has a crystal grain boundary 101, it is further preferable that the additive elements (the additive element X, the additive element Y, and the additive element Z) in the positive electrode active material 100 be segregated partly at the crystal grain boundary 101 illustrated in FIG. 3A as well as having the distribution described above.

Specifically, the barium concentration, the magnesium concentration, and/or the aluminum concentration at the crystal grain boundary 101 and the vicinity thereof in the positive electrode active material 100 and/is preferably higher than that in the other regions in the inner portion 100b. In addition, the fluorine concentration at the crystal grain boundary 101 and the vicinity thereof is preferably higher than that in the other regions in the inner portion 100b.

The crystal grain boundary 101 is a type of plane defect. Thus, the crystal grain boundary tends to be unstable and the crystal structure easily starts to change like the surface of the particle. Thus, the higher the barium concentration, the magnesium concentration and/or the aluminum concentration at the crystal grain boundary 101 and the vicinity thereof are/is, the more effectively the change in the crystal structure can be reduced.

When the barium concentration, the magnesium concentration and/or the aluminum concentration are/is high at the crystal grain boundary 101 and the vicinity thereof, the barium concentration, the magnesium concentration and/or the aluminum concentration in the vicinity of a surface generated by a crack are also high even when the crack is generated along the crystal grain boundary 101 of the particle of the positive electrode active material 100 of one embodiment of the present invention. Thus, the positive electrode active material can have an increased corrosion resistance to hydrofluoric acid or the like even after a crack is generated.

Note that in this specification and the like, the vicinity of the crystal grain boundary 101 refers to a region of approximately 50 nm from the grain boundary. The crystal grain boundary refers to a plane where atomic arrangement is changed and which can be observed with an electron microscope. Specifically, the crystal grain boundary refers to a portion where the angle formed by repetition of bright lines and dark lines in an electron microscope image changes by more than 5° or a portion where a crystal structure cannot be observed in an electron microscope image.

The positive electrode active material 100 has a depression, a crack, a concave, a V-shaped cross section, or the like in some cases. These are examples of defects, and when charging and discharging are repeated, dissolution of the transition metal M, breakage of a crystal structure, cracking of the main body, extraction of oxygen, or the like might be derived from these defects. However, when there is a filling portion 102 that fills such defects, elution of the transition metal M or the like can be inhibited. Thus, the positive electrode active material 100 can have high reliability and excellent cycle performance.

In addition, the positive electrode active material 100 may have an unevenly distributed portion 103 where the additive elements (the additive element X, the additive element Y, and/or the additive element Z) are unevenly distributed. The unevenly distributed portion 103 may have a projecting shape.

As described above, an excessive amount of the additive elements (the additive element X, the additive element Y, and the additive element Z) in the positive electrode active material 100 might adversely affect insertion and extraction of lithium. The use of such a positive electrode active material 100 for a secondary battery might cause an internal resistance increase, a charge and discharge capacity decrease, and the like. Meanwhile, when the amount of the additive elements is insufficient, the additive elements are not distributed throughout the surface portion 100a, which might diminish the effect of inhibiting degradation of a crystal structure. The additive elements (also referred to as the impurity elements) are thus required to be contained in the positive electrode active material 100 at an appropriate concentration; however, the adjustment of the concentration is not easy.

For this reason, when the positive electrode active material 100 includes the region where the impurity elements are unevenly distributed, part of the excess impurities can be removed from the inner portion 100b in the positive electrode active material 100, so that the impurity concentration can be appropriate in the inner portion 100b. This can inhibit an internal resistance increase, a charge and discharge capacity decrease, and the like when a secondary battery is fabricated. A feature of inhibiting an internal resistance increase in a secondary battery is extremely preferable especially in charge and discharge at a high rate such as charge and discharge at 2C or more. When barium, magnesium, and fluorine are used as the additive element X and the additive element Y, BaMg₂F₆, LiBaF₃, BaO, MgO, BaF₂, MgF₂, and the like is detected in the region where the impurity elements are unevenly distributed in some cases.

In the positive electrode active material 100 including the region where the impurity element is unevenly distributed, addition of excess impurities to some extent in the formation process is acceptable. This is preferable because the margin of production can be increased.

Note that in this specification and the like, uneven distribution means that the concentration of an element in a certain region differs from another region. It may be rephrased as segregation, precipitation, unevenness, deviation, high concentration, low concentration, or the like.

In the positive electrode active material 100 of one embodiment of the present invention where the surface portion 100a contains the additive element X, the additive element Y, and/or the additive element Z, in order to prevent the breakage of a layered structure formed of octahedrons of cobalt and oxygen even when lithium is extracted by charging from the positive electrode active material 100, the surface portion 100a having high concentration of the additive element X, the additive element Y, and/or the additive element Z, i.e., the outer portion of a particle, is reinforced. The surface portion 100a having high concentration of the additive element X, the additive element Y, and/or the additive element Z is desirably provided in at least part of a surface portion of the particle, preferably in a region occupying more than half of the surface portion of the particle, further preferably in the entire region of the surface portion of the particle.

Furthermore, in the positive electrode active material 100 of one embodiment of the present invention, the region exhibiting the concentration gradient of the additive element X, the additive element Y, and/or the additive element Z is desirably provided in at least part of a surface portion of the particle, preferably in a region occupying more than half of the surface portion of the particle, further preferably in the entire region of the surface portion of the particle. A situation where only part of the surface portion 100a has reinforcement is not preferable because stress might be concentrated on parts that do not have reinforcement. The concentration of stress on part of a particle might cause defects such as closed splits and cracks from that part, leading to a decrease in charge and discharge capacity.

### [Calculation of Barium]

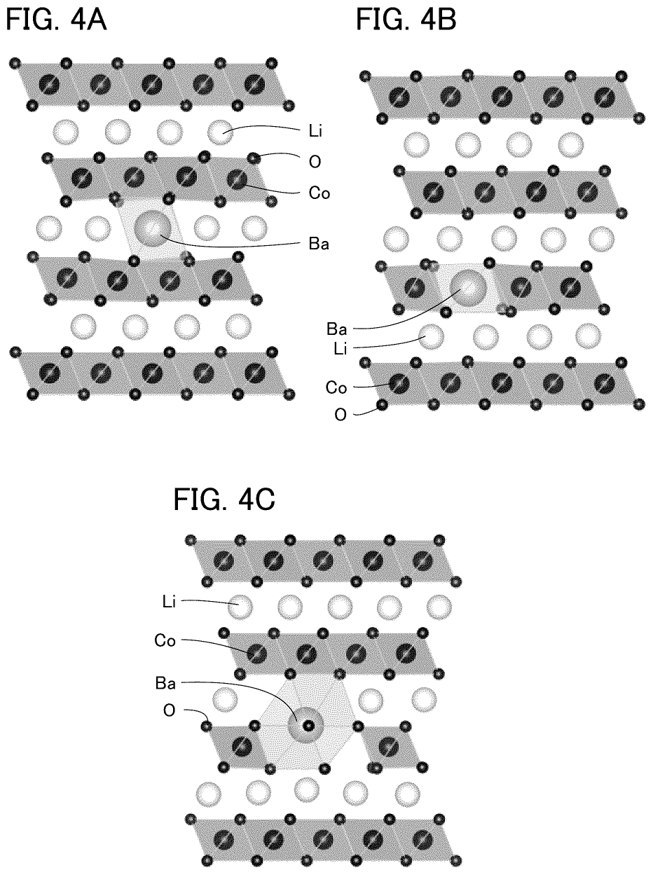

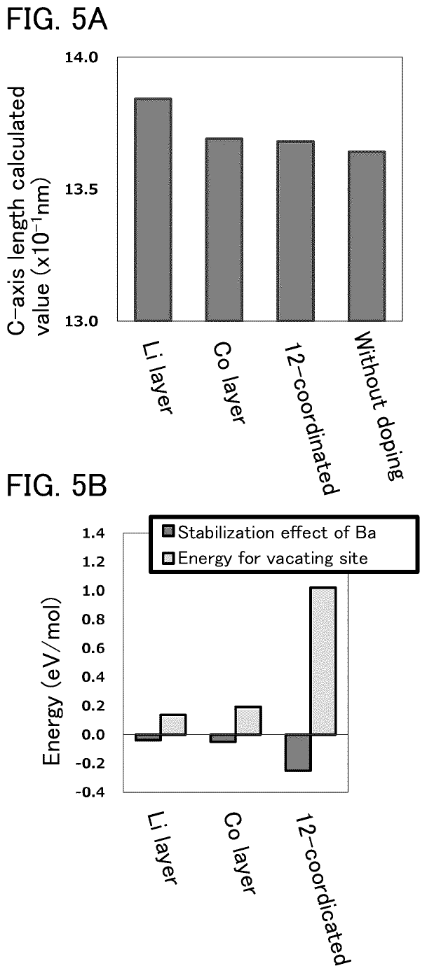

FIG. 4A to FIG. 4C show structural models used for calculation. FIG. 5A and FIG. 5B show results of structural calculation when barium is added as the additive element X to lithium cobalt oxide.

FIG. 4A to FIG. 4C show three types of crystal structures assuming the case where barium is dissolved in lithium cobalt oxide having the space group R-3m crystal structure. FIG. 4A shows the structure where Li in a Li layer is replaced with Ba; FIG. 4B shows the structure where Co in a Co layer is replaced with Ba; and FIG. 4C shows the structure where Ba occupies a Li layer and a Co layer and exists at a 12-coordinated site. Note that the Co layer refers to a layer composed of cobalt in a CoO₂ layer formed by octahedrons of cobalt and oxygen.

For the calculation, the first-principles calculation software VASP (The Vienna Ab initio simulation package) was used.

FIG. 5A shows c-axis lengths in the post-structural stabilization calculation of structures shown in FIG. 4A to FIG. 4C, as the calculation results. The c-axis lengths after the structural stabilization calculation were as follows: the c-axis length in the structure where Li in a Li layer is replaced with Ba (“Li layer” in FIG. 5A: 13.83930×10⁻¹ nm)>the c-axis length in the structure where Co in a Co layer is replaced with Ba (“Co layer” in FIG. 5A: 13.68914×10⁻¹ nm)>the c-axis length in the structure where Ba exists at a 12-coordinated site (“12-coordinated” in FIG. 5A: 13.67994×10⁻¹ nm)>the c-axis length in a structure not containing Ba (“without doping” in FIG. 5A: 13.64023×10⁻¹ nm). Each of the structures containing Ba, which were calculated this time, shows the calculation results of longer c-axis length than that in the structure not containing Ba.

FIG. 5B shows the stabilization effect of the structures shown in FIG. 4A to FIG. 4C (an energy difference from that in the structure without doping) and the energy for vacating a site, as the calculation results. A negative value of the stabilization effect means that the structure is more stable than the structure without doping, and a larger negative value means more stable.

According to the results shown in FIG. 5B, the highest stabilization effect of Ba for stabilization is obtained (the value of stabilization effect is the lowest) in the structure where Ba exists at a 12-coordinated site. In contrast, the energy necessary for vacating 12-coordinated sites (energy for securing a space doped with Ba) is the highest in the structure where Ba exists at a 12-coordinated site. Thus, it is expected that although it is not easy to put Ba in the 12-coordinated sites, the structure where Ba exists at a 12-coordinated site has the highest stabilization effect in the structures calculated this time.

Aluminum, gallium, boron, and indium are each trivalent and can exist at a transition metal site in the layered rock-salt crystal structure. Gallium, aluminum, boron, and indium can inhibit the elution of cobalt around the gallium, the aluminum, the boron, and the indium. Furthermore, gallium, aluminum, boron, and indium can inhibit cation mixing of cobalt (transfer of cobalt to a lithium site) around the gallium, the aluminum, the boron, and the indium. Furthermore, gallium, aluminum, boron, and indium each have a strong bonding strength with oxygen and accordingly can inhibit release of oxygen around the gallium, the aluminum, the boron, and the indium. Hence, with use of at least one of gallium, aluminum, boron, and indium as the additive element Z, the positive electrode active material 100 whose crystal structure is less likely to be broken even when charging and discharging are repeated can be provided.

Magnesium is divalent and is more stable in lithium sites than in transition metal sites in the layered rock-salt crystal structure; thus, magnesium is likely to enter the lithium sites. An appropriate concentration of magnesium in the lithium sites of the surface portion 100a facilitates maintenance of the layered rock-salt crystal structure. The bonding strength of magnesium with oxygen is high, thereby inhibiting extraction of oxygen around magnesium. An appropriate concentration of magnesium does not have an adverse effect on insertion and extraction of lithium in charging and discharging, and is thus preferable. However, excess magnesium might adversely affect insertion and extraction of lithium.

When fluorine, which is a monovalent anion, is substituted for part of oxygen in the surface portion 100a, the lithium extraction energy is lowered. This is because the change in the valence of cobalt ions associated with lithium extraction differs depending on the presence or absence of fluorine. For example, the change in the valence of cobalt ions is trivalent to tetravalent in the case of not containing fluorine and divalent to trivalent in the case of containing fluorine, and the oxidation-reduction potential of cobalt ions differs therebetween. It can thus be said that when fluorine is substituted for part of oxygen in the surface portion 100a of the positive electrode active material 100, lithium ions near fluorine are likely to be extracted and inserted smoothly. Thus, using such a positive electrode active material 100 in a secondary battery is preferable because the charge and discharge characteristics, rate performance, and the like are improved.

A titanium oxide is known to have superhydrophilicity. Accordingly, the positive electrode active material 100 including an oxide of titanium in the surface portion 100a presumably has good wettability with respect to a high-polarity solvent. Such the positive electrode active material 100 and a high-polarity electrolyte solution can have favorable contact at the interface therebetween and presumably inhibit a resistance increase when a secondary battery is formed using the positive electrode active material 100. In this specification and the like, an electrolyte solution may be read as an electrolyte.

The voltage of a positive electrode generally increases with increasing charge voltage of a secondary battery. The positive electrode active material of one embodiment of the present invention has a stable crystal structure even at high voltage. The stable crystal structure of the positive electrode active material in a charged state can inhibit a capacity decrease due to repetitive charging and discharging.

A short circuit of a secondary battery might cause not only malfunction in charge operation and/or discharge operation of the secondary battery but also heat generation and firing. In order to obtain a safe secondary battery, a short-circuit current is preferably inhibited even at high charge voltage. In the positive electrode active material 100 of one embodiment of the present invention, a short-circuit current is inhibited even at high charge voltage. Thus, a secondary battery with high capacity and safety can be obtained.

It is preferable that a secondary battery using the positive electrode active material 100 of one embodiment of the present invention have high capacity, excellent charge and discharge cycle performance, and safety simultaneously.

The gradient of the concentration of the additive element can be evaluated using energy dispersive X-ray spectroscopy (EDX), for example. EDX can be used in combination with SEM or STEM. In EDX measurement, evaluation performed along a line segment connecting two points is referred to EDX linear analysis in some cases. In EDX measurement, to measure a region in a rectangle shape or the like while scanning the region and evaluate the region two-dimensionally is referred to as EDX area analysis in some cases. In addition, to extract data of a linear region from EDX area analysis and evaluate the atomic concentration distribution in the positive electrode active material is also referred to as linear analysis in some cases. In the EDX area analysis and EDX linear analysis, a point where a characteristic X-ray detected value of one element is the maximum is referred to as a concentration peak in some cases.

By EDX area analysis (e.g., element mapping), the concentrations of the additive elements in the surface portion 100a, the inner portion 100b, the vicinity of the crystal grain boundary, and the like of the positive electrode active material 100 can be quantitatively analyzed. By EDX linear analysis, the concentration peak of the additive element can be analyzed.

When the positive electrode active material 100 is analyzed with the EDX linear analysis, a point where the characteristic X-ray detect value(s) of barium and/or magnesium in the surface portion 100a are/is the maximum preferably exists in a region from the surface of the positive electrode active material 100 to a depth of 50 nm toward the center, further preferably to a depth of 30 nm, and still further preferably to a depth of 20 nm.

In addition, the distribution of aluminum contained in the positive electrode active material 100 preferably overlaps with the distribution of barium and/or magnesium. Thus, when the EDX linear analysis is performed, a point where the characteristic X-ray detected value of aluminum in the surface portion 100a is the maximum preferably exists in a region from the surface of the positive electrode active material 100 to a depth of 50 nm toward the center, further preferably to a depth of 40 nm, and still further preferably to a depth of 30 nm.

The distribution regions of barium, magnesium, and aluminum contained in the positive electrode active material 100 preferably overlap with each other such that the concentration peaks of the barium, the magnesium, and the aluminum are different from each other. For example, as shown in FIG. 3A to FIG. 3C2, the concentration peaks of barium and magnesium are preferably located closer to the surface of the positive electrode active material 100 than the concentration peak of aluminum is, and the distribution areas of barium, magnesium, and aluminum preferably overlap with each other. In other words, in the surface portion 100a, the point of the maximum characteristic X-ray detected value of barium and the point of the maximum characteristic X-ray detected value of magnesium are preferably located closer to the surface of the positive electrode active material 100 than the point of the maximum characteristic X-ray detected value of aluminum is, and a region exhibiting the characteristic X-rays of barium, magnesium, and aluminum is preferably included.

### [Crystal Structure]

A material with the layered rock-salt crystal structure, such as lithium cobalt oxide (LiCoO₂), is known to have a high discharge capacity and excel as a positive electrode active material of a secondary battery. Examples of a material with a layered rock-salt crystal structure include a composite oxide represented by LiMO₂.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when high-voltage charging and discharging are performed on LiNiO₂, the crystal structure might be broken because of the distortion. The influence of the Jahn-Teller effect is suggested to be small in LiCoO₂; hence, LiCoO₂ is preferable because the resistance to high-voltage charging and discharging is higher in some cases.

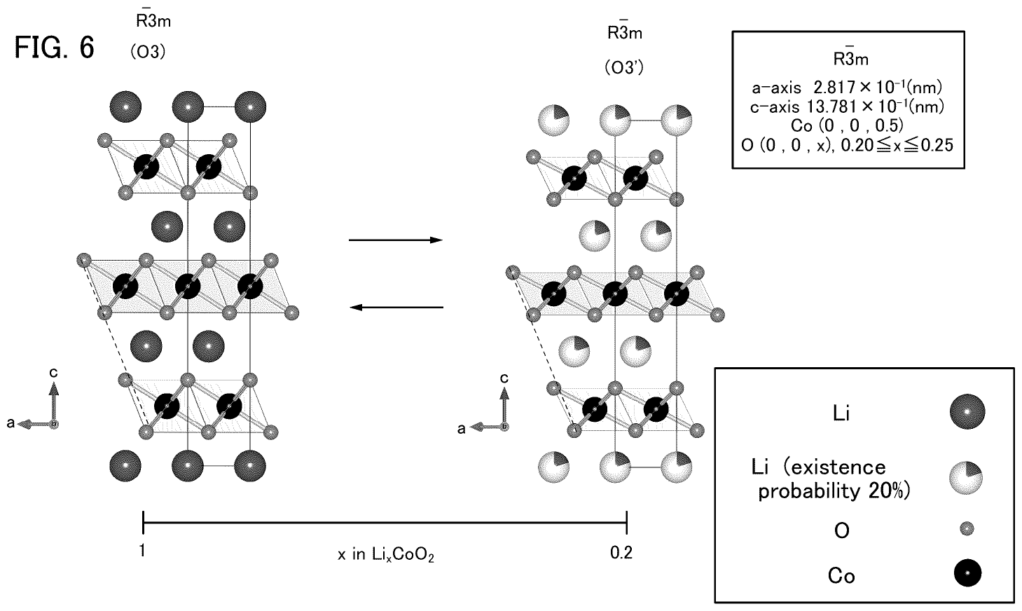

Positive electrode active materials are described with reference to FIG. 6 to FIG. 9. In FIG. 6 to FIG. 9, the case where cobalt is used as the transition metal contained in the positive electrode active material is described.

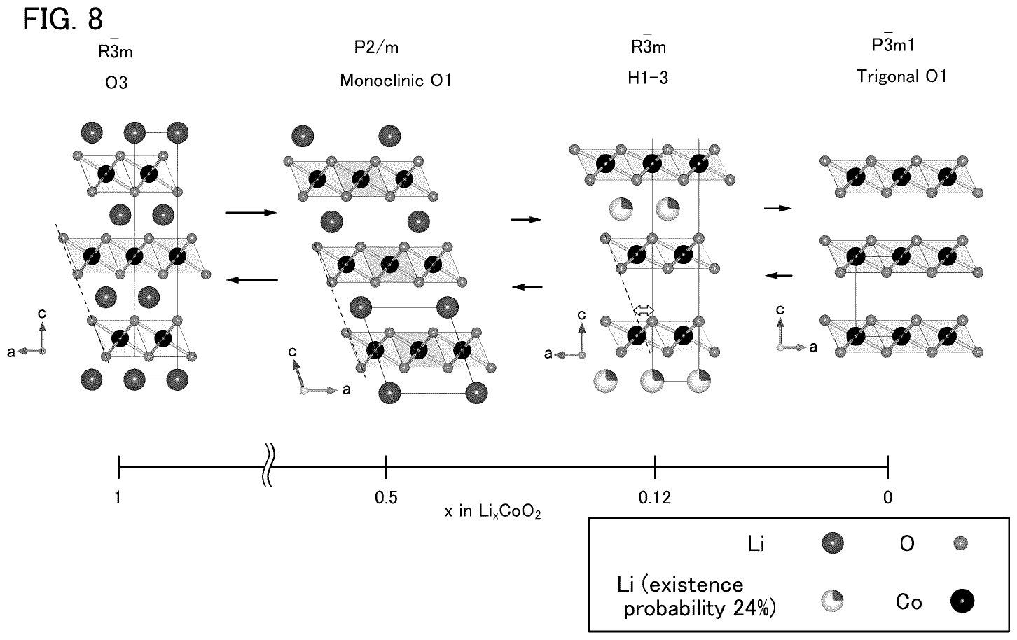

The positive electrode active material illustrated in FIG. 8 is lithium cobalt oxide (LiCoO₂) not containing the additive element X, the additive element Y, and the additive element Z substantially. The crystal structure of the lithium cobalt oxide illustrated in FIG. 8 changes depending on the charge depth. In other words, the crystal structure changes depending on the occupancy rate x of lithium in the lithium sites when the lithium cobalt oxide is referred to as LiₓCoO₂.

In this specification and the like, a charge depth is a value indicating the degree of a capacity that has been charged, i.e., the amount of lithium extracted from a positive electrode, relative to the theoretical capacity of a positive electrode active material as reference. For example, in the case of a positive electrode active material having a layered rock-salt structure such as lithium cobalt oxide (LiCoO₂) or lithium nickel cobalt manganese oxide (LiNiₓCo_{y}Mn_{z}O₂ (x+y+z=1)), a charge depth of 0 indicates a state where no lithium has been extracted from the positive electrode active material; a charge depth of 0.5 indicates a state where lithium corresponding to 137 mAh/g has been extracted from the positive electrode; and a charge depth of 0.8 indicates a state where lithium corresponding to 219.2 mAh/g has been extracted from the positive electrode, relative to the theoretical capacity of 274 mAh/g as reference. In the case of an expression LiₓCoO₂ (0≤x≤1), LiₓCoO₂ is expressed as LiCoO₂ where x is 1 when the charge depth is 0; LiₓCoO₂ is expressed as Li_{0.5}CoO₂ where x is 0.5 when the charge depth is 0.5; and LiₓCoO₂ is expressed as Li_{0.2}CoO₂ where x is 0.2 when the charge depth is 0.8.

As illustrated in FIG. 8, lithium cobalt oxide with a charge depth of 0 (in the discharged state, x=1) includes a region having a crystal structure belonging to the space group R-3m, and includes three CoO₂ layers in a unit cell. Thus, this crystal structure is referred to as an O3 type crystal structure in some cases. Note that the CoO₂ layer has a structure in which an octahedral structure with cobalt coordinated to six oxygen atoms continues on a plane in an edge-shared state.

Lithium cobalt oxide with a charge depth of 1 (x=0) has the crystal structure belonging to the space group P-3m1 and includes one CoO₂ layer in a unit cell. Thus, this crystal structure is referred to as an O1 type crystal structure in some cases.

Lithium cobalt oxide with x of approximately 0.12 has the crystal structure belonging to the space group R-3m. This structure can also be regarded as a structure in which CoO₂ structures such as P-3m1 (O1) and LiCoO₂ structures such as R-3m (O3) are alternately stacked. Thus, this crystal structure is referred to as an H1-3 type crystal structure in some cases. Since insertion and extraction of lithium do not necessarily uniformly occur in reality, the H1-3 type crystal structure is started to be observed when x is approximately 0.25 in practice. The number of cobalt atoms per unit cell in the actual H1-3 type crystal structure is twice that in other structures. However, in this specification including FIG. 8, the c-axis of the H1-3 type crystal structure is half that of the unit cell for easy comparison with the other crystal structures.

For the H1-3 type crystal structure, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). Note that 01 and 02 are each an oxygen atom. In this manner, the H1-3 type crystal structure is represented by a unit cell including one cobalt atom and two oxygen atoms. Meanwhile, the O3′ type crystal structure of an embodiment of the present invention is preferably represented by a unit cell including one cobalt atom and one oxygen atom, as described later. This means that the symmetry of cobalt and oxygen differs between the O3′ type crystal structure and the H1-3 type structure, and the amount of change from the O3 structure is smaller in the O3′ type crystal structure than in the H1-3 type structure. A preferred unit cell for representing a crystal structure in a positive electrode active material is selected such that the value of GOF (goodness of fit) is smaller in Rietveld analysis of XRD patterns, for example.

When charge at a high voltage of 4.6 V or more with reference to the redox potential of a lithium metal or charge with a high charge depth of 0.8 or more (x is less than 0.2) and discharge are repeated, the crystal structure of lithium cobalt oxide changes (i.e., an unbalanced phase change occurs) repeatedly between the H1-3 type crystal structure and the R-3m (O3) structure in a discharged state.

However, there is a large shift in the CoO₂ layers between these two crystal structures. As denoted by the dotted lines and the arrow in FIG. 8, the CoO₂ layer in the H1-3 type crystal structure largely shifts from R-3m (O3). Such a dynamic structural change can adversely affect the stability of the crystal structure.

In addition, there is a large difference in volume; the O3 type crystal structure in a discharged state and the H1-3 type crystal structure, each of which is in a region containing the same number of cobalt atoms, have a difference in volume of more than or equal to 3.0%.

Furthermore, a structure in which CoO₂ layers are arranged continuously, such as P-3m1 (O1), included in the H1-3 type crystal structure is highly likely to be unstable.

Thus, the repeated high-voltage charging and discharging causes loss of the crystal structure of lithium cobalt oxide. The broken crystal structure triggers deterioration of the cycle performance. This is probably because the loss of the crystal structure reduces sites where lithium can stably exist and makes it difficult to insert and extract lithium.

In the positive electrode active material 100 of one embodiment of the present invention, the shift in CoO₂ layers can be small in repeated high-voltage charging and discharging. Furthermore, the change in the volume can be small. Accordingly, the positive electrode active material of one embodiment of the present invention can enable excellent cycle performance. In addition, the positive electrode active material of one embodiment of the present invention can have a stable crystal structure in a high-voltage charged state. Thus, the positive electrode active material of one embodiment of the present invention is less likely to cause a short circuit in some cases while the high-voltage charged state is maintained. This is preferable because the safety is further improved.

The positive electrode active material of one embodiment of the present invention has a small crystal-structure change and a small volume difference per the same number of atoms of the transition metal between a sufficiently discharged state and a high-voltage charged state.

FIG. 6 illustrates the crystal structures of the positive electrode active material 100 before and after being charged and discharged. The positive electrode active material 100 is a composite oxide containing lithium, cobalt as the transition metal, and oxygen. In addition to the above, the positive electrode active material 100 preferably contains barium as the additive element X and magnesium as the additive element Y. Furthermore, fluorine is preferably contained as the additive element Y.

The crystal structure with a charge depth of 0 (discharged state, x=1) in FIG. 6 is R-3m (O3), which is the same as in FIG. 8. Meanwhile, the positive electrode active material 100 with a charge depth in a sufficiently charged state includes a crystal whose structure is different from the H1-3 type crystal structure. This structure belongs to the space group R-3m and is not the spinel crystal structure but has symmetry in cation arrangement similar to that of the spinel structure because an ion of cobalt, magnesium, or the like occupies a site coordinated to six oxygen atoms. Furthermore, the periodicity of CoO₂ layers of this structure is the same as that in the O3 type structure. This structure is thus referred to as the O3′ type crystal structure or the pseudo-spinel crystal structure in this specification and the like. Accordingly, the O3′ type crystal structure may be rephrased as the pseudo-spinel crystal structure. Note that although the indication of lithium is omitted in the diagram of the O3′ type crystal structure illustrated in FIG. 6 to explain the symmetry of cobalt atoms and the symmetry of oxygen atoms, a lithium of 20 atomic % or less, for example, with respect to cobalt practically exists between the CoO₂ layers. In addition, in both the O3 type crystal structure and the O3′ type crystal structure, a slight amount of magnesium preferably exists between the CoO₂ layers, i.e., in lithium sites. In addition, a slight amount of halogen such as fluorine preferably exists at random in oxygen sites.

Note that in the O3′ type crystal structure, a light element such as lithium occupies a site coordinated to four oxygen atoms in some cases. Also in that case, the ion arrangement has symmetry similar to that of the spinel crystal structure.

The O3′ type crystal structure can also be regarded as a crystal structure that contains Li between layers at random but is similar to a CdCl₂ crystal structure. The crystal structure similar to the CdCl₂ crystal structure is close to a crystal structure of lithium nickel oxide when charged until a charge depth becomes 0.94 (x=0.06) (Li_{0.06}NiO₂); however, pure lithium cobalt oxide or a layered rock-salt positive electrode active material containing a large amount of cobalt is known not to have this crystal structure in general.

In the positive electrode active material 100 of one embodiment of the present invention, a change in the crystal structure caused when a large amount of lithium is extracted by charging with high voltage is smaller than that in a conventional positive electrode active material. As indicated by dotted lines in FIG. 6, for example, CoO₂ layers hardly shift between the crystal structures.

Specifically, the crystal structure of the positive electrode active material 100 of one embodiment of the present invention is highly stable even when charge voltage is high. For example, at a charge voltage that makes a conventional positive electrode active material have the H1-3 type crystal structure, for example, at a voltage of approximately 4.6 V with reference to the potential of a lithium metal, the crystal structure belonging to R-3m (O3) can be maintained. Moreover, in a higher charge voltage range, for example, at voltages of approximately 4.65 V to 4.7 V with reference to the potential of a lithium metal, the O3′ type crystal structure can be obtained. At a much higher charge voltage, a H1-3 type crystal is eventually observed in some cases. In the case where graphite, for instance, is used as a negative electrode active material in a secondary battery, a charge voltage region where the R-3m (O3) crystal structure can be maintained exists when the voltage of the secondary battery is, for example, higher than or equal to 4.3 V and lower than or equal to 4.5 V. In a higher charge voltage region, for example, at a voltage higher than or equal to 4.35 V and lower than or equal to 4.55 V with reference to the potential of a lithium metal, there is a region within which the O3′ type crystal structure can be obtained.

Thus, in the positive electrode active material 100 of one embodiment of the present invention, the crystal structure is unlikely to be broken even when high-voltage charging and discharging are repeated.

In addition, in the positive electrode active material 100, a difference in the volume per unit cell between the O3 type crystal structure with a charge depth of 0 (x=1) and the O3′ type crystal structure with a charge depth of 0.8 (x=0.2) is less than or equal to 2.5%, specifically, less than or equal to 2.2%.

Note that in the unit cell of the O3′ type crystal structure, the coordinates of cobalt and oxygen can be represented by Co (0, 0, 0.5) and O (0, 0, x) within the range of 0.20≤x≤0.25.

The additive element Y such as magnesium randomly existing between the CoO₂ layers, i.e., in lithium sites, has an effect of inhibiting a shift in the CoO₂ layers. Thus, magnesium between the CoO₂ layers makes it easier to obtain the O3′ type crystal structure. Therefore, magnesium preferably exists in at least part of the surface portion of the particle of the positive electrode active material 100 of one embodiment of the present invention, further preferably in a region of half or more of the surface portion of the particle, still further preferably in the entire region of the surface portion of the particle. To distribute magnesium into the entire region of the surface portion of the particle, heat treatment is preferably performed in the formation process of the positive electrode active material 100 of one embodiment of the present invention.

However, heat treatment at an excessively high temperature may cause cation mixing, which increases the possibility of entry of the additive element Y such as magnesium into the cobalt sites. Magnesium in the cobalt sites does not have the effect of maintaining the structure belonging to R-3m in high-voltage charge. Furthermore, heat treatment at an excessively high temperature might have an adverse effect; for example, cobalt might be reduced to have a valence of two or lithium might be evaporated.

In view of the above, a halogen compound such as a fluorine compound is preferably added to lithium cobalt oxide before the heat treatment for distributing magnesium over the entire surface portion of the particle. The addition of the halogen compound decreases the melting point of lithium cobalt oxide. The decreased melting point makes it easier to distribute magnesium throughout the particle at a temperature at which the cation mixing is unlikely to occur. Furthermore, the fluorine compound probably increases corrosion resistance to hydrofluoric acid generated by decomposition of an electrolyte solution.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material of one embodiment of the present invention is preferably larger than 0.001 times and less than or equal to 0.1 times, preferably larger than or equal to 0.01 times and less than 0.04 times, still further preferably approximately 0.02 times the number of a transition metal. The magnesium concentration described here may be a value obtained by element analysis on the whole particles of the positive electrode active material using ICP-MS (inductively coupled plasma-mass spectrometry) or the like, or may be a value based on the ratio of the raw materials mixed in the formation process of the positive electrode active material, for example.

As shown in the legend in FIG. 6, gallium, aluminum, boron, indium, and transition metals typified by nickel and manganese preferably exist in cobalt sites; some of them may exist in lithium sites, but the amount of them is preferably small. Magnesium preferably exists in lithium sites. Fluorine may be substituted for part of oxygen.

Use of barium as the additive element X brings the structural stability of the surface portion 100a of the positive electrode active material 100 as verified in the above calculation of barium, and accordingly an increase in stability in a high-voltage charged state can be expected. By the synergetic effect of including the additive element X, the additive element Y, and the additive element Z, the positive electrode active material of one embodiment of the present invention can be a positive electrode active material that is unlikely to deteriorate with high charge and discharge voltages.

In accordance with increases in the contents of the additive element X, the additive element Y, and the additive element Z in the positive electrode active material 100 of one embodiment of the present invention, the capacity of the positive electrode material is reduced in some cases. As a presumable cause, for example, entry of gallium, aluminum, boron, or indium into the transition metal sites prevents a lithium ion existing in the vicinity thereof from contributing to charging and discharging. Another presumable cause is that the amount of lithium contributing to charging and discharging decreases by entry of barium or magnesium into the lithium sites. Moreover, in some cases, excess barium generates a barium compound not contributing to charging and discharging, or excess magnesium generates a magnesium compound not contributing to charging and discharging.

In FIG. 6, the symmetry of the oxygen atoms slightly differs between the O3 type crystal structure and the O3′ type crystal structure. Specifically, the oxygen atoms in the O3 type crystal structure are aligned with the dotted line, whereas strict alignment of the oxygen atoms is not observed in the O3′ type crystal structure. This is caused by an increase in the amount of tetravalent cobalt along with a decrease in the amount of lithium in the O3′ type crystal structure, resulting in an increase in the Jahn-Teller distortion. Consequently, the octahedral structure of CoO₆ is distorted. In addition, repelling of oxygen atoms in the CoO₂ layer becomes stronger along with a decrease in the amount of lithium, which also affects the difference in symmetry of oxygen atoms.

As described above, the surface portion 100a of the positive electrode active material 100 of one embodiment of the present invention preferably has a composition different from that in the inner portion 100b, i.e., the concentrations of the additive element Y such as magnesium and fluorine are preferably higher than those in the inner portion. The surface portion 100a having such a composition preferably has a crystal structure stable at room temperature. Accordingly, the surface portion 100a may have a crystal structure different from that of the inner portion 100b. For example, at least part of the surface portion 100a of the positive electrode active material 100 of one embodiment of the present invention may have the rock-salt crystal structure. When the surface portion 100a and the inner portion 100b have different crystal structures, the orientations of crystals in the surface portion 100a and the inner portion 100b are preferably substantially aligned with each other.

Anions of a layered rock-salt crystal and anions of a rock-salt crystal form a cubic close-packed structure (face-centered cubic lattice structure). Anions of an O3′ type crystal are presumed to form a cubic close-packed structure. When these crystals are in contact with each other, there is a crystal plane at which orientations of cubic closest packed structures composed of anions are aligned. Note that a space group of the layered rock-salt crystal and the O3′ type crystal is R-3m, which is different from a space group Fm-3m of a rock-salt crystal (a space group of a general rock-salt crystal) and a space group Fd-3m of a rock-salt crystal (a space group of a rock-salt crystal having the simplest symmetry); thus, the Miller index of the crystal plane satisfying the above conditions in the layered rock-salt crystal and the O3′ type crystal is different from that in the rock-salt crystal. In this specification, a state where the orientations of the cubic close-packed structures composed of anions in the layered rock-salt crystal, the O3′ type crystal, and the rock-salt crystal are aligned is sometimes referred to as a state where crystal orientations are substantially aligned.

Substantial alignment of the crystal orientations in two regions can be judged from a TEM (transmission electron microscope) image, a STEM (scanning transmission electron microscope) image, a HAADF-STEM (high-angle annular dark-field scanning transmission electron microscope) image, an ABF-STEM (annular bright-field scanning transmission electron microscope) image, or the like. X-ray diffraction (XRD), electron diffraction, neutron diffraction, and the like can also be used for judging. When the crystal orientations are substantially aligned with each other, a state where an angle between the orientations of lines in each of which cations and anions are alternately arranged is less than or equal to 5°, preferably less than or equal to 2.5° is observed from a TEM image and the like. Note that in the TEM image and the like, a light element such as oxygen or fluorine cannot be clearly observed in some cases; however, in such a case, alignment of orientations can be judged by arrangement of metal elements.

However, in the surface portion 100a where only MgO is contained or MgO and CoO(II) form a solid solution, it is difficult to insert and extract lithium. Thus, the surface portion 100a should contain at least cobalt, and also contain lithium in a discharged state to have the path through which lithium is inserted and extracted. The cobalt concentration is preferably higher than the magnesium concentration.

The additive element X, the additive element Y, and the additive element Z are preferably positioned in the surface portion 100a of the particle of the positive electrode active material 100 of one embodiment of the present invention. For example, the positive electrode active material 100 of one embodiment of the present invention may be covered with the coating film containing the additive element X, the additive element Y, and the additive element Z.

The crystal grain boundary is also a type of plane defect. Thus, the crystal grain boundary tends to be unstable and the crystal structure easily starts to change like the surface of the particle. Therefore, when the concentration of the additive element X and/or the additive element Y in the crystal grain boundary and its vicinity are/is higher, the change in the crystal structure can be inhibited more effectively.

In the case where the concentration of the additive element X, the additive element Y and/or the additive element Z is high in the crystal grain boundary and its vicinity, even when a crack is generated along the crystal grain boundary of the particle of the positive electrode active material 100 of one embodiment of the present invention, the concentration of the additive element X, the additive element Y and/or the additive element Z are/is increased in the vicinity of the surface generated by the crack. Thus, the positive electrode active material can have an increased corrosion resistance to hydrofluoric acid even after a crack is generated.

### [High-Voltage Charged State of Positive Electrode Active Material]

Whether or not a given positive electrode active material is the positive electrode active material 100 of one embodiment of the present invention, which has the O3′ type crystal structure at the time of high voltage charging, can be judged by analyzing a positive electrode charged with high voltage by XRD, electron diffraction, neutron diffraction, electron spin resonance (ESR), nuclear magnetic resonance (NMR), or the like. XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example.

As described above, the positive electrode active material 100 of one embodiment of the present invention features in a small change in the crystal structure between a high-voltage charged state and a discharged state. In a high-voltage charged state, a material 50 wt % or more of which is occupied by the crystal structure largely changing from a discharged state is not preferable because the material cannot withstand high-voltage charging and discharging. It should be noted that the intended crystal structure is not obtained in some cases only by addition of the additive. For example, although the positive electrode active material that is lithium cobalt oxide containing magnesium and fluorine is a commonality, the positive electrode active material has the O3′ type crystal structure at 60 wt % or more in some cases, and has the H1-3 type crystal structure at 50 wt % or more in other cases, when charged at high voltage. In some cases, lithium cobalt oxide containing magnesium and fluorine may have the O3′ type crystal structure at almost 100 wt % at a predetermined voltage, and increasing the voltage to be higher than the predetermined voltage may cause the H1-3 type crystal structure. Thus, to determine whether or not a positive electrode active material is the positive electrode active material 100 of one embodiment of the present invention, the crystal structure should be analyzed by XRD or other methods.

However, the crystal structure of a positive electrode active material in a high-voltage charged state or a discharged state may be changed with exposure to the air. For example, the O3′ type crystal structure changes into the H1-3 type crystal structure in some cases. For that reason, all samples are preferably handled in an inert atmosphere such as an argon atmosphere.

### <Charging Method 1>

High-voltage charging for determining whether or not a given composite oxide is the positive electrode active material 100 of one embodiment of the present invention can be performed on a coin cell (CR2032 type with a diameter of 20 mm and a height of 3.2 mm) with a lithium counter electrode, for example.

More specifically, a positive electrode can be formed by application of a slurry in which the positive electrode active material, a conductive material, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, an electrolyte solution in which ethylene carbonate (EC) and diethyl carbonate (DEC) at EC:DEC=3:7 (volume ratio) and vinylene carbonate (VC) at 2 wt % are mixed can be used.

As a separator, 25-μm-thick polypropylene can be used.

Stainless steel (SUS) can be used for a positive electrode can and a negative electrode can.

The coin cell fabricated with the above conditions is charged with constant current at 4.6 V and 0.5 C and then charged with constant voltage until the current value reaches 0.01 C. Note that here, 1 C is set to 137 mA/g. The temperature is set to 25° C. After the charging is performed in this manner, the coin cell is disassembled in a glove box with an argon atmosphere to take out the positive electrode, whereby the positive electrode active material charged with high voltage can be obtained. In order to inhibit a reaction with components in the external environment, the taken positive electrode is preferably enclosed in an argon atmosphere in performing various analyses later. For example, XRD can be performed on the positive electrode active material enclosed in an airtight container with an argon atmosphere.

### <XRD>

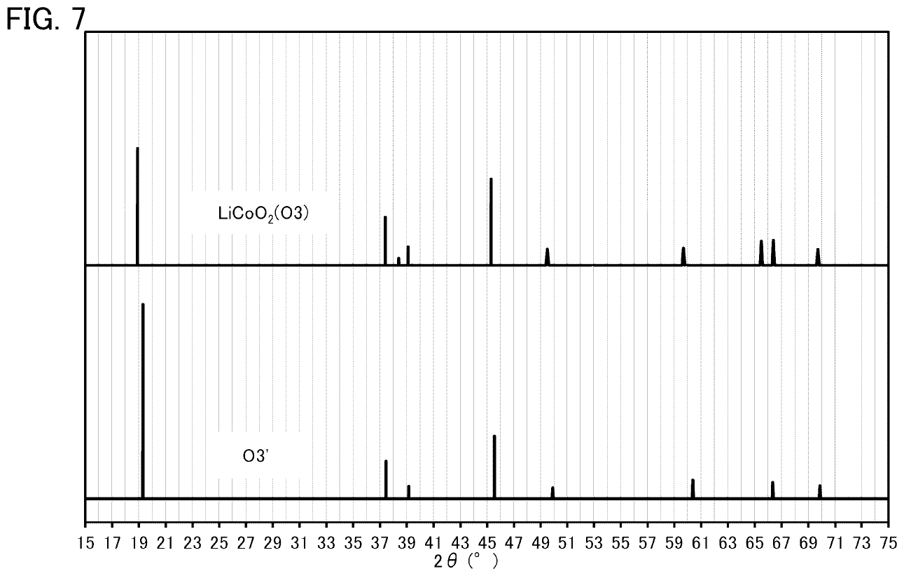

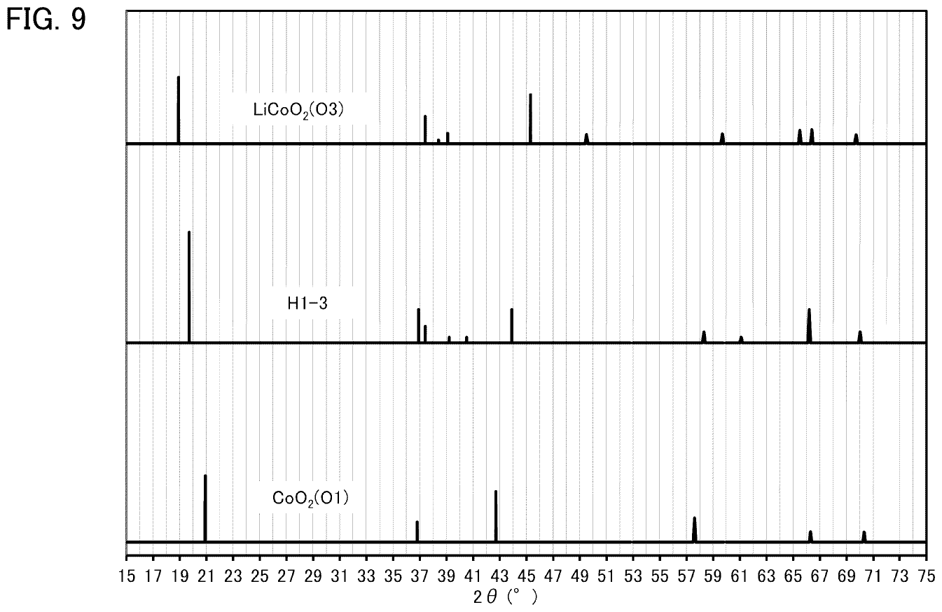

FIG. 7 and FIG. 9 show ideal powder XRD patterns with CuKα1 radiation that are calculated from models of the O3′ type crystal structure and the H1-3 type crystal structure. For comparison, ideal XRD patterns calculated from the crystal structure of LiCoO₂ (O3) with a charge depth of 0 (x=1) and the crystal structure of CoO₂ (O1) with a charge depth of 1 (x=0) are also shown. Note that the patterns of LiCoO₂ (O3) and CoO₂ (O1) are made from crystal structure data obtained from ICSD (Inorganic Crystal Structure Database) using Reflex Powder Diffraction, which is a module of Materials Studio (BIOVIA). The range of 20 was from 15° to 75°, the step size was 0.01, the wavelength λ1 was 1.540562×10-10 m, the wavelength λ2 was not set, and a single monochromator was used. The pattern of the H1-3 type crystal structure was formed on the basis of crystal structure information (W. E. Counts et al., Journal of the American Ceramic Society, 1953, 36 [1], pp. 12-17. Fig. 01471) in a similar manner. The pattern of the O3′ type crystal structure was estimated from the XRD pattern of the positive electrode active material of one embodiment of the present invention, the crystal structure was fitted with TOPAS ver. 3 (crystal structure analysis software manufactured by Bruker Corporation), and XRD patterns were made in a manner similar to those of other structures.

As shown in FIG. 7, the O3′ type crystal structure exhibits diffraction peaks at 2θ of 19.30±0.20° (greater than or equal to 19.10° and less than or equal to 19.50°) and 2θ of 45.55±0.10° (greater than or equal to 45.45° and less than or equal to 45.65°). More specifically, sharp diffraction peaks appear at 2θ of 19.30±0.10° (greater than or equal to 19.20° and less than or equal to 19.40°) and 2θ of 45.55±0.05° (greater than or equal to 45.500 and less than or equal to 45.60°). By contrast, as shown in FIG. 9, the H1-3 type crystal structure and CoO₂ (P-3m1, O1) do not exhibit peaks at these positions. Thus, the peaks at 2θ of 19.30±0.20° and 2θ of 45.55±0.10° in a high-voltage charged state can be the features of the positive electrode active material 100 of one embodiment of the present invention.

It can be said that the positions of the XRD diffraction peaks exhibited by the crystal structure with a charge depth of 0 (x=1) are close to those of the XRD diffraction peaks exhibited by the crystal structure in a high-voltage charged state. More specifically, it can be said that a difference in the positions of two or more, preferably three or more of the main diffraction peaks between the crystal structures is 2θ=0.7° or less, preferably 2θ=0.5° or less.

Although the positive electrode active material 100 of one embodiment of the present invention has the O3′ type crystal structure at the time of high voltage charging, not all the particles necessarily have the O3′ type crystal structure. The positive electrode active material 100 may have another crystal structure or be partly amorphous. Note that when the XRD patterns are subjected to the Rietveld analysis, the O3′ type crystal structure preferably accounts for greater than or equal to 50 wt %, further preferably greater than or equal to 60 wt %, still further preferably greater than or equal to 66 wt %. The positive electrode active material in which the O3′ type crystal structure accounts for greater than or equal to 50 wt %, preferably greater than or equal to 60 wt %, further preferably greater than or equal to 66 wt % can have sufficiently good cycle performance.

Furthermore, even after 100 or more cycles of charging and discharging after the measurement starts, the O3′ type crystal structure preferably accounts for greater than or equal to 35 wt %, further preferably greater than or equal to 40 wt %, still further preferably greater than or equal to 43 wt %, in the Rietveld analysis.

The crystallite size of the O3′ type crystal structure of the positive electrode active material particle is only decreased to approximately one-tenth that of LiCoO₂ (O3) in a discharged state. Thus, a clear peak of the O3′ type crystal structure can be observed in a high-voltage charged state, even under the same XRD measurement conditions as those of a positive electrode before the charging and discharging. By contrast, simple LiCoO₂ has a small crystallite size and exhibits a broad and small peak although it can partly have a structure similar to the O3′ type crystal structure. The crystallite size can be calculated from the half width of the XRD peak.

As described above, the influence of the Jahn-Teller effect is preferably small in the positive electrode active material of one embodiment of the present invention. It is preferable that the positive electrode active material of one embodiment of the present invention have a layered rock-salt crystal structure and mainly contain cobalt as a transition metal. The positive electrode active material of one embodiment of the present invention may contain the above-described additive element X and/or the additive element Y in addition to cobalt as long as the influence of the Jahn-Teller effect is small.

In the positive electrode active material of one embodiment of the present invention, when the layered rock-salt crystal structure of the particle of the positive electrode active material in the discharged state or the state where charging and discharging are not performed is subjected to XRD analysis, a first peak is observed at 2θ of greater than or equal to 18.50° and less than or equal to 19.30°, and a second peak is observed at 2θ of greater than or equal to 38.00° and less than or equal to 38.80°, in some cases.

Note that the peaks appearing in the powder XRD patterns reflect the crystal structure of the inner portion 100b of the positive electrode active material 100, which accounts for the majority of the volume of the positive electrode active material 100. The crystal structure of the surface portion 100a or the like can be analyzed by electron diffraction of a cross section of the positive electrode active material 100, for example.

### [Defects in Positive Electrode Active Material]

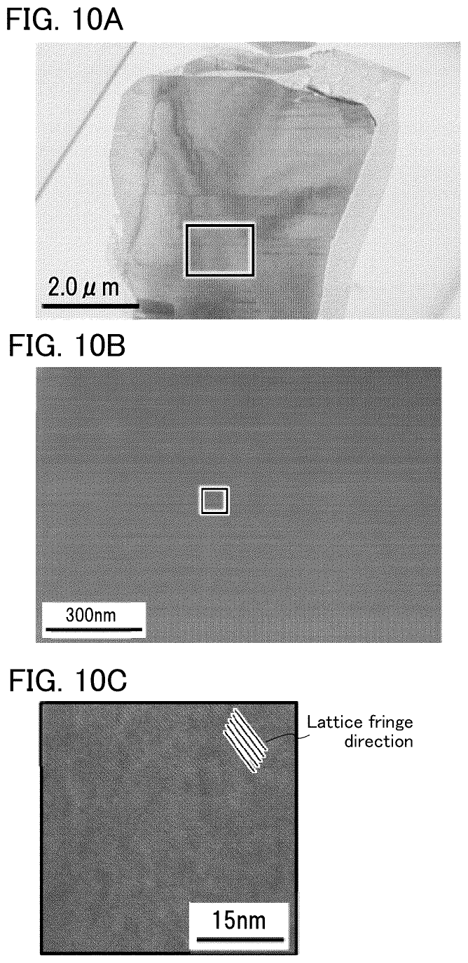

Examples of defects that can be generated in the positive electrode active material are shown in FIG. 10 to FIG. 13. An effect of inhibiting the generation of defects described below can be expected in the positive electrode active material of one embodiment of the present invention.

Charging and discharging is performed under a high-voltage charge condition that is higher than or equal to 4.5 V or at a high temperature (higher than or equal to 45° C.), whereby a closed split (also referred to as a closed crack or crack closure) that is one of progressive defects might be generated inside a positive electrode active material.

To give an example of a defect, a positive electrode sample was fabricated in the following manner: a positive electrode active material not containing the additive element X was prepared; and slurry in which the positive electrode active material, a conductive material, and a binder were mixed was applied on a positive electrode current collector made of aluminum foil. A coin cell (CR2032 type, diameter: 20 mm, height: 3.2 mm) was fabricated with use of the positive electrode sample as a positive electrode and lithium foil as a negative electrode, and charging and discharging were repeated 50 times. The charge condition was such that, after constant current charging was performed at 0.5 C up to 4.7 V, constant voltage charging was performed until the current value reached 0.05 C. As discharging, constant current discharging was performed at 0.5 C until the voltage reached 2.5 V. Note that here, 1 C was set to 200 mA/g. Three temperatures conditions, 25° C., 45° C., and 60° C., were set. After the charging and discharging were repeated 50 times in the above manner, the coin cell was disassembled in a glove box containing an argon atmosphere, whereby the positive electrode was taken out. Actual positive electrode samples that were taken out and degraded were Sample C1, Sample C2, and Sample C3. Here, Sample C1 refers to the positive electrode that had been subjected to the test at 25° C., Sample C2 refers to the positive electrode that had been subjected to the test at 45° C., and Sample C3 refers to the positive electrode that had been subjected to the test at 60° C.

### <STEM Observation>

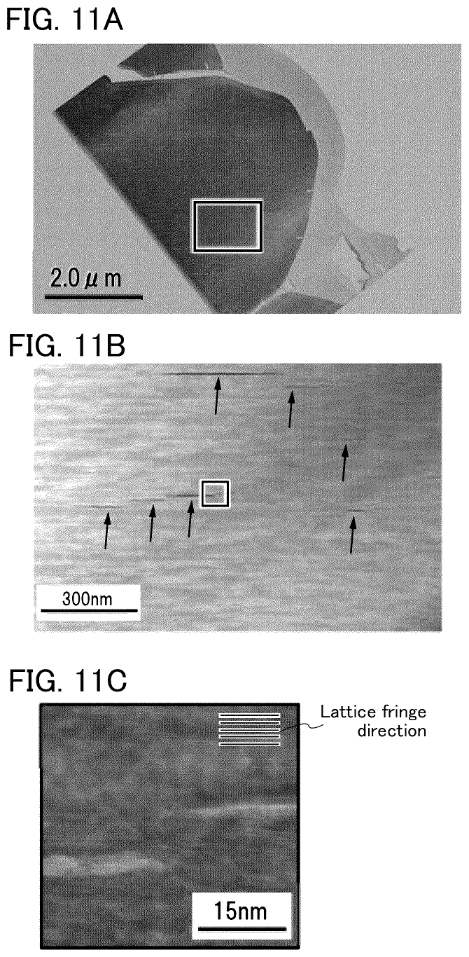

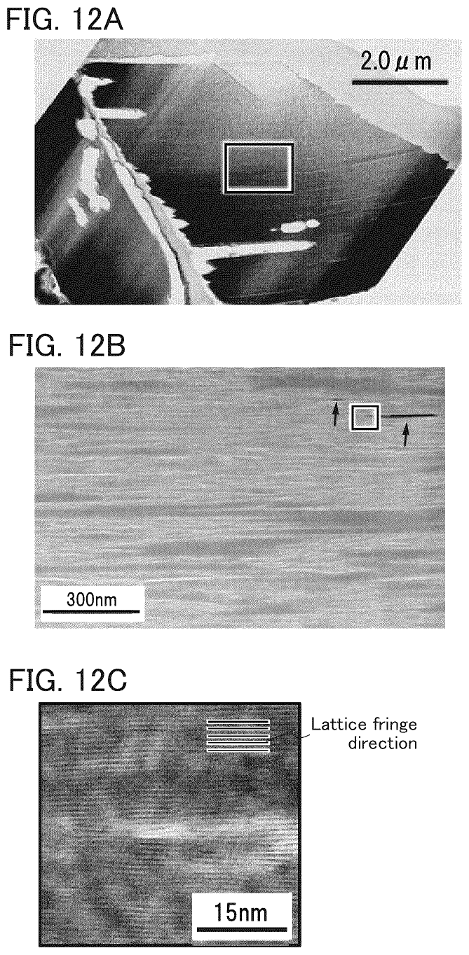

Then, a cross section of the positive electrode of a secondary battery after 50 cycles was observed with a scanning transmission electron microscope (STEM). FIB (Focused Ion Beam) was used for the processing of the samples for the cross-sectional observation. FIG. 10A to FIG. 10C show results of cross-sectional STEM observation of Sample C1. FIG. 11A to FIG. 11C show results of cross-sectional STEM observation of Sample C2. FIG. 12A to FIG. 12C show results of cross-sectional STEM observation of Sample C3. FIG. 10C is an enlarged image of a region surrounded by a solid line in FIG. 10B, and FIG. 10B is an enlarged view of a region surrounded by a solid line in FIG. 10A. FIG. 11C is an enlarged view of a region surrounded by a solid line in FIG. 11B, and FIG. 11B is an enlarged view of a region surrounded by a solid line in FIG. 11A. FIG. 12C is an enlarged view of a region surrounded by a solid line in FIG. 12B, and FIG. 12B is an enlarged view of a region surrounded by a solid line in FIG. 12A. To obtain the cross-sectional STEM images, HD-2700 produced by Hitachi High-Technologies Corporation was used at an accelerating voltage of 200 kV.

In Sample C1 subjected to the cycle test at 25° C., as shown in FIG. 10A to FIG. 10C, any closed split is not observed in the inner portion of the positive electrode active material. By contrast, in Sample C2 subjected to the cycle test at 45° C., as shown in FIG. 11A to FIG. 11C, closed splits are observed in the inner portion of the positive electrode active material. Also in Sample C3 subjected to the cycle test at 60° C., as shown in FIG. 12A to FIG. 12C, closed splits are observed in the inner portion of the positive electrode active material. In FIG. 10 to FIG. 12, arrows indicate the closed splits. Note that the observed closed splits are extended in parallel to lattice fringes. The lattice fringes shown in FIG. 10C, FIG. 11C, and FIG. 12C are the image contrast originating from the atomic arrangement (crystal plane) of the positive electrode active material, and in this case, the lattice fringes are presumed to originate from a crystal plane perpendicular to the c-axis

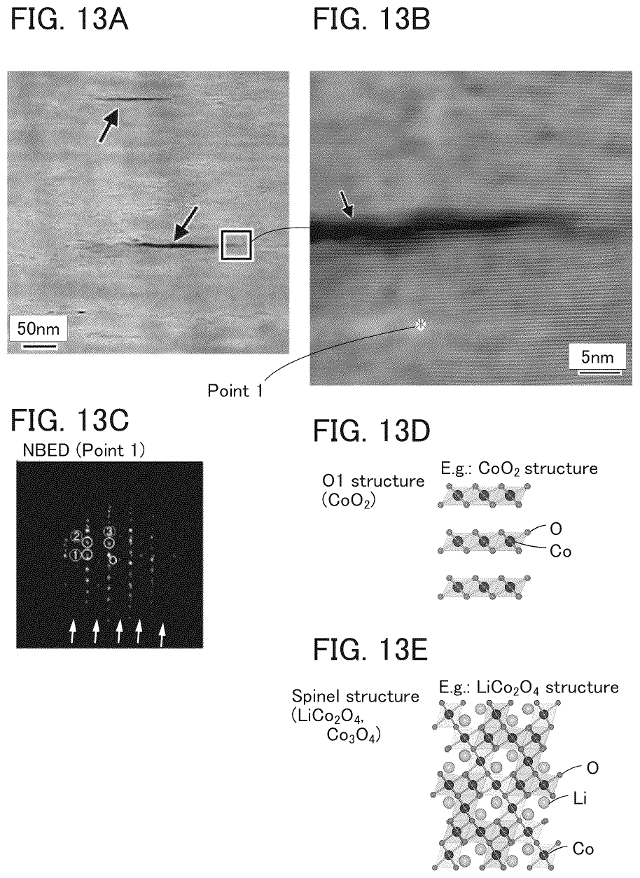

FIG. 13A to FIG. 13E show results of detail analysis of Sample C2 shown in FIG. 11A to FIG. 11C. FIG. 13B is an enlarged image of a region surrounded by a solid line in FIG. 13A. Nano-beam electron diffraction (NBED) was performed on a point (Point 1 in FIG. 13B) near the closed split, whereby Sample C2 was found to exhibit diffraction patterns originating from a spinel structure (white arrows in FIG. 13C) and diffraction patterns identified with an O1 structure (reference numerals 1, 2, and 3 in FIG. 13C). The diffraction spot 1, the diffraction spot 2, the diffraction spot 3, and a transmission spot O in FIG. 13C were analyzed. As a result, the interplanar spacing (d) calculated from the distance between the diffraction spot 1 and the transmission spot O was 0.239 nm, the interplanar spacing (d) calculated from the distance between the diffraction spot 2 and the transmission spot O was 0.208 nm, and the interplanar spacing (d) calculated from the distance between the diffraction spot 3 and the transmission spot O was 0.429 nm. The angle formed by the diffraction spot 1, the transmission spot O, and the diffraction spot 2 was 29°, the angle formed by the diffraction spot 1, the transmission spot O, and the diffraction spot 3 was 89°, and the angle formed by the diffraction spot 2, the transmission spot O, and the diffraction spot 3 was 60°. Thus, Sample C2 has a possibility of including a region of CoO₂ existing as the O1 structure, for example. FIG. 13D illustrates a CoO₂ structure as an example of the O1 structure, and FIG. 13E illustrates a LiCo₂O₄ structure as an example of the spinel structure.

### [Calculation 1 of Closed Split]

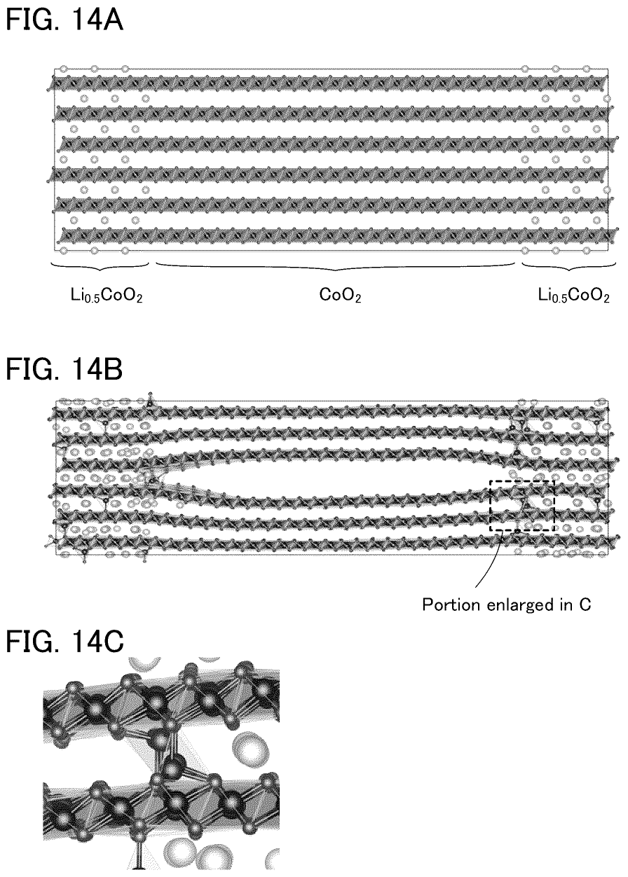

On the basis of the analysis results shown in FIG. 13A to FIG. 13E, molecular dynamics calculation of the closed split was performed according to a program of SCIGRESS. CoO₂ and Li_{0.5}CoO₂ were subjected to structure optimization with a program of VASP and then to Bader charge analysis of charge density distribution, so that average values of the electric charge of atoms used in the molecular dynamics calculation were obtained. The Table 1 to Table 3 show conditions of the calculation. Table 1 shows VASP conditions, Table 2 shows conditions of charge of atoms obtained by Bader charge analysis, and Table 3 shows SCIGRESS conditions. FIG. 14A shows a structural model used in the molecular dynamics calculation. FIG. 14B shows a structure after the calculation. FIG. 14C is an enlarged view of part of FIG. 14B.

TABLE 1

| Software | VASP |
|---|---|
| Functional | GGA + U (DFT-D2) |
| Pseudopotential | PAW |
| Cutoff energy (eV) | 600 |

| | | |
|---|---|---|
| U potential | Co | 4.91 |

| | |
|---|---|
| k-points | 1 × 1 × 1 |
| Calculation | Optimize lattice and atom positions |

TABLE 2

| | Li_{0.5}CoO₂ | CoO₂ |
|---|---|---|
| Li | 0.896 | — |
| Co | 1.486 | 1.58 |
| O | −0.967 | −0.79 |

TABLE 3

| Ensemble | NTV | |
|---|---|---|
| Temperature | 298 | K |
| Time step size | 1 | fs |
| Simulation time | 30 | ps |

As in the analysis results shown in FIG. 13, a region having the O1 structure (CoO₂) was observed in the vicinity of the closed split. In this sample, the discharge capacity was reduced to approximately 50% by the charge and discharge cycle test before the cross-sectional STEM analysis was performed. Thus, CoO₂ and Li_{0.5}CoO₂ are considered. CoO₂ is in a state where all Li atoms are extracted from LiCoO₂ in a completely discharged state, Li_{0.5}CoO₂ is in a state where the charge depth is 0.5 (x=0.5) and half the number of Li atoms are extracted from LiCoO₂ in a completely discharged state. When compared to Li_{0.5}CoO₂, CoO₂ has a different length of c-axis of a unit cell from Li_{0.5}CoO₂, which leads to a suggestion that stress is generated in a region where CoO₂ and Li_{0.5}CoO₂ are in contact with each other. Thus, a structural model of a region where e CoO₂ and Li_{0.5}CoO₂ are in contact with each other was formed as illustrated in FIG. 14A and used for the molecular dynamics calculation. As the calculation conditions, an NTV ensemble was used, the temperature was room temperature (298 K), the time step size was 1 fs, and the simulation time was 30 ps. As the calculation program, SCIGRESS was used.

FIG. 14B shows a calculation result obtained by relaxing the structural model illustrated in FIG. 14A at room temperature, which exhibits the formation of one closed split at a center of the drawing. Accordingly, in a region where CoO₂ and Li_{0.5}CoO₂ are in contact with each other, there is possibility that a stress originating from a difference in the c-axis length is generated and CoO₂ (is more likely to be deformed than Li_{0.5}CoO₂) is stretched, whereby a closed split is generated. Furthermore, as shown in FIG. 14C, part of a spinel structure was formed in the vicinity of the closed split.

### [Calculation 2 of Closed Split]

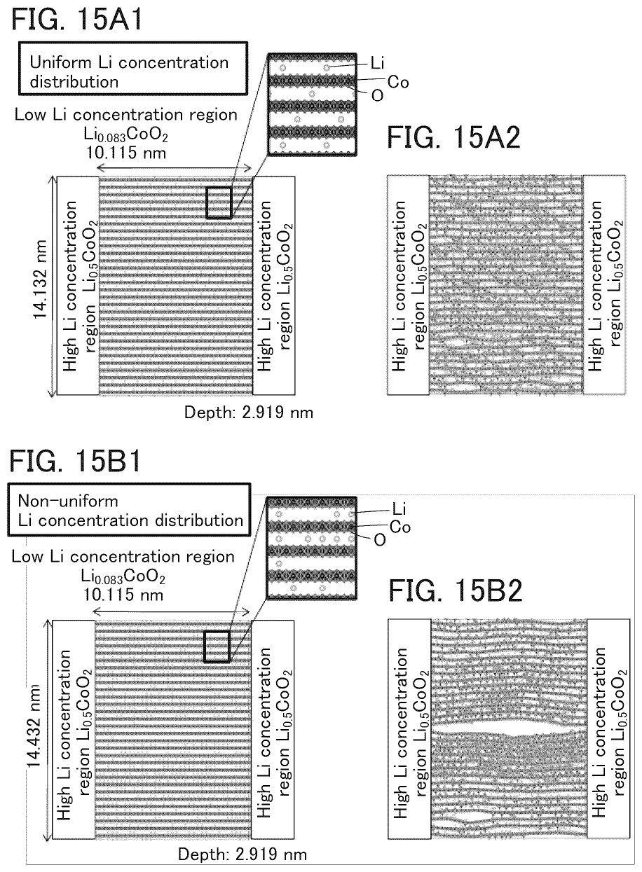

With use of a structural model different from that for Calculation 1 of closed split, molecular dynamics calculation was performed on closed split. The electric charge of atoms were as follows: Li, 0.8964; Co, 1.5073; and O, −0.7910. As the calculation conditions, an NTV ensemble was used, the temperature was room temperature (298 K), the time step size was 1 fs, and the simulation time was 10 ps. As the calculation program, SCIGRESS was used. FIG. 15A1 and FIG. 15B1 illustrate structural models used for calculation. FIG. 15A2 and FIG. 15B2 illustrate structures after the calculation.

In Calculation 2 of closed split, a region corresponding to a structure of CoO₂ in Calculation 1 of closed split was set to a structure of Li_{0.083}CoO₂. Furthermore, the region of a structure of Li_{0.5}CoO₂ was not provided, and Co and O at the right end were fixed. The structural model and the structure after the calculation illustrated in FIG. 15A1 and FIG. 15A2 show the case where Li distribution in the Li_{0.083}CoO₂ region is uniform. The structural model and the structure after the calculation illustrated in FIG. 15B1 and FIG. 15B2 show the case where Li distribution in the Li_{0.083}CoO₂ region is not uniform.

As the calculation results illustrated in FIG. 15A2 and FIG. 15B2, a closed spilt with a width of approximately 1 nm occurs as illustrated in FIG. 15B2 in the case where Li distribution is not uniform, whereas the width of the generated closed split is less than 0.5 nm as illustrated in FIG. 15A2 in the case where Li distribution is uniform. This indicates a possibility that the generation of closed split can be inhibited in the case where Li distribution in a positive electrode active material is uniform in a charged state. For example, in high-voltage charging with a charge depth greater than or equal to 0.8 (x is lower than 0.2), it is preferable that the Li be distributed uniformly in a positive electrode active material. In the positive electrode active material of one embodiment of the present invention, uniform Li distribution can be expected in high-voltage charging with a charge depth greater than or equal to 0.8 (x is lower than 0.2).

### [Surface Roughness and Specific Surface Area]

The positive electrode active material 100 of one embodiment of the present invention preferably has a smooth surface with little unevenness. A smooth surface with little unevenness indicates uniform distribution of the additive element Y in the surface portion 100a.

A smooth surface with little unevenness can be recognized from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image, as described below, for example.

First, the positive electrode active material 100 is processed with an FIB or the like such that its cross section is exposed. At this time, the positive electrode active material 100 is preferably covered with a protective film, a protective agent, or the like. Next, a SEM image of the interface between the positive electrode active material 100 and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 100 and the protective film or the like is selected with a magic hand tool or the like, and data is extracted to spreadsheet software or the like. With use of the function of the spreadsheet software or the like, correction is performed using regression curves (quadratic regression), parameters for calculating roughness are obtained from data subjected to slope correction, and root-mean-square (RMS) surface roughness is obtained by calculating standard deviation. This surface roughness refers to the surface roughness in at least 400 nm of the particle periphery of the positive electrode active material.

On the surface of the particle of the positive electrode active material 100 of this embodiment, root-mean-square (RMS) surface roughness, which is an index of roughness, is preferably less than 3 nm, further preferably less than 1 nm, still further preferably less than 0.5 nm.

Note that the image processing software used for the noise processing, the interface extraction, or the like is not particularly limited, and for example, “ImageJ” can be used. In addition, the spreadsheet software or the like is not particularly limited, and Microsoft Office Excel can be used, for example.

For example, the level of surface smoothness of the positive electrode active material 100 can also be quantified from the ratio of an actual specific surface area A_{R} measured by a constant-volume gas adsorption method to an ideal specific surface area Aᵢ.

The median diameter D50 can be measured with a particle size distribution analyzer or the like using a laser diffraction and scattering method. The specific surface area can be measured with a specific surface area analyzer or the like by a constant-volume gas adsorption method, for example.

The ideal specific surface area Aᵢ is calculated on the assumption that all the particles have the same diameter as D50, have the same weight, and have ideal spherical shapes.

In the positive electrode active material 100 of one embodiment of the present invention, the ratio of the actual specific surface area A_{R} to the ideal specific surface area Aᵢ (assuming a perfect sphere) obtained from the median diameter D50 (A_{R}/Aᵢ) is preferably greater than or equal to 1 and less than or equal to 2.

When the particle diameter of the positive electrode active material 100 of one embodiment of the present invention is too large, there are problems such as difficulty in lithium diffusion and large surface roughness of an active material layer at the time when the material is applied to a current collector. By contrast, when the particle diameter is too small, there are problems such as difficulty in loading of the active material layer at the time when the material is applied to the current collector and overreaction with an electrolyte solution. Therefore, an average particle diameter (D50, also referred to as median diameter) is preferably greater than or equal to 1 μm and less than or equal to 100 μm, further preferably greater than or equal to 2 μm and less than or equal to 40 μm, still further preferably greater than or equal to 5 m and less than or equal to 30 μm.

This embodiment can be implemented in appropriate combination with the other embodiments.

### Embodiment 3

In this embodiment, examples of shapes of a plurality of secondary batteries including the positive electrode active material 100 formed by the formation method described in the above embodiment will be described.

### [Coin-Type Secondary Battery]

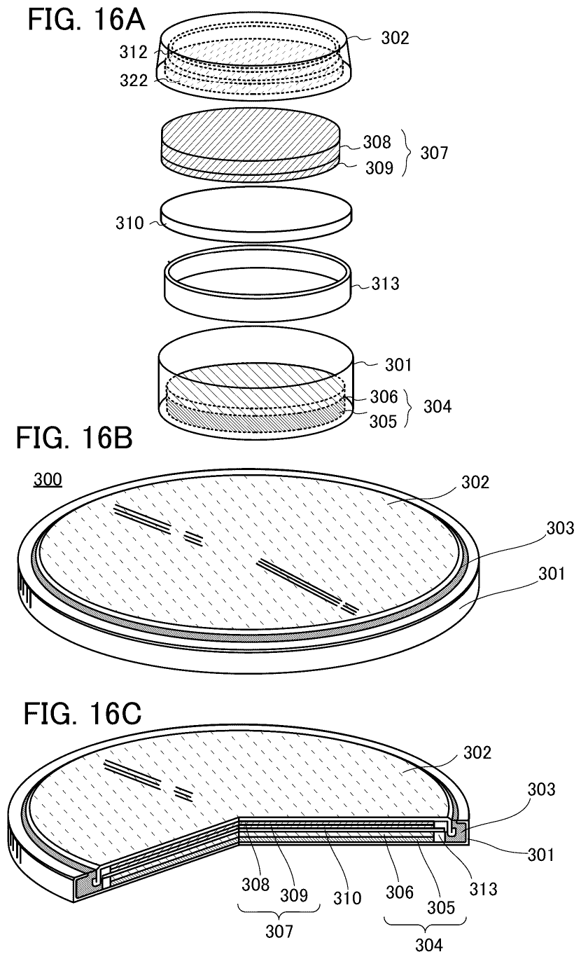

An example of a coin-type secondary battery is described. FIG. 16A is an exploded perspective view of a coin-type (single-layer flat type) secondary battery, FIG. 16B is an external view thereof, and FIG. 16C is a cross-sectional view thereof. Coin-type secondary batteries are mainly used in small electronic devices. In this specification and the like, coin-type batteries include button-type batteries.

For easy understanding, FIG. 16A is a schematic view showing overlap (a vertical relation and a positional relation) between components. Thus, FIG. 16A and FIG. 16B do not completely correspond with each other.

In FIG. 16A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 16A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

To prevent a short circuit between the positive electrode and the negative electrode, the separator 310 and a ring-shaped insulator 313 are placed to cover the side surface and top surface of the positive electrode 304. The separator 310 has a larger flat surface area than the positive electrode 304.

FIG. 16B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of the current collector of each of the positive electrode 304 and the negative electrode 307 used for the coin-type secondary battery 300 is provided with an active material layer.

For the positive electrode can 301 and the negative electrode can 302, a metal having corrosion resistance to an electrolyte, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, and the like in order to prevent corrosion due to the electrolyte, for example. The positive electrode can 301 and the negative electrode can 302 are electrically connected to the positive electrode 304 and the negative electrode 307, respectively.

The coin-type secondary battery 300 is manufactured in the following manner: the negative electrode 307, the positive electrode 304, and the separator 310 are immersed in the electrolyte solution; as illustrated in FIG. 16C, the positive electrode 304, the separator 310, the negative electrode 307, and the negative electrode can 302 are stacked in this order with the positive electrode can 301 positioned at the bottom; and then the positive electrode can 301 and the negative electrode can 302 are subjected to pressure bonding with the gasket 303 therebetween.

With the above structure, the coin-type secondary battery 300 can have high capacity, high charge and discharge capacity, and excellent cycle performance. Note that in the case of a secondary battery including a solid electrolyte layer between the negative electrode 307 and the positive electrode 304, the separator 310 is not necessarily provided.

### [Cylindrical Secondary Battery]

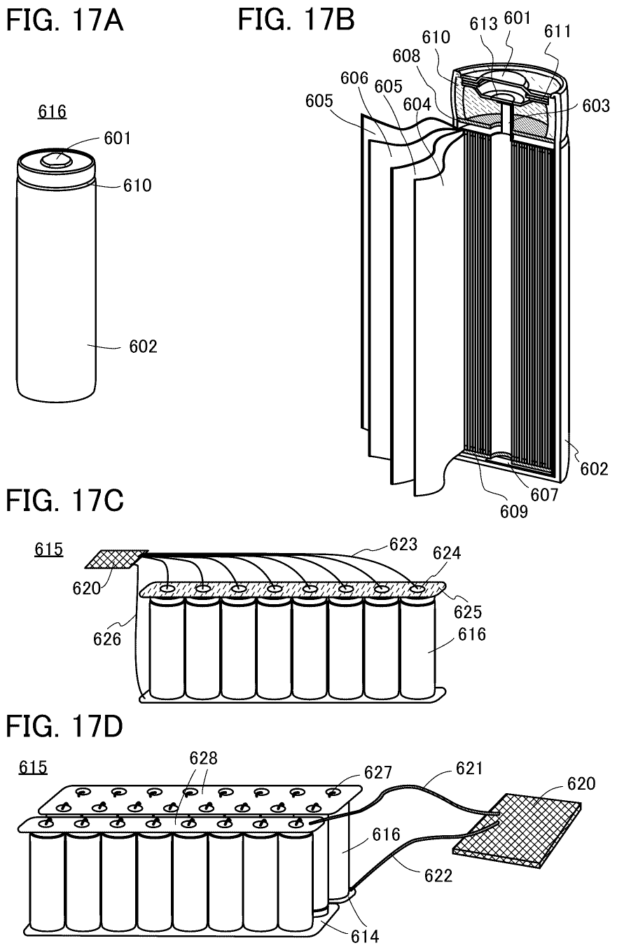

An example of a cylindrical secondary battery is described with reference to FIG. 17A. As illustrated in FIG. 17A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 17B schematically illustrates a cross section of a cylindrical secondary battery. The cylindrical secondary battery illustrated in FIG. 17B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a belt-like positive electrode 604 and a belt-like negative electrode 606 are wound with a belt-like separator 605 located therebetween is provided. Although not illustrated, the battery element is wound around a central axis. One end of the battery can 602 is close and the other end thereof is open. For the battery can 602, a metal having corrosion resistance to an electrolyte solution, such as nickel, aluminum, or titanium, an alloy of such a metal, and an alloy of such a metal and another metal (e.g., stainless steel) can be used. The battery can 602 is preferably covered with nickel, aluminum, and the like in order to prevent corrosion due to the electrolyte solution. Inside the battery can 602, the battery element in which the positive electrode, the negative electrode, and the separator are wound is provided between a pair of insulating plates 608 and 609 that face each other. A nonaqueous electrolyte solution (not illustrated) is injected inside the battery can 602 provided with the battery element. A nonaqueous electrolyte solution similar to that for the coin-type secondary battery can be used.

Since a positive electrode and a negative electrode that are used for a cylindrical storage battery are wound, active materials are preferably formed on both surfaces of a current collector. Note that although FIG. 17A to FIG. 17D each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

The positive electrode active material 100 obtained in the above embodiment is used for the positive electrode 604, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO3)-based semiconductor ceramic or the like can be used for the PTC element.

FIG. 17C illustrates an example of a power storage system 615. The power storage system 615 includes a plurality of the secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharging or overdischarging can be used, for example.

FIG. 17D illustrates an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 17D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### [Other Structure Examples of Secondary Battery]

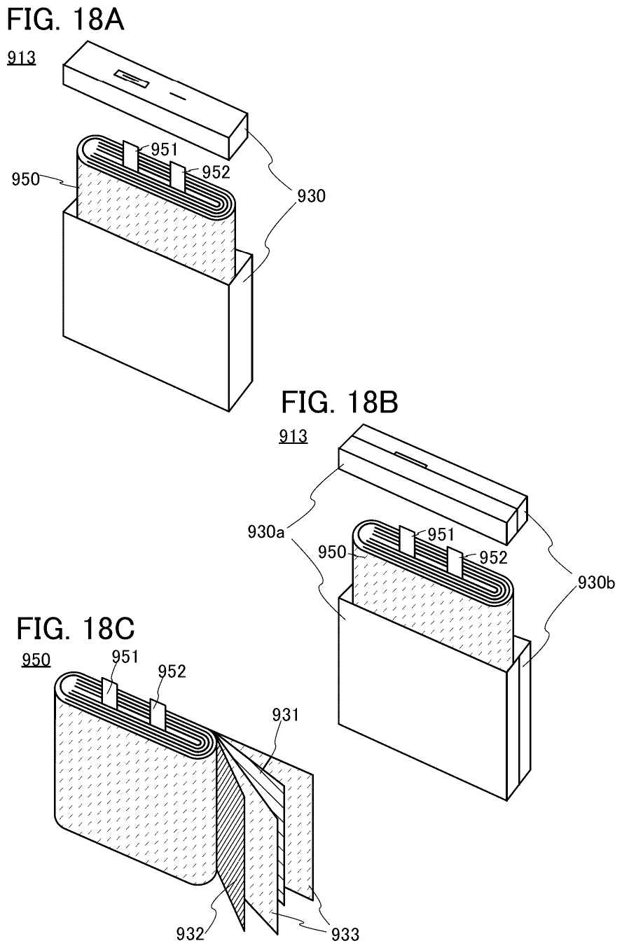

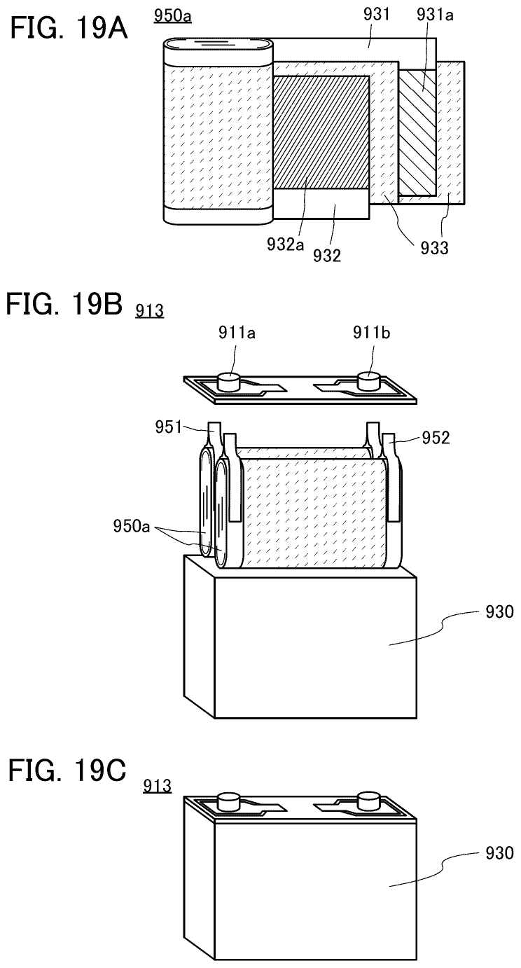

Structure examples of secondary batteries are described with reference to FIG. 18 and FIG. 19.

A secondary battery 913 illustrated in FIG. 18A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 18A, the housing 930 divided into pieces is illustrated for convenience; however, in the actual structure, the wound body 950 is covered with the housing 930 and the terminal 951 and the terminal 952 extend to the outside of the housing 930. For the housing 930, a metal material (e.g., aluminum) or a resin material can be used.

Note that as illustrated in FIG. 18B, the housing 930 illustrated in FIG. 18A may be formed using a plurality of materials. For example, in the secondary battery 913 illustrated in FIG. 18B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

Furthermore, FIG. 18C illustrates the structure of the wound body 950. The wound body 950 includes a negative electrode 931, a positive electrode 932, and separators 933. The wound body 950 is obtained by rolling a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 19A to FIG. 19C, the secondary battery 913 may include a wound body 950a. The wound body 950a illustrated in FIG. 19A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 obtained in the above embodiment is used for the positive electrode 932, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 19B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 19C, the wound body 950a and an electrolyte solution are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 19B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 18A to FIG. 18C can be referred to for the other components of the secondary battery 913 illustrated in FIG. 19A and FIG. 19B.

### <Laminated Secondary Battery>

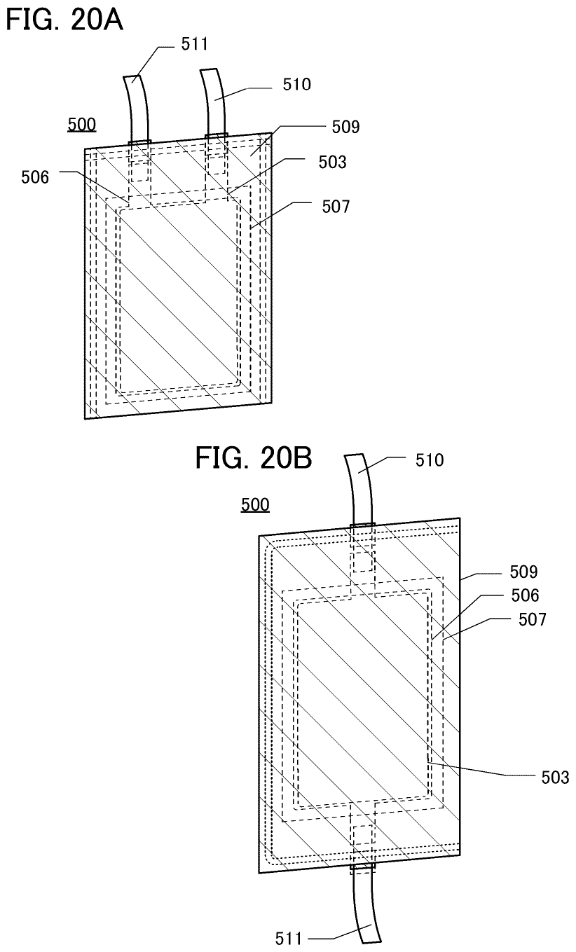

Next, examples of the appearance of a laminated secondary battery are illustrated in FIG. 20A and FIG. 20B. In FIG. 20A and FIG. 20B, a positive electrode 503, a negative electrode 506, a separator 507, an exterior body 509, a positive electrode lead electrode 510, and a negative electrode lead electrode 511 are included.

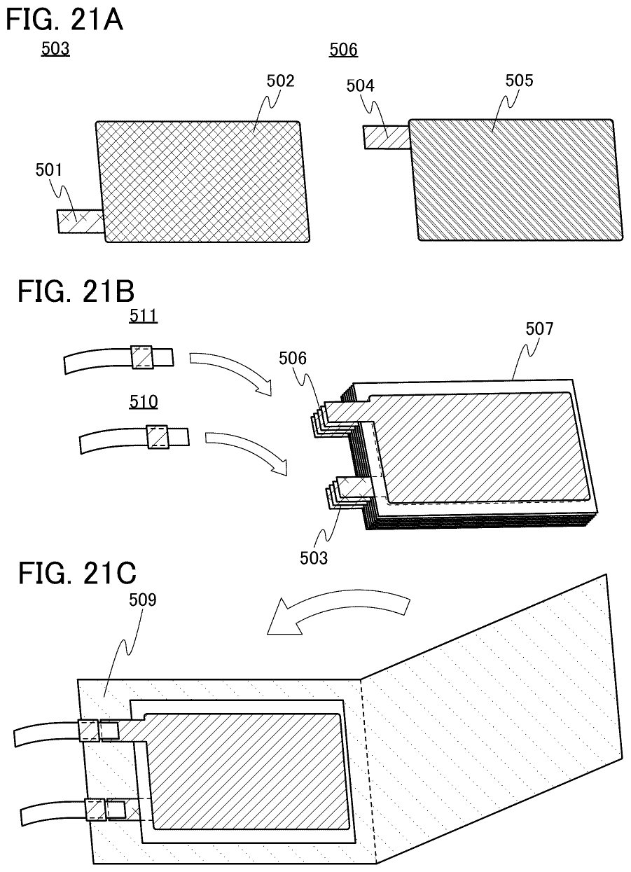

FIG. 21A illustrates the appearance of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter, referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to the examples illustrated in FIG. 21A.

### <Method for Fabricating Laminated Secondary Battery>

Here, an example of a method for fabricating the laminated secondary battery whose external view is illustrated in FIG. 20A is described with reference to FIG. 21B and FIG. 21C.

First, the negative electrode 506, the separator 507, and the positive electrode 503 are stacked. FIG. 21B illustrates the negative electrodes 506, the separators 507, and the positive electrodes 503 that are stacked. Here, an example in which five negative electrodes and four positive electrodes are used is shown. The negative electrode, the separator, and the positive electrode that are stacked can be referred to as a stack. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

After that, the negative electrodes 506, the separators 507, and the positive electrodes 503 are placed over the exterior body 509.

Subsequently, the exterior body 509 is folded along a portion shown by a dashed line, as illustrated in FIG. 21C. Then, the outer edges of the exterior body 509 are bonded to each other. The bonding can be performed by thermocompression, for example. At this time, an unbonded region (hereinafter, referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, a laminated secondary battery 500 can be fabricated.

The positive electrode active material 100 described in the above embodiment is used for the positive electrode 503, whereby the secondary battery 500 can have high capacity, high charge and discharge capacity, and excellent cycle performance.

### [Examples of Battery Pack]

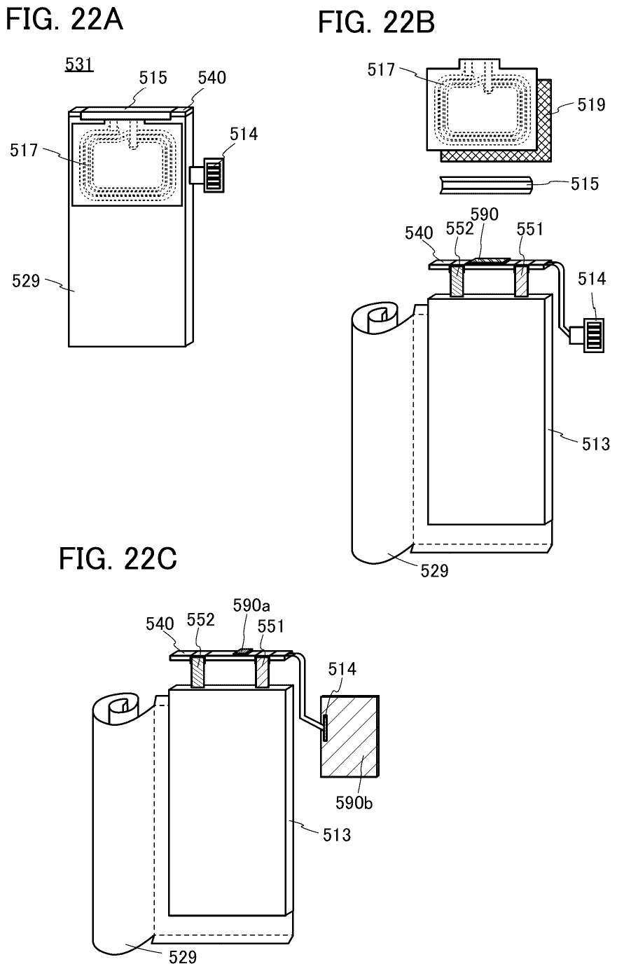

Examples of a secondary battery pack of one embodiment of the present invention that is capable of wireless charging using an antenna are described with reference to FIG. 22A to FIG. 22C.

FIG. 22A is a diagram illustrating the appearance of a secondary battery pack 531 that has a rectangular solid shape with a small thickness (also referred to as a flat plate shape with a certain thickness). FIG. 22B is a diagram illustrating a structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

A wound body or a stack may be included inside the secondary battery 513.

In the secondary battery pack 531, a control circuit 590 is provided over the circuit board 540 as illustrated in FIG. 22B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

Alternatively, as illustrated in FIG. 22C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

### [Positive Electrode]

The positive electrode includes a positive electrode active material layer and a positive electrode current collector. The positive electrode active material layer includes a positive electrode active material, and may include a conductive material and a binder. As the positive electrode active material, the positive electrode active material 100 formed by the formation method described in the above embodiments is used.

A cross-sectional structure example of a positive electrode active material layer containing graphene or a graphene compound as a conductive material is described below. The graphene compound will be described later.

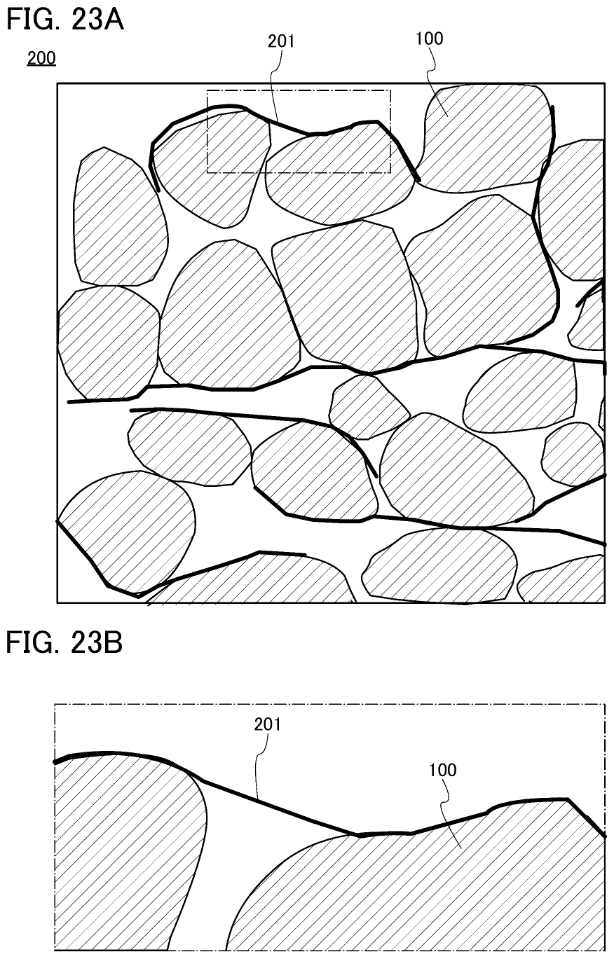

FIG. 23A is a longitudinal cross-sectional view of a positive electrode active material layer 200. The positive electrode active material layer 200 includes particles of the positive electrode active material 100, graphene or a graphene compound 201 serving as the conductive material, and a binder (not illustrated).

It is particularly effective to use a graphene compound as a conductive material of a secondary battery that needs to be rapidly charged and discharged. For example, a secondary battery for a two- or four-wheeled vehicle, a secondary battery for a drone, or the like is required to have fast charge and fast discharge characteristics in some cases. In addition, a mobile electronic device or the like is required to have fast charge characteristics in some cases. Fast charge and discharge may also be referred to as charge and discharge at a high rate, for example, at 1 C, 2 C, or 5 C or more.

The longitudinal cross section of the positive electrode active material layer 200 in FIG. 23B shows substantially uniform dispersion of the sheet-like graphene or the graphene compound 201 in the positive electrode active material layer 200. The graphene or the graphene compound 201 is schematically shown by the thick line in FIG. 23B but is actually a thin film having a thickness corresponding to the thickness of a single layer or a multi-layer of carbon molecules. A plurality of sheets of graphene or the plurality of graphene compounds 201 are formed to partly cover or adhere to the surfaces of the plurality of particles of the positive electrode active material 100, so that the plurality of sheets of graphene or the plurality of graphene compounds 201 make surface contact with the particles of the positive electrode active material 100.

Here, the plurality of sheets of graphene or the plurality of graphene compounds can be bonded to each other to form a net-like graphene compound sheet (hereinafter, referred to as a graphene compound net or a graphene net). A graphene net that covers the active material can function as a binder for bonding the active material particles. Accordingly, the amount of the binder can be reduced, or the binder does not have to be used. This can increase the proportion of the active material in the electrode volume and the electrode weight. That is to say, the charge and discharge capacity of the secondary battery can be increased.

Here, it is preferable to perform reduction after a layer to be the positive electrode active material layer 200 is formed in such a manner that graphene oxide is used as the graphene or the graphene compound 201 and mixed with an active material. In other words, the formed active material layer preferably contains reduced graphene oxide. When graphene oxide with extremely high dispersibility in a polar solvent is used for the formation of the graphene or the graphene compound 201, the graphene or the graphene compound 201 can be substantially uniformly dispersed in the positive electrode active material layer 200. The solvent is removed by volatilization from a dispersion medium in which graphene oxide is uniformly dispersed, and the graphene oxide is reduced; hence, the sheets of graphene or the graphene compounds 201 remaining in the positive electrode active material layer 200 partly overlap with each other and are dispersed such that surface contact is made, thereby forming a three-dimensional conduction path. Note that graphene oxide can be reduced by heat treatment or with use of a reducing agent, for example.

Unlike a conductive material in the form of particles, such as acetylene black, which makes point contact with an active material, the graphene or the graphene compound 201 is capable of making low-resistance surface contact; accordingly, the electrical conduction between the particles of the positive electrode active material 100 and the graphene or the graphene compound 201 can be improved with a small amount of the graphene and the graphene compound 201 compared with a normal conductive material. This can increase the proportion of the positive electrode active material 100 in the positive electrode active material layer 200. Thus, discharge capacity of the secondary battery can be increased.

It is possible to form, with a spray dry apparatus, a graphene compound serving as a conductive material as a coating film to cover the entire surface of the active material in advance and to form a conductive path between the active materials using the graphene compound.

The positive electrode active material described in the above embodiments and another positive electrode active material may be mixed to be used as the positive electrode active material layer 200.

Example of the another positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

As the another positive electrode active material, it is preferable to mix lithium nickel oxide (represented as LiNiO₂, LiNi₁₋ₓMₓO₂ (0<x<1) (M=Co, Al, or the like), or the like) with a lithium-containing material that has a spinel crystal structure and contains manganese, such as LiMn₂O₄. This composition can improve the characteristics of the secondary battery.

The applicable another example of the positive electrode active material is a lithium-manganese composite oxide that can be represented by a composition formula LiₐMn_{b}M_{c}O_{d}. Here, the element M is preferably silicon, phosphorus, or a metal element other than lithium and manganese, further preferably nickel. In the case where the whole particle of a lithium-manganese composite oxide is measured, it is preferable to satisfy the following at the time of discharging: 0<a/(b+c)<2; c>0; and 0.26≤(b+c)/d<0.5. Note that the proportions of metals, silicon, phosphorus, and the like in the whole particle of a lithium-manganese composite oxide can be measured with, for example, an ICP-MS (inductively coupled plasma mass spectrometer). The proportion of oxygen in the whole particle of a lithium-manganese composite oxide can be measured by, for example, EDX (energy dispersive X-ray spectroscopy). Alternatively, the proportion of oxygen can be measured by ICP-MS analysis combined with fusion gas analysis and valence evaluation of XAFS (X-ray absorption fine structure) analysis. Note that the lithium-manganese composite oxide is an oxide containing at least lithium and manganese, and may contain at least one selected from chromium, cobalt, aluminum, nickel, iron, magnesium, molybdenum, zinc, indium, gallium, copper, titanium, niobium, silicon, phosphorus, and the like.

### <Conductive Material>

A conductive material is also referred to as a conductivity-imparting agent or a conductive additive, and a carbon material is used. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

Typical examples of the carbon material used as the conductive material include carbon black (e.g., furnace black, acetylene black, and graphite).

Graphene or a graphene compound is used as the conductive material, which is further preferable.

A graphene compound in this specification and the like refers to multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring of carbon. The two-dimensional structure formed of the six-membered ring of carbon may be referred to as a carbon sheet. A graphene compound may include a functional group. The graphene compound is preferably bent. A graphene compound may be rounded like a carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide may also be referred to as a carbon sheet. Only one sheet of the reduced graphene oxide can function but may have a stacked structure of multiple sheets. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

The graphene and graphene compound may have excellent electrical characteristics of high conductivity and excellent physical properties of high flexibility and high mechanical strength. The graphene and graphene compound have a sheet-like shape. The graphene and graphene compound have a curved surface in some cases, thereby enabling low-resistant surface contact. Furthermore, the graphene and graphene compound sometimes have extremely high conductivity even with a small thickness, and thus a small amount of them efficiently allows a conductive path to be formed in an active material layer. Hence, the use of graphene or a graphene compound as a conductive material can increase the area where an active material and the conductive material are in contact with each other. The graphene or a graphene compound preferably covers 80% or more of the area of an active material. Note that the graphene or the graphene compound preferably clings to at least part of the active material particle. Alternatively, the graphene or the graphene compound preferably overlays at least part of the active material particle. Alternatively, the shape of the graphene or the graphene compound preferably conforms to at least part of the shape of the active material particle. The shape of an active material particle means, for example, unevenness of a single active material particle or unevenness formed by a plurality of active material particles. The graphene or the graphene compound preferably surrounds at least part of the active material particle. The graphene or the graphene compound may have a hole.

In the case where active material particles with a small diameter (e.g., 1 μm or less) are used, the specific surface area of the active material particles is large and thus more conductive paths for the active material particles are needed. In such a case, it is preferable to use graphene or a graphene compound that can efficiently form a conductive path even with a small amount be used.

It is particularly effective to use a graphene compound, which has the above-described properties, as a conductive material of a secondary battery that needs to be rapidly charged and discharged. For example, a secondary battery for a two- or four-wheeled vehicle, a secondary battery for a drone, or the like is required to have fast charge and fast discharge characteristics in some cases. In addition, a mobile electronic device or the like is required to have fast charge characteristics in some cases. In addition, a mobile electronic device or the like is required to have fast charge characteristics in some cases. Fast charge and discharge may also be referred to as charge and discharge at a high rate, for example, at 1 C, 2 C, or 5 C or more.

A material used in formation of the graphene or graphene compound may be mixed with the graphene or graphene compound to be used for the active material layer. For example, particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The median diameter (D50) of the particles is preferably less than or equal to 1 μm, further preferably less than or equal to 100 nm.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferred that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of a slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is further desirable that the passivation film can conduct lithium ions while inhibiting electrical conduction.

### <Positive Electrode Current Collector>

The current collector can be formed using a material that has high conductivity, such as a metal like stainless steel, gold, platinum, aluminum, or titanium, or an alloy thereof. It is preferred that a material used for the positive electrode current collector not be dissolved at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer may contain a conductive material and a binder.

For the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiOₓ. Here, x preferably has an approximate value of 1. For example, x is preferably greater than or equal to 0.2 and less than or equal to 1.5, or preferably greater than or equal to 0.3 and less than or equal to 1.2.

As the carbon-based material, graphite, graphitizing carbon (soft carbon), non-graphitizing carbon (hard carbon), carbon nanotube, graphene, carbon black, or the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery using graphite can have a high operating voltage. In addition, graphite is preferred because of its advantages such as a relatively high capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M is Co, Ni, or Cu) with a Li₃N structure, which is a composite nitride of lithium and a transition metal, can be used. For example, Li_{2.6}Co_{0.4}N₃ is preferable because of high charge and discharge capacity (900 mAh/g and 1890 mAh/cm³).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that even in the case of using a material containing lithium ions as a positive electrode active material, the composite nitride of lithium and a transition metal can be used as the negative electrode active material by extracting the lithium ions contained in the positive electrode active material in advance.

A material that causes a conversion reaction can be used for the negative electrode active material. For example, a transition metal oxide that does not form an alloy with lithium, such as cobalt oxide (CoO), nickel oxide (NiO), or iron oxide (FeO), may be used as the negative electrode active material. Other examples of the material which causes a conversion reaction include oxides such as Fe₂O₃, CuO, Cu₂O, RuO₂, and Cr₂O3, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

As the negative electrode active material, lithium can be also used. In the case of using lithium as the negative electrode active material, lithium foil can be provided over the negative electrode current collector. Lithium may also be provided over the negative electrode current collector by a gas phase method such as an evaporation method or a sputtering method. In a solution containing lithium ions, lithium may be precipitated on the negative electrode current collector by an electrochemical method.

For the conductive additive and the binder that can be included in the negative electrode active material layer, materials similar to those for the conductive additive and the binder that can be included in the positive electrode active material layer can be used.

For the negative electrode current collector, copper or the like can be used in addition to a material similar to that for the positive electrode current collector. Note that a material that is not alloyed with carrier ions of lithium or the like is preferably used for the negative electrode current collector.

As another form of the negative electrode of the present invention, a negative electrode that does not include a negative electrode active material can be used. In a secondary battery including the negative electrode that does not include a negative electrode active material, lithium can be precipitated on a negative electrode current collector at the time of charging, and lithium on the negative electrode current collector can be dissolved at the time of discharging. Thus, lithium is on the negative electrode current collector in the states except for the completely discharged state.

When the negative electrode that does not contain a negative electrode active material is used, a film may be included over a negative electrode current collector for uniforming lithium deposition. For the film for uniforming lithium deposition, for example, a solid electrolyte having lithium ion conductivity can be used. As a solid electrolyte, a sulfide-particle-based solid electrolyte, an oxide-based solid electrolyte, or a polymer-based solid electrolyte can be used, for example. In particular, the polymer-based solid electrolyte can be uniformly formed as a film over a negative electrode current collector relatively easily, and thus is preferable as the film for uniforming lithium deposition.

When the negative electrode that does not contain a negative electrode active material is used, a negative electrode current collector having unevenness can be used. When the negative electrode current collector having unevenness is used, a depression of the negative electrode current collector becomes a cavity in which lithium contained in the negative electrode current collector is easily deposited, so that the lithium can be prevented from having a dendrite-like shape when being deposited.

### [Electrolyte Solution]

As one mode of the electrolyte, an electrolyte solution containing a solvent and an electrolyte dissolved in the solvent can be used. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

Alternatively, the use of one or more ionic liquids (room temperature molten salts) which have features of non-flammability and non-volatility as the solvent of the electrolyte solution can prevent a power storage device from exploding, catching fire, and the like even when the power storage device internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₂, LiCF₃SO₃, LiC₄F₉SO₃, LiC(CF₃SO₂)₃, LiC(C₂FsSO₂)₃, LiN(CF₃SO₂)₂, LiN(C₄F₉SO₂)(CF₃SO₂), LiN(C₂FsSO₂)₂, and lithium bis(oxalate)borate (Li(C₂O₄)₂, LiBOB) can be used, or two or more of these lithium salts can be used in an appropriate combination at an appropriate ratio.

The electrolyte solution used for a power storage device is preferably highly purified and contains a small number of dust particles or elements other than the constituent elements of the electrolyte solution (hereinafter, also simply referred to as impurities). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of such an additive agent in the solvent in which the electrolyte is dissolved is, for example, higher than or equal to 0.1 wt % and lower than or equal to 5 wt %.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

### [Separator]

The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Although a material in a glass state can be used as a ceramic material, the material preferably has a low electron conductivity, unlike glass used for an electrode. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charge at high voltage can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

The contents in this embodiment can be freely combined with the contents in the other embodiments.

### Embodiment 4

In this embodiment, an example in which an all-solid-state battery is fabricated using the positive electrode active material 100 obtained in the above embodiment will be described.

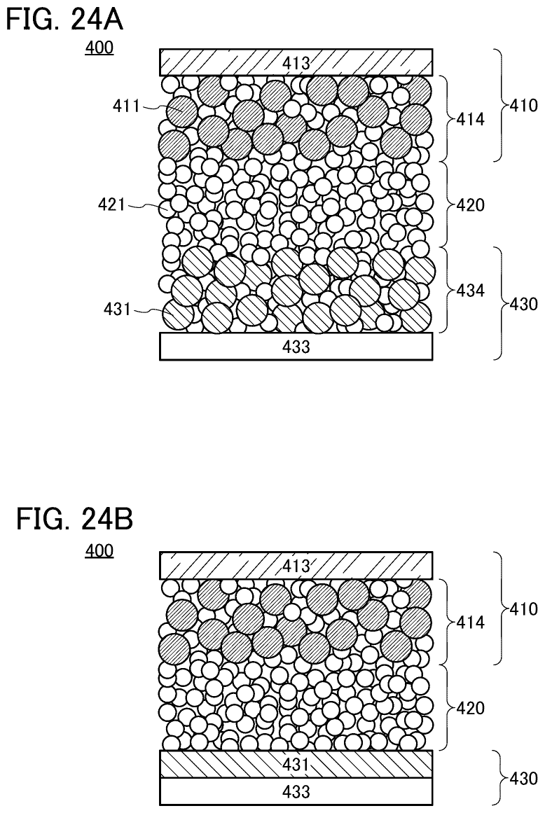

As illustrated in FIG. 24A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The positive electrode active material 100 obtained in the above embodiment is used as the positive electrode active material 411. The positive electrode active material layer 414 may also include a conductive additive and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may include a conductive additive and a binder. Note that when metal lithium is used as the negative electrode active material 431, metal lithium does not need to be processed into particles; thus, the negative electrode 430 that does not include the solid electrolyte 421 can be formed, as illustrated in FIG. 24B. The use of metal lithium for the negative electrode 430 is preferable because the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

The sulfide-based solid electrolyte includes a thio-LISICON-based material (e.g., Li₁₀GeP₂Si₂ or Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, or 50Li₂S·50GeS₂), or sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charging and discharging because of its relative softness.

The oxide-based solid electrolyte includes a material with a perovskite crystal structure (e.g., La_{2/3-x}Li₃ₓTiO₃), a material with a NASICON crystal structure (e.g., Li_{1-Y}Al_{Y}Ti_{2-Y}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ or 50Li₄SiO₄·50Li₃BO₃), or oxide-based crystallized glass (e.g., Li_{1.07}Al_{0.69}Ti_{1.46}(PO₄)₃ or Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₊ₓAlₓTi₂₋ₓ(PO₄)₃(0<x<1) having a NASICON crystal structure (hereinafter, LATP) is preferable because it contains aluminum and titanium, each of which is the element the positive electrode active material used in the secondary battery 400 of one embodiment of the present invention is allowed to contain, and thus synergy of improving the cycle performance is expected. Moreover, higher productivity due to the reduction in the number of steps is expected. Note that in this specification and the like, a NASICON crystal structure refers to a compound that is represented by M₂(XO₄)₃ (M: transition metal; X: S, P, As, Mo, W, or the like) and has a structure in which MO₆ octahedrons and XO₄ tetrahedrons that share common corners are arranged three-dimensionally.

### [Exterior Body and Shape of Secondary Battery]

An exterior body of the secondary battery 400 of one embodiment of the present invention can be formed using a variety of materials and have a variety of shapes, and preferably has a function of applying pressure to the positive electrode, the solid electrolyte layer, and the negative electrode.

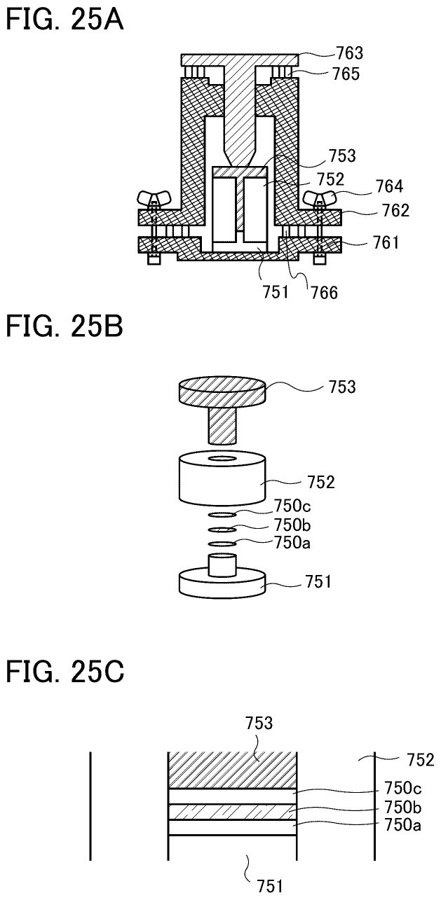

FIG. 25 illustrates an example of a cell for evaluating materials of an all-solid-state battery, for example.

FIG. 25A is a cross-sectional schematic view of the evaluation cell, and the evaluation cell includes a lower component 761, an upper component 762, and a fixation screw or a butterfly nut 764 for fixing these components; by rotating a pressure screw 763, an electrode plate 753 is pressed to fix an evaluation material. An insulator 766 is provided between the lower component 761 and the upper component 762 that are made of a stainless steel material. An O ring 765 for hermetic sealing is provided between the upper component 762 and the pressure screw 763.

The evaluation material is placed on an electrode plate 751, surrounded by an insulating tube 752, and pressed from above by the electrode plate 753. FIG. 25B is an enlarged perspective view of the evaluation material and its vicinity.

A stack of a positive electrode 750a, a solid electrolyte layer 750b, and a negative electrode 750c is illustrated here as an example of the evaluation material, and its cross-sectional view is illustrated in FIG. 25C. Note that the same portions in FIG. 25A to FIG. 25C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

A package having excellent airtightness is preferably used as the exterior body of the secondary battery of one embodiment of the present invention. For example, a ceramic package or a resin package can be used. The exterior body is sealed preferably in a closed atmosphere where the outside air is blocked, for example, in a glove box.

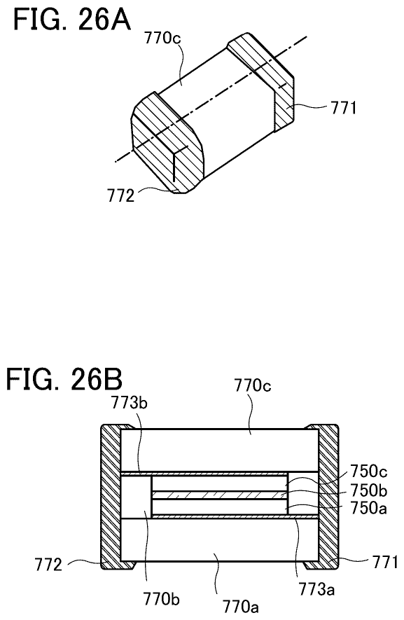

FIG. 26A illustrates a perspective view of a secondary battery of one embodiment of the present invention that has an exterior body and a shape different from those in FIG. 25. The secondary battery in FIG. 26A includes external electrodes 771 and 772 and is sealed with an exterior body including a plurality of package components.

FIG. 26B illustrates an example of a cross section along the dashed-dotted line in FIG. 26A. A stack including the positive electrode 750a, the solid electrolyte layer 750b, and the negative electrode 750c has a structure of being surrounded and sealed by a package component 770a including an electrode layer 773a on a flat plate, a frame-like package component 770b, and a package component 770c including an electrode layer 773b on a flat plate. For the package components 770a, 770b, and 770c, an insulating material, e.g., a resin material and ceramic, can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

The use of the positive electrode active material 100 obtained in the above embodiment can achieve an all-solid-state secondary battery having a high energy density and favorable output characteristics.

The contents in this embodiment can be combined with the contents in the other embodiments as appropriate.

### Embodiment 5

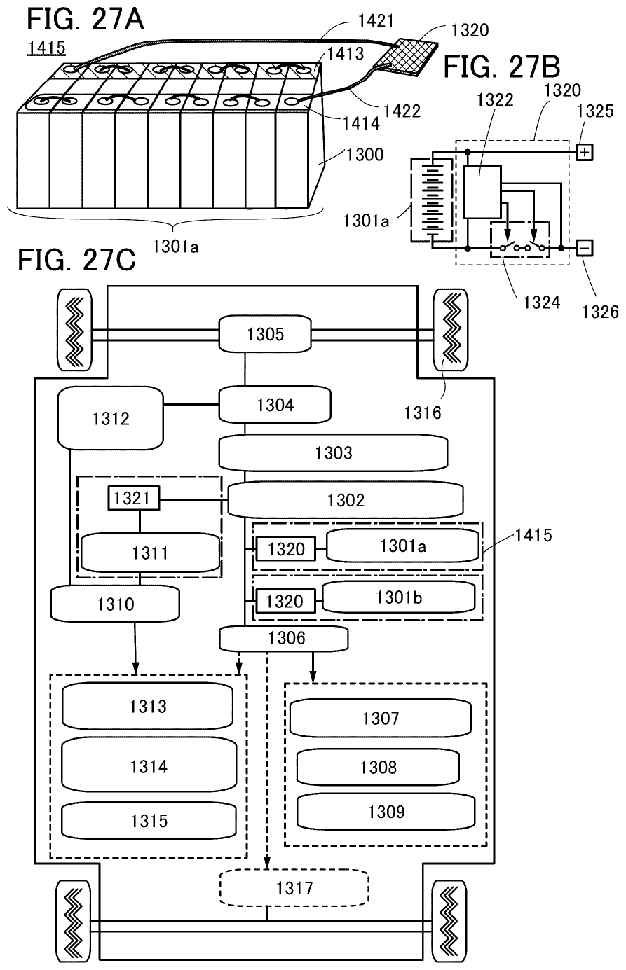

In this embodiment, an example in which a secondary battery different from the cylindrical secondary battery in FIG. 17D is used in an electric vehicle (EV) will be described with reference to FIG. 27C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed; the capacity of the second battery 1311 is lower than that of the first batteries 1301a and 1301b.

The internal structure of the first battery 1301a may be the wound structure illustrated in FIG. 18A or FIG. 19C or the stacked-layer structure illustrated in FIG. 20A or FIG. 20B. Alternatively, the first battery 1301a may be an all-solid-state battery in Embodiment 4. The use of the all-solid-state battery in Embodiment 4 as the first battery 1301a can achieve high capacity, improvement in safety, and reduction in size and weight.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (such as a stereo 1313, a power window 1314, and lamps 1315) through a DCDC circuit 1310.

The first battery 1301a will be described with reference to FIG. 27A.

FIG. 27A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the oxide, a metal oxide such as an In-M-Zn oxide (the element M is one or more kinds selected from aluminum, gallium, tin, yttrium, copper, vanadium, beryllium, boron, titanium, iron, nickel, germanium, zirconium, molybdenum, lanthanum, cerium, neodymium, hafnium, tantalum, tungsten, magnesium, and the like) or the like is preferably used. In particular, the In-M-Zn oxide that can be used as the oxide is preferably a CAAC-OS (C-Axis Aligned Crystalline Oxide Semiconductor) or a CAC-OS (Cloud-Aligned Composite Oxide Semiconductor). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the film thickness direction of a CAAC-OS film, the normal direction of the surface where the CAAC-OS film is formed, or the normal direction of the surface of the CAAC-OS film. The crystal region refers to a region having a periodic atomic arrangement. When an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the direction of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. The CAC-OS refers to one composition of a material in which elements constituting a metal oxide are unevenly distributed with a size greater than or equal to 0.5 nm and less than or equal to 10 nm, preferably greater than or equal to 1 nm and less than or equal to 3 nm, or a similar size, for example. Note that a state in which one or more metal elements are unevenly distributed and regions including the metal element(s) are mixed with a size greater than or equal to 0.5 nm and less than or equal to 10 nm, preferably greater than or equal to 1 nm and less than or equal to 3 nm, or a similar size in a metal oxide is hereinafter referred to as a mosaic pattern or a patch-like pattern.

In addition, the CAC-OS has a composition in which materials are separated into a first region and a second region to form a mosaic pattern, and the first regions are distributed in the film (this composition is hereinafter also referred to as a cloud-like composition). That is, the CAC-OS is a composite metal oxide having a composition in which the first regions and the second regions are mixed.

Here, the atomic ratios of In, Ga, and Zn to the metal elements contained in the CAC-OS in an In—Ga—Zn oxide are denoted by [In], [Ga], and [Zn], respectively. For example, the first region in the CAC-OS in the In—Ga—Zn oxide has [In] higher than that in the composition of the CAC-OS film. Moreover, the second region has [Ga] higher than that in the composition of the CAC-OS film. For example, the first region has higher [In] and lower [Ga] than the second region. Moreover, the second region has higher [Ga] and lower [In] than the first region.

Specifically, the first region contains indium oxide, indium zinc oxide, or the like as its main component. The second region contains gallium oxide, gallium zinc oxide, or the like as its main component. That is, the first region can be referred to as a region containing In as its main component. The second region can be referred to as a region containing Ga as its main component.

Note that a clear boundary between the first region and the second region cannot be observed in some cases.

For example, energy dispersive X-ray spectroscopy (EDX) is used to obtain EDX mapping, and according to the EDX mapping, the CAC-OS in the In—Ga—Zn oxide has a structure in which the region containing In as its main component (the first region) and the region containing Ga as its main component (the second region) are unevenly distributed and mixed.

In the case where the CAC-OS is used for a transistor, a switching function (on/off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Accordingly, when the CAC-OS is used for a transistor, high on-state current (Ion), high field-effect mobility (p), and excellent switching operation can be achieved.

An oxide semiconductor has various structures with different properties. Two or more kinds among the amorphous oxide semiconductor, the polycrystalline oxide semiconductor, the a-like OS, the CAC-OS, the nc-OS (nanocrystalline Oxide Semiconductor), and the CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C. inclusive, which is wider than that of a single crystal Si transistor, and thus shows a smaller change in characteristics than the single crystal Si transistor when the secondary battery is heated. The off-state current of the transistor using an oxide semiconductor is lower than or equal to the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety. When the control circuit portion 1320 is used in combination with a secondary battery including a positive electrode using the positive electrode active material 100 obtained in the above embodiment, the synergy on safety can be obtained.

The control circuit portion 1320 that includes a memory circuit including a transistor using an oxide semiconductor can also function as an automatic control device for the secondary battery to resolve causes of instability, such as a micro-short circuit. Examples of functions of resolving the causes of instability of a secondary battery include prevention of overcharging, prevention of overcurrent, control of overheating during charging, maintaining the cell balance of an assembled battery, prevention of overdischarging, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A micro-short circuit refers to a minute short circuit caused in a secondary battery and refers not to a state where the positive electrode and the negative electrode of a secondary battery are short-circuited so that charging and discharging are impossible, but to a phenomenon in which a slight short-circuit current flows through a minute short-circuit portion. Since a large voltage change is caused even when a micro-short circuit occurs in a relatively short time in a minute area, the abnormal voltage value might adversely affect estimation of the charged/discharged state of the secondary battery to be performed subsequently.

One of the causes of a micro-short circuit is as follows: a plurality of charging and discharging cause an uneven distribution of positive electrode active materials, which leads to local concentration of current in part of the positive electrode and part of the negative electrode, whereby part of a separator stops functioning or a by-product is generated by a side reaction, which is thought to generate a micro short-circuit.

It can be said that the control circuit portion 1320 not only detects a micro-short circuit but also senses terminal voltage of the secondary battery and controls the charge and discharge state of the secondary battery. For example, to prevent overcharging, an output transistor of a charge circuit and an interruption switch can be turned off substantially at the same time.

FIG. 27B illustrates an example of a block diagram of the battery pack 1415 illustrated in FIG. 27A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside, the upper limit of output current to the outside, and the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to a switch including a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOx (gallium oxide, where x is a real number greater than 0), or the like. A memory element using an OS transistor can be freely placed by being stacked over a circuit using a Si transistor, for example; hence, integration can be easy. Furthermore, an OS transistor can be fabricated with a manufacturing apparatus similar to that for a Si transistor and thus can be fabricated at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle devices for 42 V (for a high-voltage system), and the second battery 1311 supplies electric power to in-vehicle devices for 14 V (for a low-voltage system).

In this embodiment, an example in which a lithium-ion secondary battery is used as both the first battery 1301a and the second battery 1311 is described. As the second battery 1311, a lead storage battery, an all-solid-state battery, or an electric double layer capacitor may be used. For example, the all-solid-state battery in Embodiment 4 may be used. The use of the all-solid-state battery in Embodiment 4 as the second battery 1311 can achieve high capacity and reduction in size and weight.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge characteristics of a secondary battery to be used, so that fast charging can be performed.

Although not illustrated, in the case of connecting an electric vehicle to an external charger, an outlet of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, the outlet of the charger or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, and a three-phase 200 V outlet with 50 kW, for example. Furthermore, charging can be performed with electric power supplied from external charge equipment by a contactless power feeding method or the like.

For fast charging, secondary batteries that can withstand high-voltage charging have been desired to perform charging in a short time.

The above-described secondary battery in this embodiment uses the positive electrode active material 100 obtained in the above embodiment. Moreover, even when graphene is used as a conductive additive and the electrode layer is formed thick to increase the loading amount, it is possible to achieve a secondary battery with significantly improved electrical characteristics while synergy such as a reduction in capacity and the retention of high capacity can be obtained. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

Specifically, as the above-described secondary battery in this embodiment, the use of the positive electrode active material 100 described in the above embodiment can increase the operating voltage of the secondary battery, and the increase in charge voltage can increase the available capacity. Moreover, using the positive electrode active material 100 described in the above embodiment in the positive electrode can provide an automotive secondary battery having excellent cycle performance.

Next, examples in which the secondary battery of one embodiment of the present invention is mounted on a vehicle, typically a transport vehicle, will be described.

Mounting the secondary battery illustrated in any one of FIG. 17D, FIG. 19C, and FIG. 27A on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

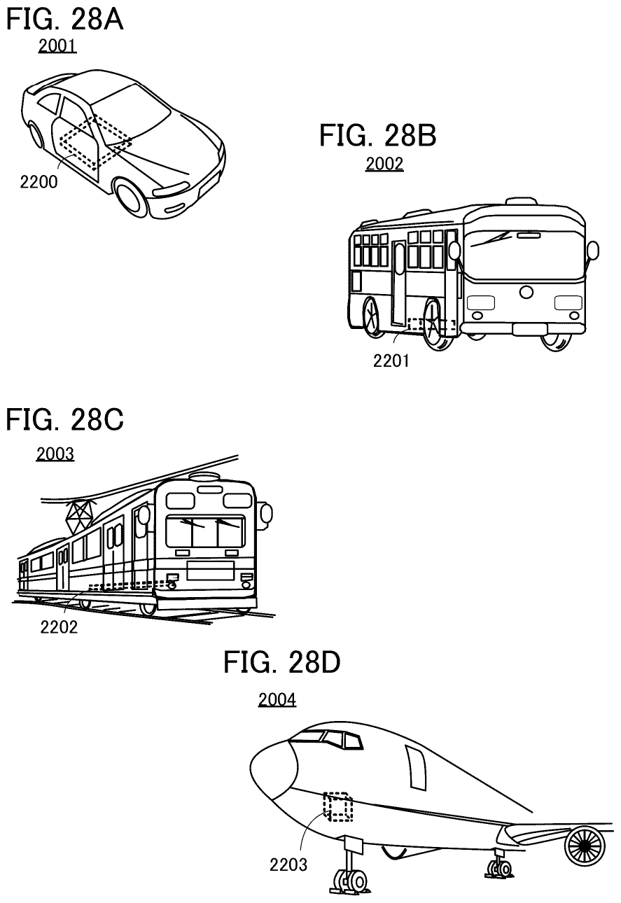

FIG. 28A to FIG. 28D illustrate examples of transport vehicles as examples of vehicles using one embodiment of the present invention. A motor vehicle 2001 illustrated in FIG. 28A is an electric vehicle that runs using an electric motor as a driving power source. Alternatively, the motor vehicle 2001 is a hybrid vehicle that can appropriately select an electric motor or an engine as a driving power source. In the case where the secondary battery is mounted on the vehicle, an example of the secondary battery described in Embodiment 3 is provided at one position or several positions. The motor vehicle 2001 illustrated in FIG. 28A includes a battery pack 2200, and the battery pack includes a secondary battery module in which a plurality of secondary batteries are connected to each other. Moreover, the battery pack preferably includes a charge control device that is electrically connected to the secondary battery module.

The motor vehicle 2001 can be charged when the secondary battery included in the motor vehicle 2001 is supplied with electric power from external charge equipment by a plug-in system, a contactless charge system, or the like. In charging, a given method such as CHAdeMO (registered trademark) or Combined Charging System may be employed as a charging method, the standard of a connector, and the like as appropriate. A charging device may be a charging station provided in a commerce facility or a power source in a house. For example, with use of the plug-in system, the power storage device mounted on the motor vehicle 2001 can be charged by being supplied with electric power from the outside. Charging can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and moves. To supply electric power in such a contactless manner, an electromagnetic induction method or a magnetic resonance method can be used.

FIG. 28B illustrates a large transporter 2002 having a motor controlled by electricity as an example of a transport vehicle. The secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has the same function as that in FIG. 28A except, for example, the number of secondary batteries configuring the secondary battery module; thus, the description is omitted.

FIG. 28C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V, for example. When a secondary battery including the positive electrode active material 100 described in the above embodiment for a positive electrode is used, a secondary battery having favorable rate performance and charge and discharge cycle performance can be manufactured, which can contribute to higher performance and a longer lifetime of the transport vehicle 2003. A battery pack 2202 has the same function as that in FIG. 28A except, for example, the number of secondary batteries configuring the secondary battery module; thus, the description is omitted.

FIG. 28D illustrates an aircraft 2004 having a combustion engine as an example. The aircraft 2004 illustrated in FIG. 28D can be regarded as a kind of transport vehicles since it is provided with wheels for takeoff and landing, and has a battery pack 2203 including a secondary battery module and a charge control device; the secondary battery module includes a plurality of connected secondary batteries.

The secondary battery module of the aircraft 2004 has eight 4 V secondary batteries connected in series, which has the maximum voltage of 32 V, for example. The battery pack 2203 has the same function as that in FIG. 28A except, for example, the number of secondary batteries configuring the secondary battery module; thus, the description is omitted.

The contents in this embodiment can be combined with the contents in the other embodiments as appropriate.

### Embodiment 6

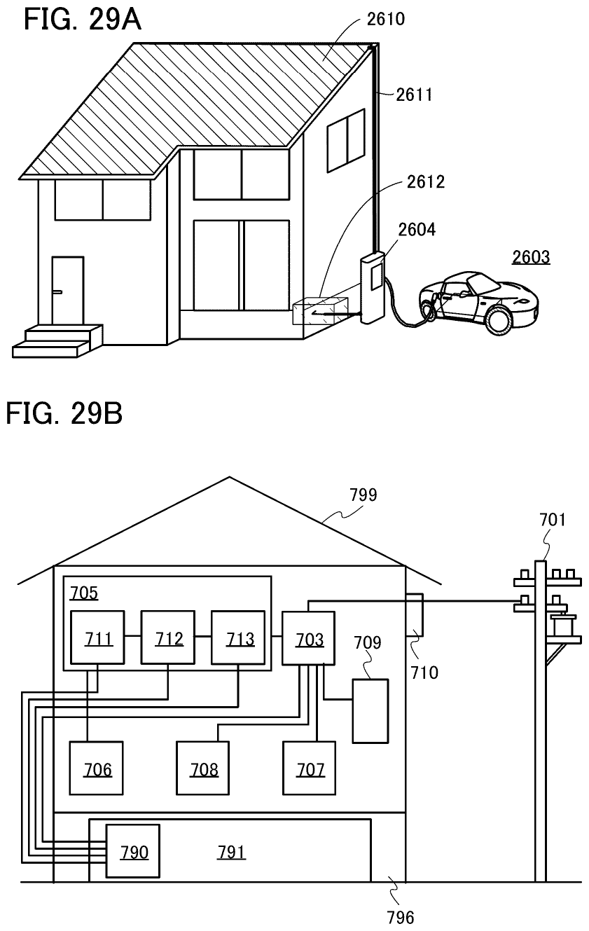

In this embodiment, examples in which the secondary battery of one embodiment of the present invention is mounted on a building will be described with reference to FIG. 29A and FIG. 29B.

A house illustrated in FIG. 29A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to ground-based charge equipment 2604. The power storage device 2612 can be charged with electric power generated by the solar panel 2610. A secondary battery included in a vehicle 2603 can be charged with the electric power stored in the power storage device 2612 through the charge equipment 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with use of the power storage device 2612 of one embodiment of the present invention as an uninterruptible power source, electronic devices can be used even when electric power cannot be supplied from a commercial power source due to power failure or the like.

FIG. 29B illustrates an example of a power storage device of one embodiment of the present invention. As illustrated in FIG. 29B, a power storage device 791 of one embodiment of the present invention is provided in an underfloor space 796 of a building 799. The power storage device 791 may be provided with the control circuit described in Embodiment 5, and the use of a secondary battery including a positive electrode using the positive electrode active material 100 obtained in the above embodiment for the power storage device 791 enables the power storage device 791 to have a long lifetime.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device such as a TV or a personal computer through the router 709. Furthermore, it can be checked with a portable electronic terminal such as a smartphone or a tablet through the router 709. With the indicator 706, the electric device, or the portable electronic terminal, for example, the demand for electric power depending on a time period (or per hour) that is predicted by the predicting portion 712 can be checked.

The contents in this embodiment can be combined with the contents in the other embodiments as appropriate.

### Embodiment 7

In this embodiment, examples in which a motorcycle and a bicycle are each provided with the power storage device of one embodiment of the present invention will be described.

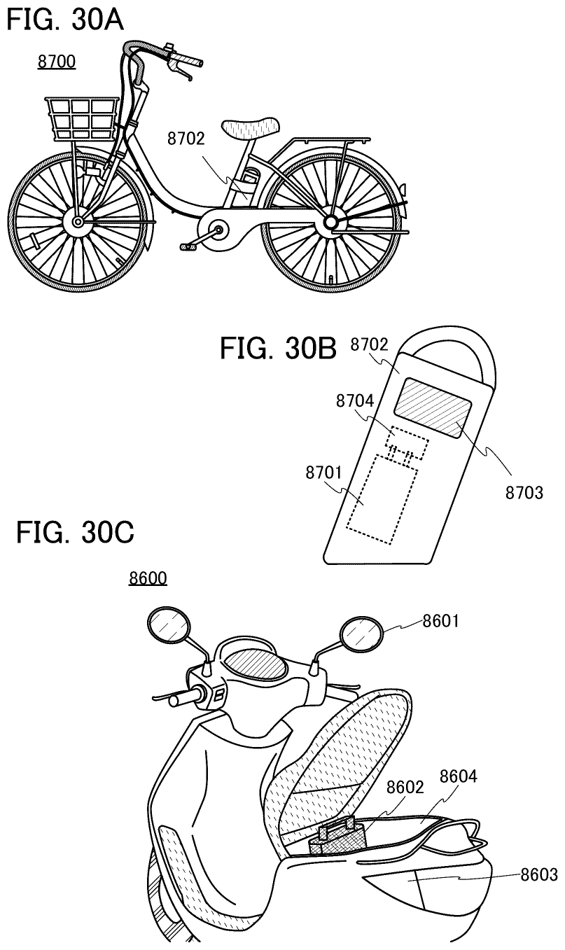

FIG. 30A illustrates an example of an electric bicycle using the power storage device of one embodiment of the present invention. The power storage device of one embodiment of the present invention can be used for an electric bicycle 8700 illustrated in FIG. 30A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 30B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 5. The control circuit 8704 is electrically connected to a positive electrode and a negative electrode of the storage battery 8701. The control circuit 8704 may be provided with the small solid-state secondary battery illustrated in FIG. 26A and FIG. 26B. When the small solid-state secondary battery illustrated in FIG. 26A and FIG. 26B is provided in the control circuit 8704, electric power can be supplied to store data in a memory circuit included in the control circuit 8704 for a long time. When the control circuit 8704 is used in combination with a secondary battery including a positive electrode using the positive electrode active material 100 obtained in the above embodiment, the synergy on safety can be obtained. The secondary battery including the positive electrode active material 100 obtained in the above embodiment in the positive electrode and the control circuit 8704 can greatly contribute to elimination of accidents due to secondary batteries, such as fires.

FIG. 30C illustrates an example of a motorcycle using the power storage device of one embodiment of the present invention. A motor scooter 8600 illustrated in FIG. 30C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material 100 obtained in the above embodiment can have high capacity and contribute to a reduction in size.

In the motor scooter 8600 illustrated in FIG. 30C, the power storage device 8602 can be stored in a storage unit under seat 8604. The power storage device 8602 can be stored in the under-seat storage unit under seat 8604 even with a small size.

The contents in this embodiment can be combined with the contents in the other embodiments as appropriate.

### Embodiment 8

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

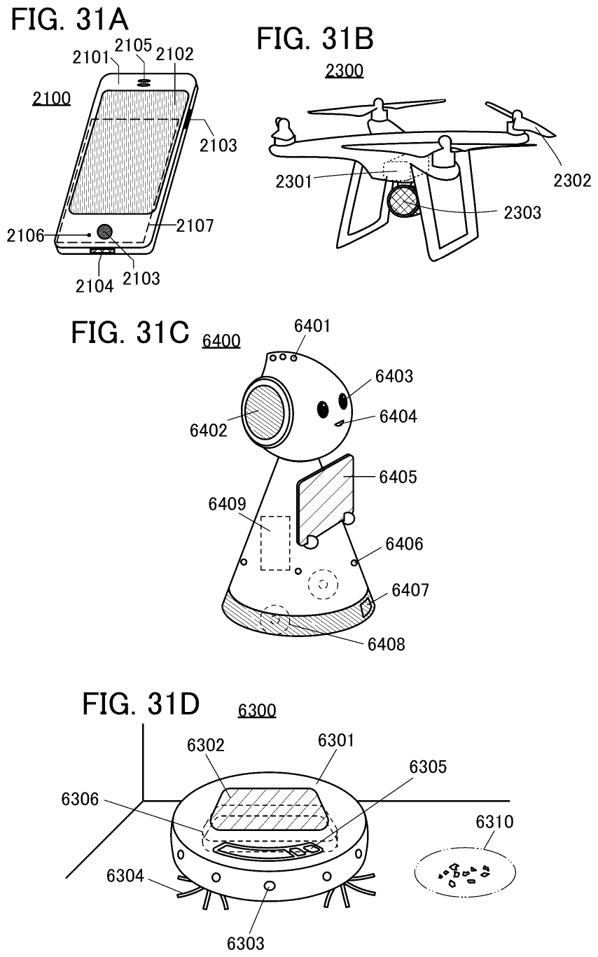

FIG. 31A shows an example of a mobile phone. A mobile phone 2100 includes a housing 2101 in which a display portion 2102 is incorporated, operation buttons 2103, an external connection port 2104, a speaker 2105, a microphone 2106, and the like. The mobile phone 2100 includes a secondary battery 2107. The use of the secondary battery 2107 including a positive electrode using the positive electrode active material 100 described in the above embodiment achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication with a headset capable of wireless communication enables hands-free calling.

Moreover, the mobile phone 2100 includes the external connection port 2104, and data can be directly transmitted to and received from another information terminal via a connector. In addition, charging can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 31B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 100 obtained in the above embodiment has high energy density and a high level of safety, and thus can be used safely for a long time over a long period of time and is preferable as the secondary battery included in the unmanned aircraft 2300.

FIG. 31C illustrates an example of a robot. A robot 6400 illustrated in FIG. 31C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 100 obtained in the above embodiment has high energy density and a high level of safety, and thus can be used safely for a long time over a long period of time and is preferable as the secondary battery 6409 included in the robot 6400.

FIG. 31D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material 100 obtained in the above embodiment has high energy density and a high level of safety, and thus can be used safely for a long time over a long period of time and is preferable as the secondary battery 6306 included in the cleaning robot 6300.

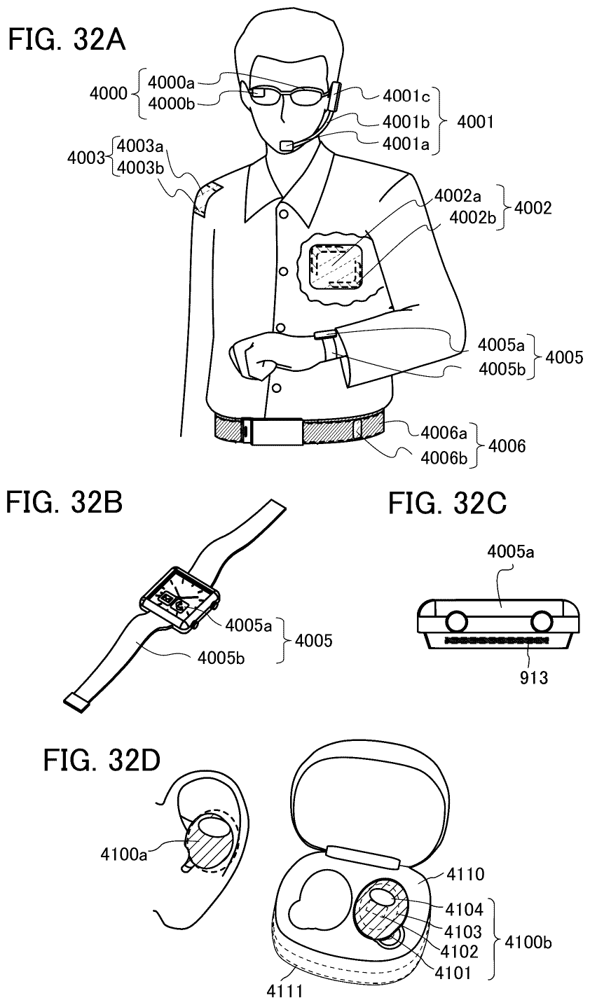

FIG. 32A shows examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 32A. The glasses-type device 4000 includes a frame 4000a and a display portion 4000b. The secondary battery is provided in a temple portion of the frame 4000a having a curved shape, whereby the glasses-type device 4000 can be lightweight, can have a well-balanced weight, and can be used continuously for a long time. A secondary battery including a positive electrode using the positive electrode active material 100 obtained in the above embodiment has high energy density and achieves a structure that accommodates space saving due to a reduction in size of the housing.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c. A secondary battery including a positive electrode using the positive electrode active material 100 obtained in the above embodiment has high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode using the positive electrode active material 100 obtained in the above embodiment has high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode using the positive electrode active material 100 obtained in the above embodiment has high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode using the positive electrode active material 100 obtained in the above embodiment has high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material 100 obtained in the above embodiment has high energy density and achieves a structure that accommodates space saving due to a reduction in size of the housing.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 32B illustrates a perspective view of the watch-type device 4005 that is detached from an arm.

FIG. 32C is a side view. FIG. 32C illustrates a state where the secondary battery 913 is incorporated in the inner region. The secondary battery 913 is the secondary battery described in Embodiment 3. The secondary battery 913 is provided to overlap with the display portion 4005a, can have high density and high capacity, and is small and lightweight.

Since the secondary battery in the watch-type device 4005 is required to be small and lightweight, the use of the positive electrode active material 100 obtained in the above embodiment in the positive electrode of the secondary battery 913 enables the secondary battery 913 to have high energy density and a small size.

FIG. 32D illustrates an example of wireless earphones. The wireless earphones illustrated here as an example consist of, but not limited to, a pair of main bodies 4100a and 4100b.

The main bodies 4100a and 4100b each include a driver unit 4101, an antenna 4102, and a secondary battery 4103. A display portion 4104 may also be included. Moreover, a substrate where a circuit such as a wireless IC is provided, a terminal for charging, and the like are preferably included. Furthermore, a microphone may be included.

A case 4110 includes a secondary battery 4111. Moreover, a substrate where a circuit such as a wireless IC or a charge control IC is provided, and a terminal for charging are preferably included. Furthermore, a display portion, a button, and the like may be included.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. A secondary battery including a positive electrode using the positive electrode active material 100 obtained in the above embodiment has a high energy density; thus, with use of the secondary battery as the secondary battery 4103 and the secondary battery 4111, a structure that accommodates space saving due to a reduction in size of the wireless earphones can be achieved.

This embodiment can be implemented in appropriate combination with the other embodiments.

### Example 1

In this example, the positive electrode active material 100 of one embodiment of the present invention was formed and features thereof were analyzed.

Will be described Sample A to Sample C fabricated in this example with reference to the formation method shown in FIG. 1 and FIG. 2A to FIG. 2C.

### <Sample A>

As LiMO₂ in Step S14 in FIG. 1, with use of cobalt as the transition metal M, commercially available lithium cobalt oxide (Cellseed C-10N produced by NIPPON CHEMICAL INDUSTRIAL CO., LTD.) not containing any additive element was prepared. The initial heating in Step S15 was performed on the lithium cobalt oxide, which was put in a sagger covered with a lid, in a muffle furnace at 850° C. for two hours. After the muffle furnace was filled with an oxygen atmosphere, no flowing was performed (O₂ purging). The collected amount after the initial heating showed a slight decrease in weight. The decrease in weight was probably caused by elimination of impurities from LCO.

In accordance with Steps S22, S23, and S24 shown in FIG. 2A, the additive element X source was prepared. BaF₂ and LiF were used as the additive element X source and weighed, so that BaF₂:LiF=3:1 (molar ratio) as shown in the mixing ratio of Sample A in Table 4. Then, BaF₂ and LiF were mixed into dehydrated acetone and the mixture was stirred at a rotating speed of 400 rpm for 12 hours, whereby an additive element source X_{A} was produced. Then, the mixture was made to pass through a sieve with an aperture of 300 μm, whereby the additive element source X having a uniform particle diameter was obtained.

In accordance with Steps S25, S26, and S27 shown in FIG. 2B, the additive element Y source was prepared. LiF and MgF₂ were used, respectively, for the Li source and the Mg source as the additive element Y source and weighed, so that MgF₂:LiF=3:1 (molar ratio) as shown in the mixing ratio of Sample A in Table 4. Then, LiF and MgF₂ were mixed into dehydrated acetone and the mixture was stirred at a rotating speed of 400 rpm for 12 hours, whereby an additive element source Y was produced. Then, the mixture was made to pass through a sieve with an aperture of 300 μm, whereby the additive element source Y having a uniform particle diameter was obtained.

Next, in accordance with Step S31 shown in FIG. 1, BaF₂ included in the additive element X source and MgF₂ included in the additive element Y source were weighed together to account for 1 at % of cobalt in LCO, and then mixed with LCO after initial heating by a dry method, in accordance with the mixing ratio of Sample A shown in Table 4. In Sample A, the molar ratio of BaF₂ to MgF₂ is 1:1. Stirring was performed at a rotating speed of 150 rpm for one hour. These conditions were milder than those of the stirring in the production of the additive element source X source or the additive element Y source. Finally, the mixture was made to pass through a sieve with an aperture of 300 μm, whereby a first mixture A having a uniform particle diameter was obtained.

TABLE 4

| | Additive element X source | | Additive element Y source | |
|---|---|---|---|---|
| | BaF₂ | LiF | MgF₂ | LiF |
| Sample A | 0.50 mol % | 0.17 mol % | 0.50 mol % | 0.17 mol % |
| Sample B | 0.20 mol % | 0.07 mol % | 0.80 mol % | 0.27 mol % |
| Sample C | 0.00 mol % | 0.00 mol % | 1.00 mol % | 0.33 mol % |

Then, the first mixture A was heated. The heating conditions were 900° C. and 20 hours. During the heating, a lid was put on the sagger containing the first mixture A. The sagger was filled with an atmosphere containing oxygen and entry and exit of the oxygen were blocked (purged). By the heating, LCO (a composite oxide A) containing Ba and Mg was obtained.

Next, the additive element Z source was added to the composite oxide A. In accordance with Step S41 in FIG. 2C, Ni(OH)₂ and Al(OH)₃ were prepared as the Ni source and the Al source. Each of the Ni(OH)₂ and the Al(OH)₃ were weighed to account for 0.5 at % of the transition metal M and then mixed with the composite oxide A by a dry method. Stirring was performed at a rotating speed of 150 rpm for one hour. These conditions were milder than those of the stirring in the production of the additive element X source or the additive element Y source. Finally, the mixture was made to pass through a sieve with an aperture of 300 μm, whereby a second mixture A having a uniform particle diameter was obtained.

Then, the second mixture A was heated. The heating was performed at 850° C. for 10 hours. During the heating, a lid was put on the sagger containing the second mixture A. The sagger was filled with an atmosphere containing oxygen and entry and exit of the oxygen were blocked (purged). By the heating, LCO containing Ba, Mg, F, Ni, and Al was obtained. The positive electrode active material obtained in this manner was Sample A.

### <Sample B>

Except for employing the mixing ratio of Sample B shown in Table 4 for the additive element X source and the additive element Y source when the additive element sources were mixed with LCO after the initial heating, Sample B was fabricated in a manner similar to that of Sample A.

### <Sample C>

Except for employing the mixing ratio of Sample D shown in Table 4 for the additive element X source and the additive element Y source when the additive element sources were mixed with LCO after the initial heating, Sample C was fabricated in a manner similar to that of Sample A.

### <SEM>

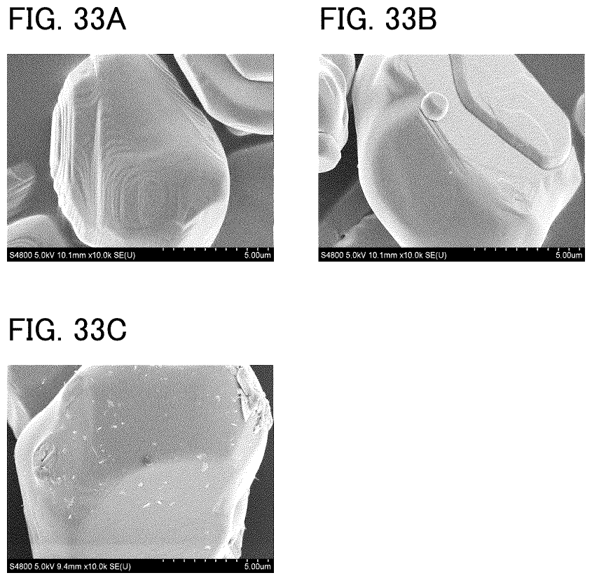

FIG. 33A to FIG. 33C show SEM (Scanning Electron Microscope) observation results of Sample A to Sample C. In the SEM observation in this example, an S4800 scanning electron microscope produced by Hitachi High-Tech Corporation was used under the measurement conditions where the acceleration voltage was 5 kV and the magnification was 10000 times.

According to the SEM observation results, the surfaces of Sample A and Sample B fabricated using the additive element X source containing Ba are extremely smooth. Owing to the extremely smooth surfaces, particles are likely to slip in pressing a positive electrode active material in a later process for forming a positive electrode with use of Sample A and Sample B. Thus, it can be expected that the surface smoothness of particles prevent a crack or a slip from being generated in the positive electrode active material particles.

### <STEM and EDX (Energy Dispersive X-Ray Spectroscopy)>

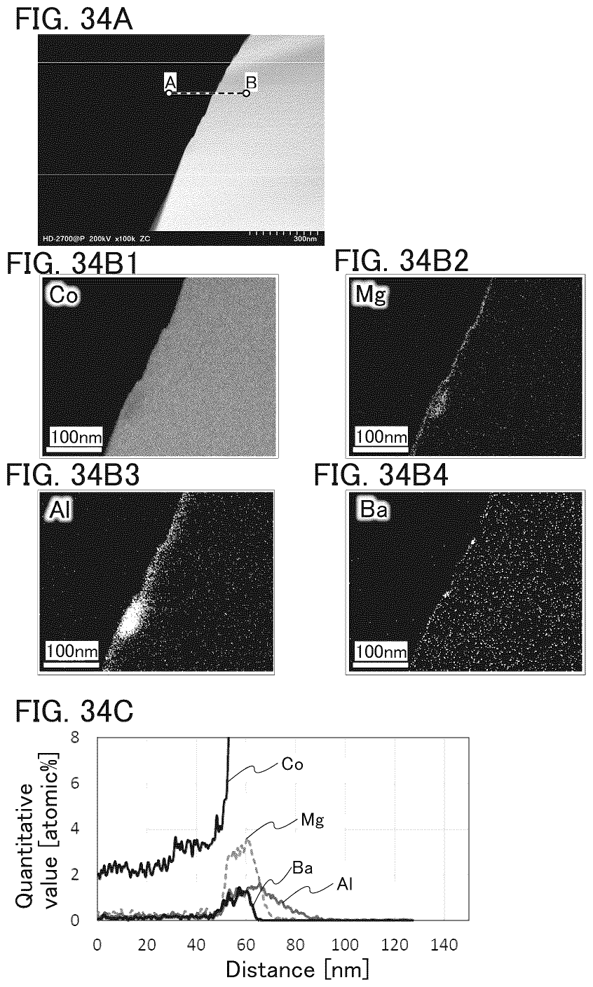

Next, the surface portion of Sample A was subjected to STEM observation and linear analysis and area analysis with STEM-EDX. HD-2700 produced by Hitachi High-Technologies Corporation was used as an STEM apparatus and an STEM-EDX apparatus, at an accelerating voltage of 200 kV and a magnification of 100000 times. FIG. 34A shows across-sectional STEM image (ZC image) of Sample A (LCO containing Ba, Mg, and Al as the additive elements).

FIG. 34B1 to FIG. 34B4 show element mapping results obtained by the STEM-EDX area analysis in the observed region shown in FIG. 34A. FIG. 34B1 exhibits Co, FIG. 34B2 exhibits Mg, FIG. 34B3 exhibits Al, and FIG. 34B4 exhibits Ba, which indicates that large amounts of Ba, Mg, and Al exist in the surface portion of LCO that is Sample A. In each of FIG. 34B1 to FIG. 34B4, the brightness of the element mapping image is normalized in accordance with the detected amount of characteristic X-ray of the element.

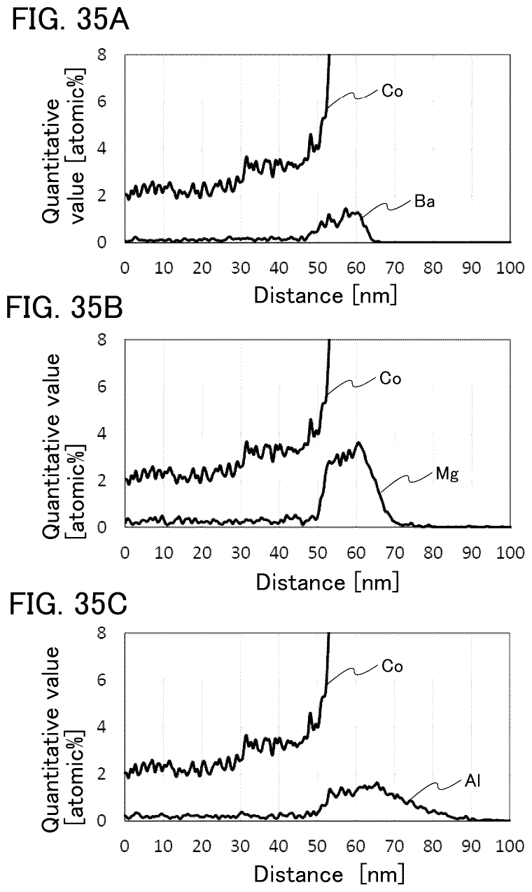

FIG. 34C shows results of the STEM-EDX linear analysis between A-B shown in FIG. 34A, which shows distribution of Co, Ba, Mg, and Al. The results indicate that large amounts of Ba, Mg, and Al exist in the surface portion of LCO that is Sample A, as in the results shown in FIG. 34B1 to FIG. 34B4. FIG. 35 are graphs each showing the distribution of Co and any one of Ba, Mg, and Al extracting from the STEM-EDX linear analysis results shown in FIG. 34C. FIG. 35A shows the distribution of Co and Ba, FIG. 35B shows the distribution of Co and Mg, and FIG. 35C shows the distribution of Co and Al. Here, the details of the distribution of Ba, Mg, and Al in the particle are mentioned. Each of Ba and Mg exhibits the point of the maximum characteristic X-ray detected value closer to the surface than the point of the maximum characteristic X-ray detected value of Al. In other words, the concentration peaks of Ba and Mg are positioned closer to the surface than the concentration peak of Al is. The distribution regions of Ba, Mg, and Al overlap with each other. Note that the concentration peaks of Ba and Mg exist within a range of 10 nm from the surface of LCO, and the concentration peak of Al exists within a range of 20 nm from the surface of LCO. Accordingly, it can be said that in the surface portion of the positive electrode active material, Ba and Mg preferably exist closer to the surface of the positive electrode material than Al does. In other words, it can be said that in the surface portion of the positive electrode active material, Al preferably exists more inward than Ba and Mg. Furthermore, it can be said that in the surface portion of the positive electrode active material, the distribution regions of Ba, Mg, and Al overlap with each other. Furthermore, it can be said that in the surface portion of the positive electrode active material, a portion where distribution regions of Ba, Mg, and Al overlap with each other, a portion where distribution regions of Mg and Al overlap with each other, and a region containing Al preferably exist in this order in the direction from the surface toward the inside.

### Example 2

### <Half Cell Charge and Discharge Cycle Performance>

In this example, half cells were fabricated using the positive electrode active material of one embodiment of the present invention and their cycle performance was evaluated, so that the performance of the positive electrode alone is clarified by the evaluation of the cycle performance of the half cells.

First, half cells were assembled with use of Sample A to Sample C shown in Example 1 as positive electrode active materials. The conditions of the half cells are described below.

The positive electrode active materials were prepared, acetylene black (AB) was prepared as a conductive material, and polyvinylidene fluoride (PVDF) was prepared as a binding agent. Slurry was formed by mixing the positive electrode active material, AB, and PVDF at a weight ratio of 95:3:2, and the slurry was applied to an aluminum current collector. As a solvent of the slurry, NMP was used.

After the slurry was applied onto the current collector, a solvent was volatilized. Through the above process, the positive electrode was obtained. The loading amount of the active material was approximately 7 mg/cm².

As an electrolyte solution, a solution which is obtained by adding vinylene carbonate (VC) at 2 wt % as an additive to a mixture of ethylene carbonate (EC) and diethyl carbonate (DEC) at EC:DEC=3:7 (volume ratio) was used. As an electrolyte contained in the electrolyte solution, 1 mol/L lithium hexafluorophosphate (LiPF₆) was used. As a separator, polypropylene was used.

A lithium metal was prepared as a counter electrode to fabricate coin-type half cells including the above positive electrodes and the like, and cycle performance was measured.

A discharge rate and a charge rate as cycle conditions are described. A discharge rate refers to the relative ratio of current at the time of discharging to battery capacity and is expressed in a unit C. A current corresponding to 1 C in a battery with a rated capacity X (Ah) is X (A). The case where discharging is performed with a current of 2X (A) is rephrased as to perform discharging at 2 C, and the case where discharging is performed with a current of X/5 (A) is rephrased as to perform discharging at 0.2 C. The same applies to a charge rate; the case where charging is performed with a current of 2X(A) is rephrased as to perform charging at 2 C, and the case where charging is performed with a current of X/5 (A) is rephrased as to perform charging at 0.2 C.

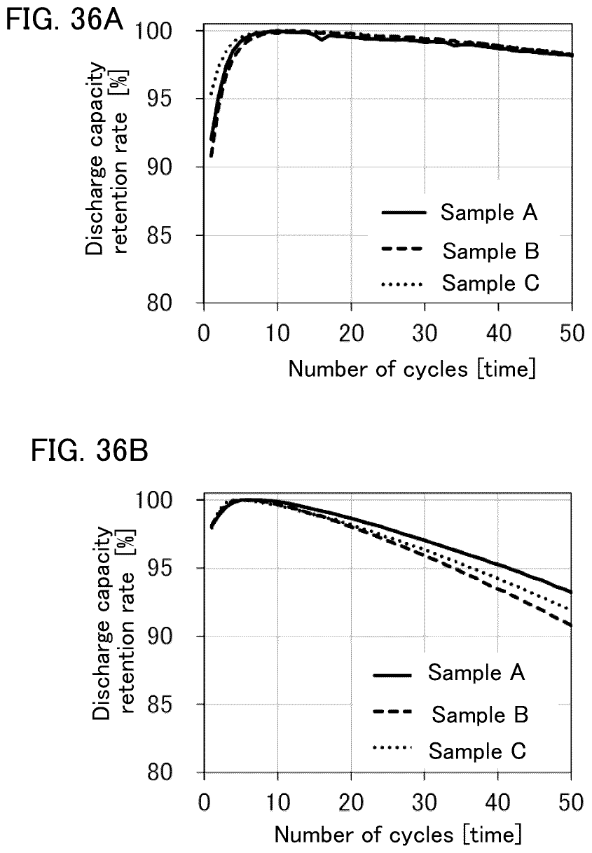

FIG. 36A to 38B show the cycle performance. The charge conditions were as follows: constant current charging was performed at 0.5 C until the voltage reached 4.60 V, 4.65 V or 4.7 V, and then constant voltage charging was performed until the current value reached 0.05 C. As discharging, constant current discharging was performed at 0.5 C until the voltage reached 2.5 V. Note that here, 1 C was set to 200 mA/g. Two conditions were set to the temperature: 25° C. and 45° C. In the above manner, charging and discharging were repeated 50 times.

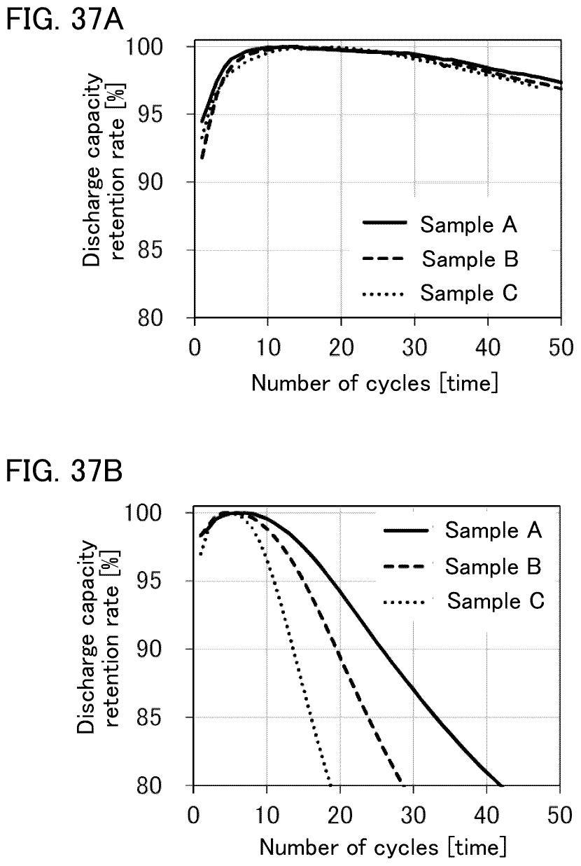

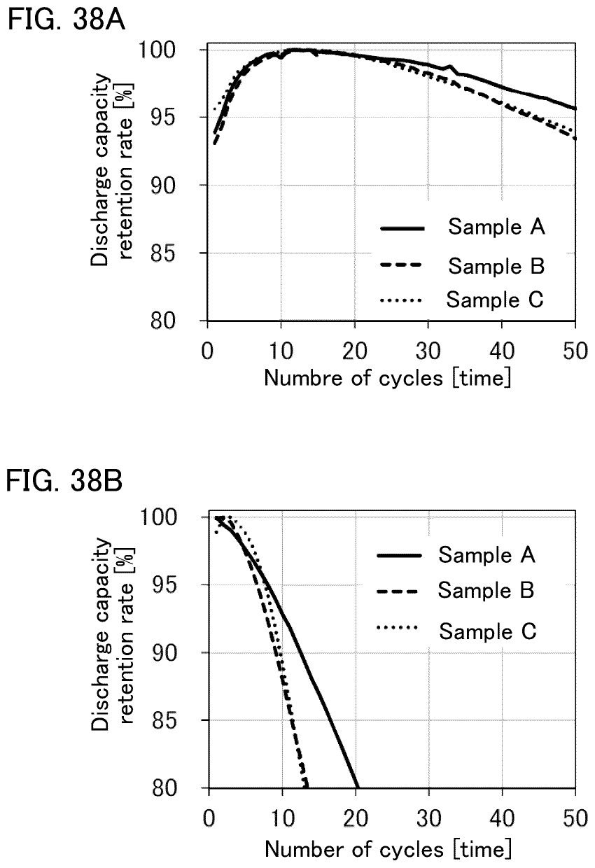

FIG. 36A to FIG. 38B show results of charge and discharge cycle tests. The results shown in FIG. 36A were obtained at a charge voltage of 4.60 V and a measurement temperature of 25° C.; the results shown in FIG. 36B were obtained at a charge voltage of 4.60 V and a measurement temperature of 45° C.; the results shown in FIG. 37A were obtained at a charge voltage of 4.65 V and a measurement temperature of 25° C.; the results shown in FIG. 37B were obtained at a charge voltage of 4.65 V and a measurement temperature of 45° C.; the results shown in FIG. 38A were obtained at a charge voltage of 4.70 V and a measurement temperature of 25° C.; and the results shown in FIG. 38B were obtained at a charge voltage of 4.70 V and a measurement temperature of 45° C. Each of the results is a graph showing a change in discharge capacity with respect to the number of cycles. The horizontal axis of the graph represents the number of cycles, and the vertical axis of the graph represents the discharge capacity retention rate (%: the maximum discharge capacity in 50 cycles assumed to be 100%). As evaluation results of the coin cells using Sample A to Sample C, Table 5 shows the maximum discharge capacity values, Table 6 shows the discharge capacity values after 50 cycles, and Table 7 shows the discharge capacity retention rates after 50 cycles.

TABLE 5

| | 25° C. | | | 45° C. | | |
|---|---|---|---|---|---|---|
| | 4.60 V | 4.65 V | 4.70 V | 4.60 V | 4.65 V | 4.70 V |
| Sample A | 204 | 208.7 | 208.2 | 216.1 | 220.2 | 217.7 |
| Sample B | 205.7 | 212.1 | 213.5 | 216.8 | 223 | 221.9 |
| Sample C | 215 | 220.4 | 223 | 224.4 | 229.1 | 229.9 |

(mAh/g)

TABLE 6

| | 25° C. | | | 45° C. | | |
|---|---|---|---|---|---|---|
| | 4.60 V | 4.65 V | 4.70 V | 4.60 V | 4.65 V | 4.70 V |
| Sample A | 200.3 | 203.2 | 199.1 | 201.5 | 167.1 | 114.7 |
| Sample B | 202.1 | 205.5 | 199.5 | 196.8 | 142.3 | 108.2 |
| Sample C | 211.3 | 212.8 | 209.4 | 206.3 | 118.8 | 98.8 |

(mAh/g)

TABLE 7

| | 25° C. | | | 45° C. | | |
|---|---|---|---|---|---|---|
| | 4.60 V | 4.65 V | 4.70 V | 4.60 V | 4.65 V | 4.70 V |
| Sample A | 98.19 | 97.38 | 95.64 | 93.23 | 75.89 | 52.67 |
| Sample B | 98.24 | 96.88 | 93.43 | 90.8 | 63.84 | 48.77 |
| Sample C | 98.27 | 96.54 | 93.92 | 91.91 | 51.87 | 42.97 |

(%)

According to the discharge capacity retention rates after 50 cycles shown in Table 7, Sample A and Sample B exhibit favorable characteristics in terms of resistance to deterioration under a severe environment at a high temperature of 45° C. and high charge voltage. In particular, Sample A was confirmed to demonstrate better characteristics.

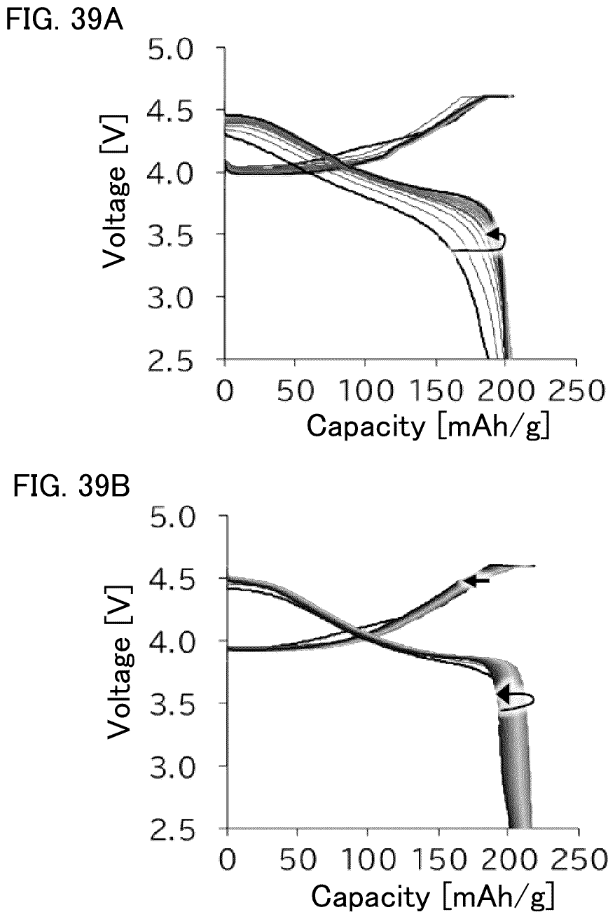

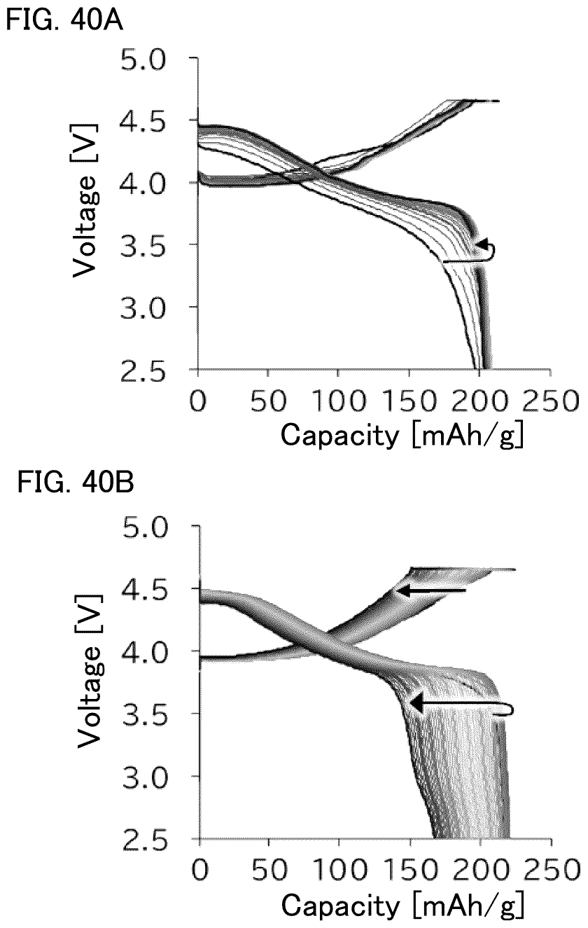

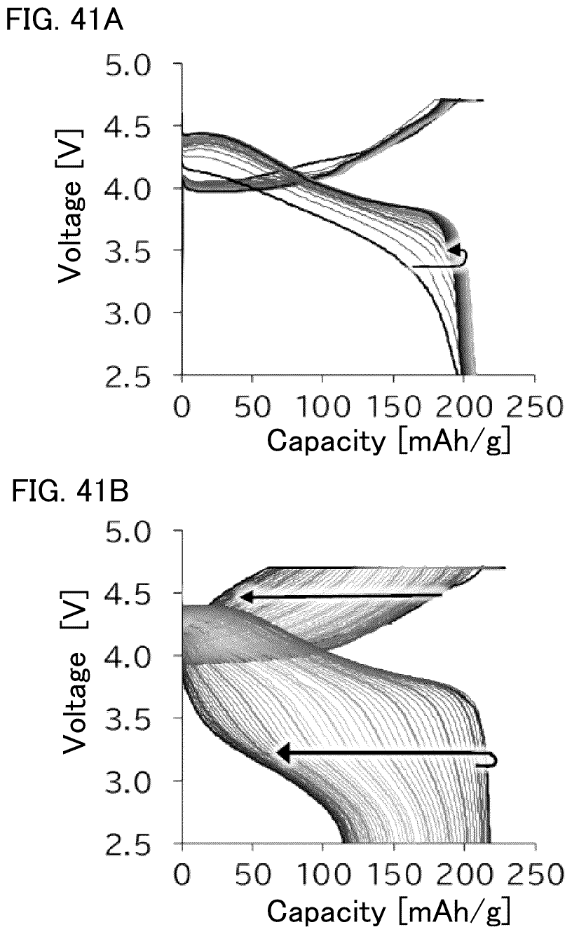

FIG. 39A to FIG. 41B are graphs relating to the cycle performance shown in FIG. 36A to FIG. 38B. In each of FIG. 39A to FIG. 41B, charge curves and discharge curves obtained from the first cycle to the 50th cycle of Sample A are superimposed. The results shown in FIG. 39A were obtained at a charge voltage of 4.60 V and a measurement temperature of 25° C.; the results shown in FIG. 39B were obtained at a charge voltage of 4.60 V and a measurement temperature of 45° C.; the results shown in FIG. 40A were obtained at a charge voltage of 4.65 V and a measurement temperature of 25° C.; the results shown in FIG. 40B were obtained at a charge voltage of 4.65 V and a measurement temperature of 45° C.; the results shown in FIG. 41A were obtained at a charge voltage of 4.70 V and a measurement temperature of 25° C.; and the results shown in FIG. 41B were obtained at a charge voltage of 4.70 V and a measurement temperature of 45° C. Arrows on the graphs denote the direction of changes in the charge curves and the discharge curves along with the increase in the cycle number of charging and discharging. As the tendency of change in the discharge curves, no large change in the discharge curve shape along with a decrease in discharge capacity is observed in five conditions other than the condition at 45° C. and 4.70 V. With the condition at 45° C. and 4.70 V, the shape of discharge curves is greatly deformed along with a decrease in discharge capacity, which means that the discharge voltage is reduced on the whole. Accordingly, when the charge and discharge cycle is performed at 45° C. and 4.70 V, a significant increase in the internal resistance of a secondary battery is presumed.

<Defect of Positive Electrode Active Material after Cycle Test>

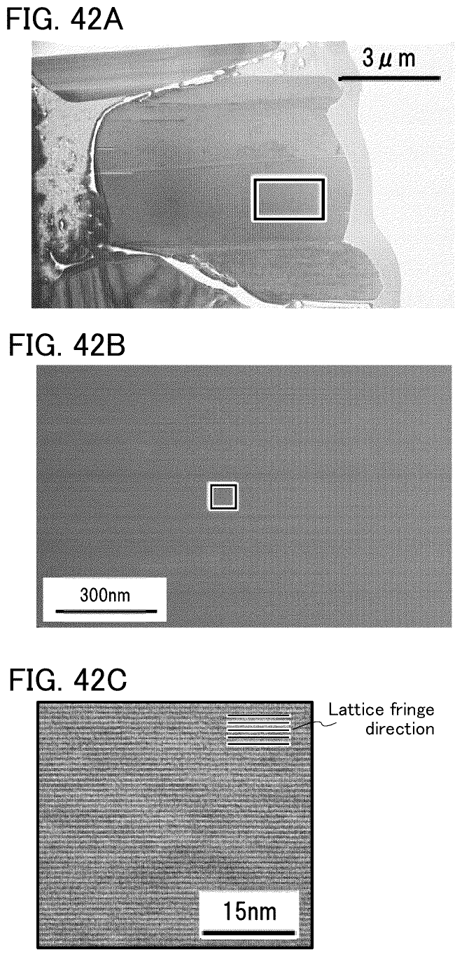

A cross section of the positive electrode after 50 cycles was observed with a scanning transmission electron microscope (STEM). An FIB was used for processing the sample for cross-sectional observation. FIG. 42A to FIG. 42C show the cross-sectional STEM observation results of Sample A after the 50-time cycle test was performed with the conditions of 45° C. and 4.70 V. FIG. 42C is an enlarged image of a region surrounded by a solid line in FIG. 42B, and FIG. 42B is an enlarged image of a region surrounded by a solid line in FIG. 42A. To obtain the cross-sectional STEM image, HD-2700 produced by Hitachi High-Technologies Corporation was used at an accelerating voltage of 200 kV.

In Sample A subjected to the 50-time cycle test with the conditions of 45° C. and 4.70 V as shown in FIG. 42A to FIG. 42C, a closed split is not observed in the inner portion of the positive electrode active material, which indicates that the positive electrode active material in Sample A has a stable structure compared to the positive electrode active materials not containing Ba shown in FIG. 10 to FIG. 12. It is known that a large amount of Ba exist in the surface portion after the positive electrode active material is produced. Considering that the generation of closed splits in the inner portion of the positive electrode active material is inhibited after the cycle deterioration at 45° C. and 4.70 V, as shown in FIG. 42A to FIG. 42C, the presumable possibility is that Ba the amount of which is undetectable (lower than or equal to 1 atomic %) at the STEM-EDX level diffuses into the LCO bulk and with the structure stabilization effect of the Ba, generation of closed splits in the active material is inhibited.

### REFERENCE NUMERALS

100: positive electrode active material, 100a: surface portion, 100b: inner portion, 101: crystal grain boundary, 102: filling portion, 103: unevenly distributed portion, 200: positive electrode active material layer, 201: graphene compound, 903: mixture, 904: mixture

1. A positive electrode comprising:
a positive electrode active material comprising a composite oxide comprising lithium and cobalt,
wherein the positive electrode active material comprises barium, magnesium, and aluminum in a surface portion.

2. The positive electrode according to claim 1,
wherein the surface portion comprises a region where the barium and the magnesium exist closer to a surface of the positive electrode active material than the aluminum does.

3. The positive electrode according to claim 1,
wherein when the surface portion is analyzed by cross-sectional STEM-EDX linear analysis, the surface portion comprises a region where a first point of a maximum characteristic X-ray detected value of the barium and a second point of a maximum characteristic X-ray detected value of the magnesium exist closer to a surface of the positive electrode active material than a third point of a maximum characteristic X-ray detected value of the aluminum does.

4. The positive electrode according to claim 1,
wherein in a charged state with a charge depth greater than or equal to 0.8, the lithium is distributed uniformly in the positive electrode active material.

5. A lithium-ion secondary battery comprising:
a positive electrode;
a negative electrode; and
an electrolyte,
wherein the positive electrode comprises a positive electrode active material comprising a composite oxide comprising lithium and cobalt, and
wherein the positive electrode active material comprises barium, magnesium, and aluminum in a surface portion.

6. A lithium-ion secondary battery comprising:
a positive electrode;
a negative electrode; and
an electrolyte,
wherein the positive electrode comprises a positive electrode active material comprising a composite oxide comprising lithium and cobalt,
wherein the positive electrode active material comprises barium, magnesium, and aluminum in a surface portion, and
wherein the surface portion comprises a region where the barium and the magnesium exist closer to a surface of the positive electrode active material than the aluminum does.

7. A lithium-ion secondary battery comprising:
a positive electrode;
a negative electrode; and
an electrolyte,
wherein the positive electrode comprises a positive electrode active material comprising a composite oxide comprising lithium and cobalt,
wherein the positive electrode active material comprises barium, magnesium, and aluminum in a surface portion, and
wherein when the surface portion is analyzed by cross-sectional STEM-EDX linear analysis, the surface portion comprises a region where a first point of a maximum characteristic X-ray detected value of the barium and a second point of a maximum characteristic X-ray detected value of the magnesium exist closer to a surface of the positive electrode active material than a third point of a maximum characteristic X-ray detected value of the aluminum does.

8. The lithium-ion secondary battery according to claim 5,
wherein in a charged state with a charge depth greater than or equal to 0.8, the lithium is distributed uniformly in the positive electrode active material.

9. The lithium-ion secondary battery according to claim 5, wherein the negative electrode comprises a carbon-based material.

10. The lithium-ion secondary battery according to claim 5, wherein the electrolyte comprises a solid electrolyte.

11. A moving vehicle comprising the lithium-ion secondary battery according to claim 5.

12. A power storage system comprising the lithium-ion secondary battery according to claim 5.

13. An electronic device comprising the lithium-ion secondary battery according to claim 5.

14. A method for forming a composite oxide comprising the steps of:
heating a composite oxide comprising lithium and cobalt at a temperature higher than or equal to 700° C. and lower than or equal to 1000° C. for a time longer than or equal to two hours;
adding a first mixture comprising a barium source and a second mixture comprising a magnesium source to the composite oxide to form a third mixture;
heating the third mixture at a temperature higher than or equal to 800° C. and lower than or equal to 1100° C. for a time longer than or equal to two hours;
adding a nickel source and an aluminum source to the third mixture to form a fourth mixture; and
heating the fourth mixture at a temperature higher than or equal to 800° C. and lower than or equal to 1100° C. for a time longer than or equal to two hours.

15. The method for forming a composite oxide according to claim 14, wherein when the number of barium atoms in the barium source is denoted by atBa and the number of magnesium atoms in the magnesium source is denoted by atMg, atBa/(atBa+atMg) is greater than or equal to 0.1 and less than or equal to 0.5.

16. The method for forming a composite oxide according to claim 14,
wherein the barium source is barium fluoride,
wherein the magnesium source is magnesium fluoride, and
wherein when the number of moles of the barium fluoride is denoted by mBaF₂ and the number of moles of the magnesium fluoride is denoted by mMgF₂, mBaF₂/(mBaF₂+mMgF₂) is greater than or equal to 0.1 and less than or equal to 0.5.

17. The lithium-ion secondary battery according to 6, wherein the negative electrode comprises a carbon-based material.

18. The lithium-ion secondary battery according to 7, wherein the negative electrode comprises a carbon-based material.

19. The lithium-ion secondary battery according to 8, wherein the negative electrode comprises a carbon-based material.

20. The lithium-ion secondary battery according to claim 6, wherein the electrolyte comprises a solid electrolyte.

21. The lithium-ion secondary battery according to claim 7, wherein the electrolyte comprises a solid electrolyte.

22. The lithium-ion secondary battery according to claim 8, wherein the electrolyte comprises a solid electrolyte.

23. A power storage system comprising the lithium-ion secondary battery according to claim 6.

24. A power storage system comprising the lithium-ion secondary battery according to claim 7.

25. A power storage system comprising the lithium-ion secondary battery according to claim 8.

26. An electronic device comprising the lithium-ion secondary battery according to claim 6.

27. An electronic device comprising the lithium-ion secondary battery according to claim 7.

28. An electronic device comprising the lithium-ion secondary battery according to claim 8.
